(19) United States
(12) Patent Application Publication
(10) Pub. No.: US 2009/0099042 A1
(43) Pub. Date: Apr. 16, 2009

(54) Reverse Two-Hybrid System for Identification of Interaction Domains

(75) Inventors: Phillip Neal Gray, Carlsbad, CA (US); Thomas Gilbert Chappell, San Marcos, CA (US)

Correspondence Address: INVITROGEN CORPORATION;C/O INTELLEVATE, P.O. BOX 52050, MINNEAPOLIS, MN, 55402, US

(73) Assignee: INVITROGEN CORPORATION, Carlsbad, CA (US)

(21) Appl. No.: 12/206,562

(22) Filed: Sep. 8, 2008

Related U.S. Application Data
(63) Continuation of application No. 11/290,804, filed on Dec. 1, 2005, now abandoned.
(60) Provisional application No. 60/648,689, filed on Feb. 2, 2005.
(60) Provisional application No. 60/631,972, filed on Dec. 1, 2004.

(51) Int. Cl. C40B 50/06

(52) U.S. Cl. 506/26

(57) ABSTRACT

The present invention provides methods for producing allele libraries and vectors for producing these libraries. The present invention also provides methods of identifying interaction domains between proteins. The vectors, kits, and methods of the present invention suitably utilize recombinational cloning to efficiently generate and screen full-length mutant alleles of target sequences of interest.

This application claims benefit of priority to U.S. Provisional Patent Application 60/631,972 filed Dec. 1, 2004 and to U.S. Provisional Patent Application 60/648,689 filed Feb. 2, 2005, both of which are herein incorporated by reference in their entireties.

### BACKGROUND OF THE INVENTION

### Field of the Invention

The present invention relates to recombinant DNA technology. The present invention provides methods for producing allele libraries and vectors for producing these libraries. The present invention also provides methods of identifying interaction domains between proteins. The vectors and methods of the present invention suitably utilize recombinational cloning to manipulate various gene target regions.

### BACKGROUND OF THE INVENTION

The yeast two-hybrid system is a powerful tool for identifying protein-protein interactions. The system is based on a split transcription factor, where proteins are expressed in S. cerevisiae as fusions to either the DNA binding domain (DBD) or transcriptional activator domain (AD). A positive protein-protein interaction reconstitutes a functional transcription factor, which is capable of activating reporter genes in genetically modified strains of S. cerevisiae. The reverse two-hybrid is a variation on the yeast two-hybrid system that was developed to identify elements that disrupt protein interactions. The system can be used to characterize protein-protein interactions by generating an allele library of one of the interacting proteins and selecting for interaction defective alleles. Vidal et al. described the first reverse two-hybrid system using a negative selection scheme that exploits the relationship between the URA3 gene in S. cerevisiae and 5-fluoroorotic acid (5-FOA) (Vidal, M., Proc. Natl. Acad. Sci. 93:10315-10320 (1996)). When using URA3 as a reporter in the yeast two-hybrid system, a positive protein-protein interaction allows yeast to survive on media lacking uracil. However, this interaction will result in toxicity and cell death in the presence of 5-FOA. The URA3 reporter initiates the conversion of 5-FOA to fluorouracil, which is toxic to yeast. Thus, alleles coding for proteins that have weakened or disrupted interactions with their corresponding partner will be resistant to 5-FOA (5-FOA^{R}) and may be selected for in a reverse two-hybrid screen. As a result, one can identify amino acid residues, or regions of a protein, important in a particular protein-protein interaction by isolating non-interacting alleles.

The current strategy for conducting reverse two-hybrid screens is outlined as follows: First, allele libraries are generated by polymerase chain reaction (PCR), such that PCR products are flanked by homologous regions to the activator domain (AD) yeast two-hybrid vector. PCR products are co-transformed into S. cerevisiae with the linearized AD vector and library assembly is mediated through in vivo homologous recombination, or gap repair (See e.g., Vidal, M., Braun, P., Chen, E., A., Boeke, J. D. & Harlow, E. Proc. Natl. Acad. Sci. 93:10321-10326 (1996)). While convenient, gap repair mediated library assembly limits library complexity due to the low transformation efficiencies typically achieved (˜10⁶). Next, when evaluating a protein-protein interaction using the counterselectable marker URA3 in the presence of 5-fluoroorotic acid (5-FOA), a positive interaction will inhibit growth, whereas disrupted interactions will be resistant to 5-FOA (5-FOA^{R}). Both point mutations and truncated proteins may result in a disrupted interaction, however, truncated proteins are less informative and typically represent >97% of 5-FOA^{R} colonies ((See e.g., Vidal, M., Braun, P., Chen, E., A., Boeke, J. D. & Harlow, E. Proc. Natl. Acad. Sci. 93:10321-10326 (1996) and Endoh, H., Walhout, A. J. M. & Vidal, M. A. Methods Enzymol. 328:74-88 (2000)). Therefore, isolating interaction defective alleles containing point mutations while selecting against truncated proteins is desirable. This can be achieved by incorporating a second step positive selection, which requires the addition of an easily detected C-terminal fusion such as green fluorescent protein or β-galactosidase to the allele library ((See e.g., Endoh, H., Walhout, A. J. M. and Vidal, M., Methods Enzymol. 328:74-88 (2000) and Shih, H., et al., Proc. Natl. Acad. Sci. 93:13896-13901 (1996)). However, the allele library produced contains both an N- and C-terminal fusion, which may affect the interaction under study. Another option is the use of epitope tags at the C-terminus, which may be detected by Western blot (See e.g., Barr, R. K., Hopkins, R. M., Watt, P. M. and Bogoyevitch, M. A., J. Biol. Chem. 279:43178-43189 (2004)). But, due to its time-consuming and labor intensive nature, this method is not practical for screening out truncated proteins from a library. An additional downside to using both of these approaches is that the identification of full-length proteins is performed after 5-FOA selection and only less than 3% of 5-FOA^{R} colonies are expected to code for full-length proteins. Thus, separating this small percentage of full-length alleles from background resulting from truncated proteins remains a challenge.

The present invention addresses these issues by providing methods for generation of allele libraries, suitably in vitro, and selecting for full-length proteins in E. coli prior to analysis in yeast through the use of recombination site cloning. The present invention also provides vectors, kits and host cells that can be used in these methods.

### SUMMARY OF THE INVENTION

In one embodiment, the present invention provides methods for generating a library of full-length target sequences, comprising: (a) providing a first vector comprising a first recombination site, a second recombination site, and a selectable marker gene; (b) mixing at least one nucleic acid molecule comprising a third recombination site, a target sequence, and a fourth recombination site with the first vector to generate a mixture; (c) incubating the mixture in the presence of at least one recombination protein under conditions sufficient to cause recombination between the first and third recombination sites and the second and fourth recombination sites, thereby generating a target sequence selection construct comprising a fifth recombination site, a target sequence, a sixth recombination site, and a selectable marker; (d) introducing the target sequence selection construct into a host cell; (e) incubating the host cell under conditions sufficient to express the selectable marker gene; and (f) selecting for host cells expressing the selectable marker to obtain a library of full-length target sequences. The library comprises nucleic acid molecules encoding, in order, the fifth recombination site, a full length target gene, the sixth recombination site, and the selectable marker.

In suitable embodiments of the present invention, the mixing in (b) and the incubating in (c) are performed in vitro. Preferably, in step b), a plurality of nucleic acid molecules nucleic acid molecule that comprise a third recombination site, a target sequence, and a fourth recombination site, is mixed with the first vector. The target sequence selection construct preferably includes a promoter that can regulate expression of target sequences in the host cells in which selection is performed. Preferably, the full length target genes of the library are fused in frame with the selectable marker via the sixth recombination site of the selection construct.

In preferred embodiments, the methods of the present invention are directed to producing full-length allele libraries, in which the methods further comprise generating alleles of one or more target sequences by mutagenesis, and producing full-length allele libraries of one or more target sequences by recombinational cloning of the target sequence alleles in an expression vector that includes a selectable marker. In these embodiments, the method includes: (a) providing a first vector comprising a first recombination site, a second recombination site, and a selectable marker gene; (b) providing a population of target sequence alleles flanked by a third recombination site on one end and a fourth recombination site on the other end, in which the population of target sequence alleles has been generated by mutagenesis of at least one target nucleic acid molecule; c) mixing the population of target sequence alleles with the first vector to generate a mixture; (d) incubating the mixture in the presence of at least one recombination protein under conditions sufficient to cause recombination between the first and third recombination sites and the second and fourth recombination sites, thereby generating a population of target sequence allele selection constructs comprising a fifth recombination site, a target sequence allele, a sixth recombination site, and the selectable marker gene; (e) introducing the population of selection constructs into a host cell; (f) incubating the host cell under conditions sufficient to express the selectable marker gene; and (g) selecting for host cells expressing the selectable marker to obtain a library of full-length target alleles. The library comprises nucleic acid molecules encoding, in order, the fifth recombination site, a full length target gene, the sixth recombination site, and the selectable marker.

In suitable embodiments of the present invention, the mixing in (c) and the incubating in (d) are performed in vitro. Preferably, the target allele selection construct includes a promoter that can promote expression of target sequences in the host cells in which selection is performed. Preferably, the full length target alleles of the library are fused in frame with the selectable marker via the sixth recombination site of the selection construct.

Recombination sites useful throughout the practice of the present invention can be any site useful in site-specific recombination, including those described, e.g., in U.S. Pat. Nos. 5,888,732, 6,171,861, 6,143,557, 6,270,969, 6,720,140, 6,277,608, and U.S. patent application Ser. Nos. 09/177,387 and 09/517,466, the disclosures of each of which are incorporated by reference herein for all purposes, in particular for all disclosure of recombinational cloning compositions and methods and recombination sites. Suitable such sites include, but are not limited to, recombination sites selected from the group consisting of att sites, lox sites, frt sites, psi sites, dif sites and cer sites. Suitably they will be att sites, and in certain embodiments mutated att sites, such as att sites are selected from the group consisting of attB, attP, attL and attR sites.

In certain embodiments, the first and second recombination sites are attP sites, the third and fourth recombination sites are attB sites and the fifth or sixth recombination sites are attL sites. Suitably, the third and fourth recombination sites flank the full length target sequence.

Selectable markers useful throughout the present invention can be any sequence permitting selection of host cells comprising the marker, which may be any positive selectable marker or negative selectable marker known in the art. Suitable such markers include, for example, selectable markers selected from the group consisting of an antibiotic resistance gene, a toxic gene and a reporter gene. In suitable embodiments, the selectable marker is an antibiotic resistance gene, including antibiotic resistance genes that confer resistance to ampicillin, tetracycline, spectinomycin, kanamycin or chloramphenicol.

The vectors of the present invention can further comprise promoters and operators, such as lac operators and EML promoters. The vectors of the present invention can also further comprise additional genes such as a lacI gene. The full length target sequences of the present invention can comprise one or more mutations relative to the wild type of the full length target sequence.

The present invention also provides vectors that include, in the following order, a first recombination site, a second recombination site, and a selectable marker gene. In some embodiments, the vectors further include a counter-selectable marker gene between the first and second recombination sites. The vectors preferably include a promoter upstream of the first recombination site. In some preferred embodiments, the promoter is functional in bacteria, and in some preferred embodiments, the promoter is inducible. The present invention provides the vector pDONR-Express, and kits for generating an allele library, comprising: (a) one or more of the genetic constructs of the invention, such as vector pDONR-Express and (b) one or more control constructs for titrating selectable marker resistance for allele library constructs. The kits can further include one or more antibiotics and/or media for growth of host cells. The present invention also provides kits for generating an allele library that comprise: (a) one or more of the genetic constructs of the invention, such as vector pDONR-Express; (b) one or more recombination proteins; and (c) one or more buffers. The kits of the present invention can further comprise one or more yeast two-hybrid vectors and one or more primer nucleic acid molecules comprising a recombination site sequence or a sequence complementary thereto. The present invention also provides host cells, suitably E. Coli cells, comprising one or more of the genetic constructs of the invention, such as the vector pDONR-Express.

The present invention further provides isolated nucleic acid molecules comprising, in order: (a) a first recombination site; (b) a full length target sequence; (c) a second recombination site; and (d) a selectable marker. In preferred embodiments, the full-length target sequence includes an open reading frame that is linked in-frame to the selectable marker gene via the second recombination site. In preferred embodiments, the nucleic acid molecules include a promoter upstream of the full length target sequence that directs transcription of the reading frame-linked full length target sequence and selectable marker gene. The nucleic acid molecules of the present invention can comprise any recombination sites, and in suitable embodiments will comprise attL sites.

The present invention further provides libraries of nucleic acid molecule constructs that comprise, in order: (a) a first recombination site; (b) a full length target sequence; (c) a second recombination site; and (d) a selectable marker. In preferred embodiments, the full-length target sequence includes an open reading frame that is linked in-frame to the selectable marker gene via the second recombination site. In preferred embodiments, the nucleic acid molecules include a promoter upstream of the full length target sequence that directs transcription of the reading frame-linked full length target sequence and selectable marker gene. A library can be an allele library in which the full length target sequences are alleles of one or more target sequences generated by mutagenesis. The nucleic acid molecules of the present invention can comprise any recombination sites, and in suitable embodiments will comprise attL sites.

The present invention also provides methods for identifying host cells comprising at least one interaction-defective allele in an allele library, comprising: (a) producing isolated nucleic acid molecules of an allele library as described immediately above; (b) mixing the isolated nucleic molecule with an expression vector comprising a third recombination site and a fourth recombination site to form a mixture; (c) incubating the mixture in the presence of at least one recombination protein under conditions sufficient to cause recombination between the first and third recombination sites and the second and fourth recombination sites, to generate an expression construct comprising the full length target sequence that is not fused to a selectable marker gene; (d) introducing the expression construct into a host cell; (e) introducing a plasmid comprising an interacting domain encoding sequence into the host cell, wherein the host cell contains a nucleic acid molecule comprising a second selectable marker gene capable of counter-selection, where transcription of the selectable marker gene is indicative of a positive interaction between the target sequence gene product and the interacting domain; (f) incubating the host cell under conditions sufficient to allow interaction between the full length target sequence and the interacting domain; and (g) selecting for host cells in which the second selectable marker is not transcribed, wherein the selected host cells comprise one or more interaction-defective alleles.

In certain such embodiments, the mixing in (b) and incubating in (c) are suitably performed in vitro. Suitably the first and second recombination sites will be attL sites and the third and fourth recombination sites will be attR sites, although this is not a requirement of the present invention. In certain embodiments, the second selectable marker is selected from the group consisting of an antibiotic resistance gene, a toxic gene and a reporter gene. Suitably, the second selectable marker will confer toxicity to a compound selected from the group consisting of 5-FOA, cycloheximide, α-aminoadipate, D-histidine and galactose. In other embodiments, the second selectable marker is selected from the group consisting of a URA3 gene, a CYH2 gene, a LYS2 gene, a GAP1 gene, a GIN1 gene and a GAL1 gene. In certain embodiments the first vector is a yeast vector and the host cell is a yeast cell.

The present invention also provides methods for identifying interaction-defective alleles in an allele library, comprising: (a) producing isolated nucleic acid molecules of an allele library in accordance with the present invention that comprise in order: a first recombination site; a full length target sequence alllele; a second recombination site; and a selectable marker; (b) mixing the isolated nucleic molecules with an expression vector comprising a third recombination site and a fourth recombination site to form a mixture; (c) incubating the mixture in the presence of at least one recombination protein under conditions sufficient to cause recombination between the first and third recombination sites and the second and fourth recombination sites, to generate a library of expression constructs comprising full length target sequence alleles that are not fused to a selectable marker gene; (d) introducing the expression construct into a host cell; (e) introducing a plasmid comprising an interacting domain into the host cell, wherein the host contains a nucleic acid molecule comprising a second selectable marker capable of counter-selection, in which expression of the second selectable marker is indicative of a positive interaction between the full length target sequence and the interacting domain; (f) incubating the host cell under conditions sufficient to allow interaction between the full length target allele and the interacting domain; (g) selecting for host cells in which the second selectable marker is not transcribed, wherein the selected host cells comprise one or more interaction-defective alleles; (h) isolating a full length target sequence from at least one selected host cell; (i) sequencing at least one full length target sequence to identify at least one interaction-defective allele.

In certain such embodiments, the mixing in (b) and incubating in (c) are suitably performed in vitro. Suitably the first and second recombination sites will be attL sites and the third and fourth recombination sites will be attR sites, although this is not a requirement of the invention. In certain embodiments, the second selectable marker is selected from the group consisting of an antibiotic resistance gene, a toxic gene and a reporter gene.

The present invention also provides methods for identifying a protein interaction domain of a target protein, comprising: (a) generating a full-length allele library encoding variants of the target protein, wherein full-length alleles of the allele library are translated in frame with a selectable marker; (b) isolating clones of the allele library that express the selectable marker, thereby isolating full length clones; (c) transferring the full-length alleles into vectors in which the full-length alleles are not translated in frame with the selectable marker gene; transfecting yeast cells with the clones of full-length alleles, wherein the yeast cells are used in a reverse 2-hybrid screen to identify alleles of the allele library that are defective in the protein interaction domain; and (d) identifying the defective protein interaction domain of the identified alleles. In certain embodiments the allele library is generated using recombinational cloning. In certain embodiments the allele library comprising full-length alleles not fuse to marker genes is generated using recombinational cloning. Suitably the recombinational cloning is site-specific recombinational cloning, for example att site recombinational cloning.

In another embodiment, the present invention provides methods for generating an allele library in yeast cells, comprising: (a) generating an allele library encoding variants of the target protein, wherein the allele library is generated using recombinational cloning and wherein alleles of the allele library are translated in frame with a selectable marker; (b) isolating clones of the allele library that express the selectable marker, thereby isolating full length clones; (c) using recombinational cloning to transfer the full-length alleles into vectors in which the full-length alleles are not translated in frame with the selectable marker gene; and (d) transfecting yeast cells with the clones of full-length alleles not fused to marker genes, wherein the yeast cells comprise a selectable marker that confers toxicity to a compound. Suitably, the recombinational cloning is site-specific recombinational cloning, for example att site recombinational cloning.

The invention includes alleles of fos, MyoD and Ra1GDS proteins isolated from full-length allele libraries generated by the methods of the present invention.

Other preferred embodiments of the present invention will be apparent to one of ordinary skill in light of what is known in the art, in light of the following drawings and description of the invention, and in light of the claims.

### BRIEF DESCRIPTION OF THE DRAWINGS

FIG. 1 depicts a vector map of the pDONR-Express vector.

FIG. 2 depicts the sequence of the EML promoter and the start (ATG) and mutated codon (TGC) in attP1*.

FIG. 3 depicts a schematic of a method of determining interacting domains in accordance with one embodiment of the present invention.

FIGS. 4A and 4B depict multiple sequence alignments of Fos alleles generated using the methods of the present invention. Sequences were translated and a multiple sequence alignment was generated for Kan⁺ (4A) and Kan⁻ (4B) clones.

FIG. 5 depicts multiple Sequence Alignment of translated MyoD1 mutants.

FIG. 6 depicts a multiple sequence alignment of translated Ra1GDS RA mutants.

### DETAILED DESCRIPTION OF THE INVENTION

Site-specific recombinational cloning is a cloning technology based on lambda phage recombination and facilitates the transfer of heterologous DNA sequences between vectors through site-specific attachment sites. (See e.g., U.S. Pat. Nos. 5,888,732, 6,171,861, 6,143,557, 6,270,969, 6,720,140, 6,277,608, and U.S. patent application Ser. Nos. 09/177,387 and 09/517,466, the disclosures of each of which are incorporated by reference herein for all purposes, including disclosure of recombinational cloning methods and compositions and recombination sites.)

The reverse two-hybrid is a variation on the yeast two-hybrid system that was developed to identify elements that disrupt protein interactions. The system can be used to characterize protein-protein interactions by generating an allele library of one of the interacting proteins and selecting for interaction-defective alleles. Current strategies for conducting reverse two-hybrid screens are overwhelmed by interaction-defective truncated proteins, which cause high background. The present invention eliminates this background through the production of allele libraries in vitro using site-specific recombination technology and selection for full-length proteins in E. coli. First, this full-length selection scheme has been demonstrated by generating an allele library of the leucine zipper region of fos and segregated full-length from truncated alleles based on E. coli growth phenotypes and then confirmed by sequencing. Second, an allele library of the basic helix-loop-helix (bHLH) protein MyoD1 and its interaction with Id1 has been analyzed (See, Benezra, R., Davis, R. L., Lockshon, D., Turner, D. L. & Weintraub, H. Cell 61:49-59 (1990)). Results show most of the interaction-defective alleles contain a single point mutation in the known interaction domain, the bHLH region. Moreover, analysis of the crystal structure of MyoD reveals the majority of these mutations occur at the interaction interface. Third, the vector pDONR-Express was used to generate a full-length enriched allele library of the ras association (RA) domain of Ra1GDS and analyze its interaction with Krev1 (See, Herrmann, C., Horn, G., Spaargaren, M. and Wittinghofer, A. J. Biol. Chem. 271:6794-6800 (1996) and Serebriiskii, I., Khazak, V. and Golemis, E. A. J. Biol. Chem. 274:17080-17087 (1999)). Several residues were identified within the RA domain, which appear to stabilize the domain and facilitate interaction. The methods of the present invention for allele library generation significantly reduce background ordinarily associated with reverse two-hybrid screens and, unlike existing strategies, allow for more complex allele libraries to be analyzed in the original two-hybrid context.

In one embodiment, the present invention provides methods by which recombination sites are added to DNA target sequences through the use of PCR amplification, followed by recombination (e.g., BP site-specific reaction) of the amplified products with a pDONR vector to yield pENTR clones containing the gene of interest. The pDONR vector, pDONR-Express, facilitates expression of pENTR clones as an N-terminal fusion to neomycin phosphotransferase. When transformed into E. coli, alleles coding for full-length proteins will confer antibiotic resistance (e.g., kanamycin resistance) and produce colonies for DNA (i.e., allele library) isolation. The pENTR allele library can then be transferred to a two-hybrid AD vector through a second recombination reaction (e.g., LR site-specific reaction), yielding a full length enriched expression library fused to Gal4 AD. As a result, clones lose the C-terminal fusion used for full-length selection (e.g., antibiotic resistance) and interactions can be evaluated in the original two-hybrid context. This scheme selects against interaction-defective truncated proteins prior to yeast transformation, eliminating virtually all background normally associated with reverse two-hybrid screens. Moreover, when compared to gap repair mediated library assembly, combining site-specific recombination with the efficiency of E. coli transformation allows for larger (10⁶-10⁷), more complex allele libraries to be evaluated.

### DEFINITIONS

In the description that follows, a number of terms used in recombinant DNA technology are utilized extensively. In order to provide a clear and consistent understanding of the specification and claims, including the scope to be given such terms, the following definitions are provided.

Host: is any prokaryotic or eukaryotic organism that can be a recipient of a recombinational cloning Product. A “host,” as the term is used herein, includes prokaryotic or eukaryotic organisms that can be genetically engineered. For examples of such hosts, see Maniatis et al., Molecular Cloning: A Laboratory Manual, Cold Spring Harbor Laboratory, Cold Spring Harbor, N.Y. (1982).

Target sequence: includes a nucleic acid segment of interest or a population of nucleic acid segments which may be manipulated by the methods of the present invention. Thus, the terms target sequence(s) are meant to include a particular nucleic acid (preferably DNA) segment or a population of segments. Such target sequence(s) can comprise one or more genes. Suitably, the target sequences utilized in the present invention will be an open reading frame of a particular nucleic acid.

Product: is one the desired daughter molecules comprising the target sequence(s) which is produced after the recombination event during the recombinational cloning process. The product contains the nucleic acid which was to be cloned or subcloned.

Promoter: is a DNA sequence generally described as the 5′-region of a gene, located proximal to the start codon that binds transcriptional regulatory factors to initiate transcription. The transcription of an adjacent DNA segment is initiated at the promoter region. A repressible promoter's rate of transcription decreases in response to a repressing agent. An inducible promoter's rate of transcription increases in response to an inducing agent. A constitutive promoter's rate of transcription is not specifically regulated, though it can vary under the influence of general metabolic conditions.

Operator: A DNA region at one end of an operon that acts as the binding site for repressor protein. A DNA sequence that is recognized by a repressor protein or repressor-corepressor complex. When the operator is complexed with the repressor, transcription is prevented.

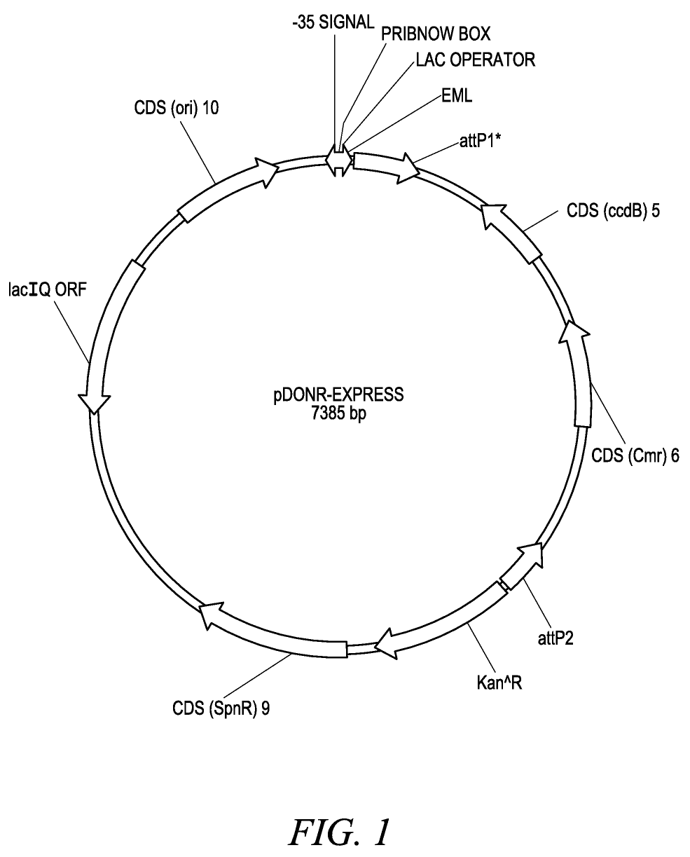

Recognition sequence: Recognition sequences are particular sequences which a protein, chemical compound, DNA, or RNA molecule (e.g., restriction endonuclease, a modification methylase, or a recombinase) recognizes and binds. In the present invention, a recognition sequence will usually refer to a recombination site. For example, the recognition sequence for Cre recombinase is loxP which is a 34 base pair sequence comprised of two 13 base pair inverted repeats (serving as the recombinase binding sites) flanking an 8 base pair core sequence. See FIG. 1 of Sauer, B., Current Opinion in Biotechnology 5:521-527 (1994). Other examples of recognition sequences are the attB, attP, attL, and attR sequences which are recognized by the recombinase enzyme λ Integrase. attB is an approximately 25 base pair sequence containing two 9 base pair core-type Int binding sites and a 7 base pair overlap region. attP is an approximately 240 base pair sequence containing core-type Int binding sites and arm-type Int binding sites as well as sites for auxiliary proteins integration host factor (IHF), FIS and excisionase (Xis). See Landy, Current Opinion in Biotechnology 3:699-707 (1993). Such sites may also be engineered according to the present invention to enhance production of products in the methods of the invention, or to mutate stop codons to amino acid-encoding codons. When such engineered sites lack the P1 or H1 domains to make the recombination reactions irreversible (e.g., attr or attP), such sites may be designated attR′ or attP′ to show that the domains of these sites have been modified in some way.

Recombinase: is an enzyme which catalyzes the exchange of DNA segments at specific recombination sites.

Recombinational Cloning: is a method described herein, whereby segments of nucleic acid molecules or populations of such molecules are exchanged, inserted, replaced, substituted or modified, in vitro or in vivo.

Recombination proteins: include excisive or integrative proteins, enzymes, co-factors or associated proteins that are involved in recombination reactions involving one or more recombination sites. See, Landy (1993), infra.

Selectable marker: is a DNA segment that allows one to select for or against a molecule or a cell that contains it, often under particular conditions. These markers can encode an activity, such as, but not limited to, production of RNA, peptide, or protein, or can provide a binding site for RNA, peptides, proteins, inorganic and organic compounds or compositions and the like. Examples of selectable markers include but are not limited to: (1) DNA segments that encode products which provide resistance against otherwise toxic compounds (e.g., antibiotics or other toxic genes); (2) DNA segments that encode products which are otherwise lacking in the recipient cell (e.g., tRNA genes, auxotrophic markers); (3) DNA segments that encode products which suppress the activity of a gene product; (4) DNA segments that encode products which can be readily identified (e.g., phenotypic markers such as β-galactosidase, green fluorescent protein (GFP), and cell surface proteins); (5) DNA segments that bind products which are otherwise detrimental to cell survival and/or function; (6) DNA segments that otherwise inhibit the activity of any of the DNA segments described in Nos. 1-5 above (e.g., antisense oligonucleotides); (7) DNA segments that bind products that modify a substrate (e.g. restriction endonucleases); (8) DNA segments that can be used to isolate or identify a desired molecule (e.g. specific protein binding sites); (9) DNA segments that encode a specific nucleotide sequence which can be otherwise non-functional (e.g., for PCR amplification of subpopulations of molecules); (10) DNA segments, which when absent, directly or indirectly confer resistance or sensitivity to particular compounds; and/or (11) DNA segments that encode products which are toxic in recipient cells.

Counterselectable marker: DNA segment that encodes a gene product that, when transcribed, is detrimental to cell growth (e.g., toxic) either under general (e.g., standard growth conditions) or specific conditions (e.g., exposure to a specific substance). These markers can encode an activity, such as, but not limited to, production of RNA, peptide, or protein. Examples of counterselectable markers include but are not limited to: (1) DNA segments that encode products which provide sensitivity to otherwise non-toxic compounds (e.g., amino acids or other non-toxic compounds); (2) DNA segments that encode products which are detrimental to cell growth (e.g., toxic). Selectable markers that are capable of couterselection include DNA segment that encodes a gene product that, when transcribed, is detrimental to cell growth (e.g., toxic) either under general (e.g., standard growth conditions) or specific conditions (e.g., exposure to a specific substance).

Selection scheme: is any method which allows selection, enrichment, or identification of a desired clone, such as a clone harboring a nucleic acid construct, such as but not limited to product or product(s) from a mixture containing various product and byproduct molecules. The selection schemes of one preferred embodiment have at least two components that are either linked or unlinked during recombinational cloning. One component is a selectable marker. The other component controls the expression in vitro or in vivo of the selectable marker, or survival of the cell harboring the plasmid carrying the selectable marker. Generally, this controlling element will be a repressor or inducer of the selectable marker, but other means for controlling expression of the selectable marker can be used. Whether a repressor or activator is used will depend on whether the marker is for a positive or negative selection, and the exact arrangement of the various DNA segments, as will be readily apparent to those skilled in the art. A preferred requirement is that the selection scheme results in selection of or enrichment for only one or more desired products. As defined herein, selecting for a DNA molecule includes (a) selecting or enriching for the presence of the desired DNA molecule, and (b) selecting or enriching against the presence of DNA molecules that are not the desired DNA molecule.

Examples of toxic gene products are well known in the art, and include, but are not limited to, restriction endonucleases (e.g., DpnI), apoptosis-related genes (e.g., ASK1 or members of the bcl-2/ced-9 family), retroviral genes including those of the human immunodeficiency virus (HIV), defensins such as NP-1, inverted repeats or paired palindromic DNA sequences, bacteriophage lytic genes such as those from ΦX174 or bacteriophage T4; antibiotic sensitivity genes such as rpsL, antimicrobial sensitivity genes such as pheS, plasmid killer genes, eukaryotic transcriptional vector genes that produce a gene product toxic to bacteria, such as GATA-1, and genes that kill hosts in the absence of a suppressing function, e.g., kicB or ccdB. A toxic gene can alternatively be selectable in vitro, e.g., a restriction site.

Many genes coding for restriction endonucleases operably linked to inducible promoters are known, and may be used in the present invention. See, e.g. U.S. Pat. Nos. 4,960,707 (DpnI and DpnII); 5,000,333, 5,082,784 and 5,192,675 (KpnI); 5,147,800 (NgoAIII and NgoAI), 5,179,015 (FspI and HaeIII): 5,200,333 (HaeII and TaqI); 5,248,605 (HpaII); 5,312,746 (ClaI); 5,231,021 and 5,304,480 (XhoI and XhoII); 5,334,526 (AluI); 5,470,740 (NsiI); 5,534,428 (SstI/SacI); 5,202,248 (NcoI); 5,139,942 (NdeI); and 5,098,839 (PacI). See also Wilson, G. G., Nucl. Acids Res. 19:2539-2566 (1991); and Lunnen, K. D., et al., Gene 74:25-32 (1988), all of which are incorporated by reference herein for all disclosure of restriction endonuclease sites and their uses in gene constructs and gene regulation.

Examples of antibiotic resistance genes include, but are not limited to, a chloramphenicol resistance gene, an ampicillin resistance gene, a tetracycline resistance gene, a Zeocin resistance gene, a spectinomycin resistance gene and a kanamycin resistance gene.

Site-specific recombinase: is a type of recombinase which typically has at least the following four activities (or combinations thereof): (1) recognition of one or two specific nucleic acid sequences; (2) cleavage of said sequence or sequences; (3) topoisomerase activity involved in strand exchange; and (4) ligase activity to reseal the cleaved strands of nucleic acid. See Sauer, B., Current Opinions in Biotechnology 5:521-527 (1994). Conservative site-specific recombination is distinguished from homologous recombination and transposition by a high degree of specificity for both partners. The strand exchange mechanism involves the cleavage and rejoining of specific DNA sequences in the absence of DNA synthesis (Landy, A. (1989) Ann. Rev. Biochem. 58:913-949).

Vector: is a nucleic acid molecule (preferably DNA) that provides a useful biological or biochemical property to an insert. Examples include plasmids, phages, autonomously replicating sequences (ARS), centromeres, and other sequences which are able to replicate or be replicated in vitro or in a host cell, or to convey a desired nucleic acid segment to a desired location within a host cell. A vector can have one or more restriction endonuclease recognition sites at which the sequences can be cut in a determinable fashion without loss of an essential biological function of the vector, and into which a nucleic acid fragment can be spliced in order to bring about its replication and cloning. Vectors can further provide primer sites, e.g., for PCR, transcriptional and/or translational initiation and/or regulation sites, recombinational signals, replicons, selectable markers, etc. Clearly, methods of inserting a desired nucleic acid fragment which do not require the use of homologous recombination, transpositions or restriction enzymes (such as, but not limited to, UDG cloning of PCR fragments (U.S. Pat. No. 5,334,575, entirely incorporated herein by reference), T:A cloning, and the like) can also be applied to clone a fragment into a cloning vector to be used according to the present invention. The cloning vector can further contain one or more selectable markers suitable for use in the identification of cells transformed with the cloning vector.

Primer: refers to a single stranded or double stranded oligonucleotide that is extended by covalent bonding of nucleotide monomers during amplification or polymerization of a nucleic acid molecule (e.g., a DNA molecule). In a preferred aspect, the primer comprises one or more recombination sites or portions of such recombination sites. Portions of recombination sties comprise at least 2 bases, at least 5 bases, at least 10 bases or at least 20 bases of the recombination sites of interest. When using portions of recombination sites, the missing portion of the recombination site may be provided by the newly synthesized nucleic acid molecule. Such recombination sites may be located within and/or at one or both termini of the primer. Preferably, additional sequences are added to the primer adjacent to the recombination site(s) to enhance or improve recombination and/or to stabilize the recombination site during recombination. Such stabilization sequences may be any sequences (preferably G/C rich sequences) of any length. Preferably, such sequences range in size from 1 to about 1000 bases, 1 to about 500 bases, and 1 to about 100 bases, 1 to about 60 bases, 1 to about 25, 1 to about 10, 2 to about 10 and preferably about 4 bases. Preferably, such sequences are greater than 1 base in length and preferably greater than 2 bases in length.

Template: refers to double stranded or single stranded nucleic acid molecules which are to be amplified, synthesized or sequenced. In the case of double stranded molecules, denaturation of its strands to form a first and a second strand is preferably performed before these molecules will be amplified, synthesized or sequenced, or the double stranded molecule may be used directly as a template. For single stranded templates, a primer complementary to a portion of the template is hybridized under appropriate conditions and one or more polypeptides having polymerase activity (e.g. DNA polymerases and/or reverse transcriptases) may then synthesize a nucleic acid molecule complementary to all or a portion of said template. Alternatively, for double stranded templates, one or more promoters may be used in combination with one or more polymerases to make nucleic acid molecules complementary to all or a portion of the template. The newly synthesized molecules, according to the invention, may be equal or shorter in length than the original template. Additionally, a population of nucleic acid templates may be used during synthesis or amplification to produce a population of nucleic acid molecules typically representative of the original template population.

Adapter: is an oligonucleotide or nucleic acid fragment or segment (preferably DNA) which comprises one or more recombination sites (or portions of such recombination sites) which in accordance with the invention can be added to a nucleic acid molecule. Such adapters may be added at any location within a circular or linear molecule, although the adapters are preferably added at or near one or both termini of a linear molecule. Preferably, adapters are positioned to be located on both sides (flanking) a particularly nucleic acid molecule of interest. In accordance with the invention, adapters may be added to nucleic acid molecules of interest by standard recombinant techniques (e.g., restriction digest and ligation). For example, adapters may be added to a circular molecule by first digesting the molecule with an appropriate restriction enzyme, adding the adapter at the cleavage site and reforming the circular molecule which contains the adapter(s) at the site of cleavage. Alternatively, adapters may be ligated directly to one or more and preferably both termini of a linear molecule thereby resulting in linear molecule(s) having adapters at one or both termini. In one aspect of the invention, adapters may be added to a population of linear molecules, (e.g., a cDNA library or genomic DNA which has been cleaved or digested) to form a population of linear molecules containing adapters at one and preferably both termini of all or substantial portion of said population.

Library: refers to a collection of nucleic acid molecules (circular or linear). In one embodiment, a library is representative of all or a significant portion of the DNA content of an organism (a “genomic” library), or a set of nucleic acid molecules representative of all or a significant portion of the expressed genes (a cDNA library) in a cell, tissue, organ or organism. In suitable embodiments, library refers to an allele library which contains a set of sequences representative of various alleles of a particular target sequence or protein. A library may also comprise random sequences made by de novo synthesis, mutagenesis of one or more sequences and the like. Such libraries may or may not be contained in one or more vectors.

Amplification: refers to any in vitro method for increasing a number of copies of a nucleotide sequence with the use of a polymerase. Nucleic acid amplification results in the incorporation of nucleotides into a DNA and/or RNA molecule or primer thereby forming a new molecule complementary to a template. The formed nucleic acid molecule and its template can be used as templates to synthesize additional nucleic acid molecules. As used herein, one amplification reaction may consist of many rounds of replication. DNA amplification reactions include, for example, polymerase chain reaction (PCR). One PCR reaction may consist of 5-100 “cycles” of denaturation and synthesis of a DNA molecule.

Oligonucleotide: refers to a synthetic or natural molecule comprising a covalently linked sequence of nucleotides which are joined by a phosphodiester bond between the 3′ position of the deoxyribose or ribose of one nucleotide and the 5′ position of the deoxyribose or ribose of the adjacent nucleotide.

Nucleotide: refers to a base-sugar-phosphate combination. Nucleotides are monomeric units of a nucleic acid sequence (DNA and RNA). The term nucleotide includes ribonucleoside triphosphatase ATP, UTP, CTG, GTP and deoxyribonucleoside triphosphates such as dATP, dCTP, dITP, dUTP, dGTP, dTTP, or derivatives thereof. Such derivatives include, for example, [αS]dATP, 7-deaza-dGTP and 7-deaza-dATP. The term nucleotide as used herein also refers to dideoxyribonucleoside triphosphates (ddNTPs) and their derivatives. Illustrated examples of dideoxyribonucleoside triphosphates include, but are not limited to, ddATP, ddCTP, ddGTP, ddITP, and ddTTP. According to the present invention, a “nucleotide” may be unlabeled or detectably labeled by well known techniques. Detectable labels include, for example, radioactive isotopes, fluorescent labels, chemiluminescent labels, bioluminescent labels and enzyme labels.

Hybridization: The terms “hybridization” and “hybridizing” refers to base pairing of two complementary single-stranded nucleic acid molecules (RNA and/or DNA) to give a double stranded molecule. As used herein, two nucleic acid molecules may be hybridized, although the base pairing is not completely complementary. Accordingly, mismatched bases do not prevent hybridization of two nucleic acid molecules provided that appropriate conditions, well known in the art, are used.

Other terms used in the fields of recombinant DNA technology and molecular and cell biology as used herein will be generally understood by one of ordinary skill in the applicable arts.

### Recombination Proteins

In the present invention, the exchange of DNA segments is achieved by the use of recombination proteins, including recombinases and associated co-factors and proteins. Various recombination proteins are described in the art. Examples of such recombinases include:

Cre: A protein from bacteriophage P1 (Abremski and Hoess, J. Biol. Chem. 259(3):1509-1514 (1984)) catalyzes the exchange (i.e., causes recombination) between 34 bp DNA sequences called loxP (locus of crossover) sites (See Hoess et al., Nucl. Acids Res. 14(5):2287 (1986)). Cre is available commercially (Novagen, Catalog No. 69247-1). Recombination mediated by Cre is freely reversible. From thermodynamic considerations it is not surprising that Cre-mediated integration (recombination between two molecules to form one molecule) is much less efficient than Cre-mediated excision (recombination between two loxP sites in the same molecule to form two daughter molecules). Cre works in simple buffers with either magnesium or spermidine as a cofactor, as is well known in the art. The DNA substrates can be either linear or supercoiled. A number of mutant loxP sites have been described (Hoess et al., supra). One of these, loxP 511, recombines with another loxP 511 site, but will not recombine with a loxP site.

Integrase: A protein from bacteriophage lambda that mediates the integration of the lambda genome into the E. coli chromosome. The bacteriophage λ Int recombinational proteins promote recombination between its substrate att sites as part of the formation or induction of a lysogenic state. Reversibility of the recombination reactions results from two independent pathways for integrative and excisive recombination. Each pathway uses a unique, but overlapping, set of the 15 protein binding sites that comprise att site DNAs. Cooperative and competitive interactions involving four proteins (Int, X is, IHF and FIS) determine the direction of recombination.

Integrative recombination involves the Int and IHF proteins and sites attP (240 bp) and attB (25 bp). Recombination results in the formation of two new sites: attL and attR. Excisive recombination requires Int, IHF, and Xis, and sites attL and attR to generate attP and attB. Under certain conditions, FIS stimulates excisive recombination. In addition to these normal reactions, it should be appreciated that attP and attB, when placed on the same molecule, can promote excisive recombination to generate two excision products, one with attL and one with attR. Similarly, intermolecular recombination between molecules containing attL and attR, in the presence of Int, IHF and Xis, can result in integrative recombination and the generation of attP and attB. Hence, by flanking DNA segments with appropriate combinations of engineered att sites, in the presence of the appropriate recombination proteins, one can direct excisive or integrative recombination, as reverse reactions of each other.

Each of the att sites contains a 15 bp core sequence; individual sequence elements of functional significance lie within, outside, and across the boundaries of this common core (Landy, A., Ann. Rev. Biochem. 58:913 (1989)). Efficient recombination between the various att sites requires that the sequence of the central common region be identical between the recombining partners, however, the exact sequence is modifiable. Consequently, derivatives of the att site with changes within the core recombine as least as efficiently as the native core sequences.

Integrase acts to recombine the attP site on bacteriophage lambda (about 240 bp) with the attB site on the E. coli genome (about 25 bp) (Weisberg, R. A. and Landy, A. in Lambda II, p. 211 (1983), Cold Spring Harbor Laboratory)), to produce the integrated lambda genome flanked by attL (about 100 bp) and attR (about 160 bp) sites. In the absence of X is (see below), this reaction is essentially irreversible. The integration reaction mediated by integrase and IHF works in vitro, with simple buffer containing spermidine. Integrase can be obtained as described by Nash, H. A., Methods of Enzymology 100:210-216 (1983). IHF can be obtained as described by Filutowicz, M., et al., Gene 147:149-150 (1994).

Numerous recombination systems from various organisms can also be used, based on the teaching and guidance provided herein. See, e.g., Hoess et al., Nucleic Acids Research 14(6):2287 (1986); Abremski et al., J. Biol. Chem. 261(1):391 (1986); Campbell, J. Bacteriol. 174(23):7495 (1992); Qian et al., J. Biol. Chem. 267(11):7794 (1992); Araki et al., J. Mol. Biol. 225(1):25 (1992)). Many of these belong to the integrase family of recombinases (Argos et al. EMBO J. 5:433-440 (1986)). Perhaps the best studied of these are the Integrase/att system from bacteriophage λ (Landy, A. (1993) Current Opinions in Genetics and Devel. 3:699-707), the Cre/loxP system from bacteriophage P1 (Hoess and Abremski (1990) In Nucleic Acids and Molecular Biology, vol. 4. Eds.: Eckstein and Lilley, Berlin-Heidelberg: Springer-Verlag; pp. 90-109), and the FLP/FRT system from the Saccharomyces cerevisiae 2μ circle plasmid (Broach et al. Cell 29:227-234 (1982)).

Members of a second family of site-specific recombinases, the resolvase family (e.g., γδ, Tn3 resolvase, Hin, Gin, and Cin) are also known.

Members of this highly related family of recombinases are typically constrained to intramolecular reactions (e.g., inversions and excisions) and can require host-encoded factors. Mutants have been isolated that relieve some of the requirements for host factors (Maeser and Kahnmann (1991) Mol. Gen. Genet. 230:170-176), as well as some of the constraints of intramolecular recombination. In addition, the present invention also encompasses the use of recombination sites such as psi sites, tnpI sites, dif sites, cer sites, frt sites and the like, including mutants and derivatives of these sites.

Other site-specific recombinases similar to λ Int and similar to P1 Cre can be substituted for Int and Cre. Such recombinases are known. In many cases the purification of such other recombinases has been described in the art. In cases when they are not known, cell extracts can be used or the enzymes can be partially purified using procedures described for Cre and Int.

While Cre and Int are described in detail for reasons of example, many related recombinase systems exist and their application to the described invention is also provided according to the present invention. The integrase family of site-specific recombinases can be used to provide alternative recombination proteins and recombination sites for the present invention, as site-specific recombination proteins encoded by, for example bacteriophage lambda, phi 80, P22, P2, 186, P4 and P1. This group of proteins exhibits an unexpectedly large diversity of sequences. Despite this diversity, all of the recombinases can be aligned in their C-terminal halves. A 40-residue region near the C terminus is particularly well conserved in all the proteins and is homologous to a region near the C terminus of the yeast 2 mu plasmid Flp protein. Three positions are perfectly conserved within this family: histidine, arginine and tyrosine are found at respective alignment positions 396, 399 and 433 within the well-conserved C-terminal region. These residues contribute to the active site of this family of recombinases, and suggest that tyrosine-433 forms a transient covalent linkage to DNA during strand cleavage and rejoining. See, e.g., Argos, P. et al., EMBO J. 5:433-40 (1986).

The recombinases of some transposons, such as those of conjugative transposons (e.g., Tn916) (Scott and Churchward, 1995, Ann Rev Microbiol 49:367; Taylor and Churchward, 1997, J. Bacteriol 179:1837) belong to the integrase family of recombinases and in some cases show strong preferences for specific integration sites (Ike et al., 1992, J Bacteriol 174:1801; Trieu-Cuot et al., 1993, Mol. Microbiol. 8:179).

Alternatively, IS231 and other Bacillus thuringiensis transposable elements could be used as recombination proteins and recombination sites. Bacillus thuringiensis is an entomopathogenic bacterium whose toxicity is due to the presence in the sporangia of delta-endotoxin crystals active against agricultural pests and vectors of human and animal diseases. Most of the genes coding for these toxin proteins are plasmid-borne and are generally structurally associated with insertion sequences (IS231, IS232, IS240, ISBT1 and ISBT2) and transposons (Tn4430 and Tn5401). Several of these mobile elements have been shown to be active and participate in the crystal gene mobility, thereby contributing to the variation of bacterial toxicity.

Structural analysis of the iso-IS231 elements indicates that they are related to IS1151 from Clostridium perfringens and distantly related to IS4 and IS186 from Escherichia coli. Like the other IS4 family members, they contain a conserved transposase-integrase motif found in other IS families and retroviruses. Moreover, functional data gathered from IS231 A in Escherichia coli indicate a non-replicative mode of transposition, with a preference for specific targets. Similar results were also obtained in Bacillus subtilis and B. thuringiensis. See, e.g., Mahillon, J. et al., Genetica 93:13-26 (1994); Campbell, J. Bacteriol. 7495-7499 (1992).

An unrelated family of recombinases, the transposases, have also been used to transfer genetic information between replicons. Transposons are structurally variable, being described as simple or compound, but typically encode the recombinase gene flanked by DNA sequences organized in inverted orientations. Integration of transposons can be random or highly specific. Representatives such as Tn7, which are highly site-specific, have been applied to the efficient movement of DNA segments between replicons (Lucklow et al., 1993. J. Virol 67:4566-4579).

A related element, the integron, are also translocatable-promoting movement of drug resistance cassettes from one replicon to another. Often these elements are defective transposon derivatives. Transposon Tn21 contains a class I integron called In2. The integrase (IntI1) from In2 is common to all integrons in this class and mediates recombination between two 59-bp elements or between a 59-bp element and an attI site that can lead to insertion into a recipient integron. The integrase also catalyzes excisive recombination. (Hall, 1997, Ciba Found Symp 207:192; Francia et al., 1997, J Bacteriol 179:4419).

Group II introns are mobile genetic elements encoding a catalytic RNA and protein. The protein component possesses reverse transcriptase, maturase and an endonuclease activity, while the RNA possesses endonuclease activity and determines the sequence of the target site into which the intron integrates. By modifying portions of the RNA sequence, the integration sites into which the element integrates can be defined. Foreign DNA sequences can be incorporated between the ends of the intron, allowing targeting to specific sites. This process, termed retrohoming, occurs via a DNA:RNA intermediate, which is copied into cDNA and ultimately into double stranded DNA (Matsuura et al., Genes and Dev 1997; Guo et al., EMBO J, 1997). Numerous intron-encoded homing endonucleases have been identified (Belfort and Roberts, 1997, NAR 25:3379). Such systems can be easily adopted for application to the described subcloning methods.

The amount of recombinase which is added to drive the recombination reaction can be determined by using known assays. Specifically, titration assay is used to determine the appropriate amount of a purified recombinase enzyme, or the appropriate amount of an extract.

### Engineered Recombination Sites

The above recombinases and corresponding recombinase sites are suitable for use in recombinational cloning according to the present invention. However, wild-type recombination sites may contain sequences that reduce the efficiency or specificity of recombination reactions or the function of the product molecules as applied in methods of the present invention. For example, multiple stop codons in attB, attR, attP, attL and loxP recombination sites occur in multiple reading frames on both strands, so translation efficiencies are reduced, e.g., where the coding sequence must cross the recombination sites, (only one reading frame is available on each strand of loxP and attB sites) or impossible (in attP, attR or attL).

Accordingly, the present invention also utilizes engineered recombination sites that overcome these problems. For example, att sites can be engineered to have one or multiple mutations to enhance specificity or efficiency of the recombination reaction and the properties of product DNAs (e.g., att1, att2, and att3 sites); to decrease reverse reaction (e.g., removing P1 and H1 from attR). The testing of these mutants determines which mutants yield sufficient recombinational activity to be suitable for recombination subcloning according to the present invention.

Mutations can therefore be introduced into recombination sites for enhancing site-specific recombination. Such mutations include, but are not limited to: recombination sites without translation stop codons that allow fusion proteins to be encoded; recombination sites recognized by the same proteins but differing in base sequence such that they react largely or exclusively with their homologous partners allowing multiple reactions to be contemplated; and mutations that prevent hairpin formation of recombination sites. Which particular reactions take place can be specified by which particular partners are present in the reaction mixture. For example, a tripartite protein fusion could be accomplished with parental plasmids containing recombination sites attR1 and attL1; and attB3; attR1; attP3 and 10xP; and/or attR3 and 10xP; and/or attR3 and attL2.

There are well known procedures for introducing specific mutations into nucleic acid sequences. A number of these are described in Ausubel, F. M. et al., Current Protocols in Molecular Biology, Wiley Interscience, New York (1989-1996). Mutations can be designed into oligonucleotides, which can be used to modify existing cloned sequences, or in amplification reactions. Random mutagenesis can also be employed if appropriate selection methods are available to isolate the desired mutant DNA or RNA. The presence of the desired mutations can be confirmed by sequencing the nucleic acid by well known methods.

The following non-limiting methods can be used to modify or mutate a core region of a given recombination site to provide mutated sites that can be used in the present invention:

1. By recombination of two parental DNA sequences by site-specific (e.g., attL and attR to give attB) or other (e.g., homologous) recombination mechanisms where the parental DNA segments contain one or more base alterations resulting in the final mutated core sequence;

2. By mutation or mutagenesis (site-specific, PCR, random, spontaneous, etc) directly of the desired core sequence;

3. By mutagenesis (site-specific, PCR, random, spontaneous, etc) of parental DNA sequences, which are recombined to generate a desired core sequence;

4. By reverse transcription of an RNA encoding the desired core sequence; and

5. By de novo synthesis (chemical synthesis) of a sequence having the desired base changes.

The functionality of the mutant recombination sites can be demonstrated in ways that depend on the particular characteristic that is desired. For example, the lack of translation stop codons in a recombination site can be demonstrated by expressing the appropriate fusion proteins. Specificity of recombination between homologous partners can be demonstrated by introducing the appropriate molecules into in vitro reactions, and assaying for recombination products as described herein or known in the art. Other desired mutations in recombination sites might include the presence or absence of restriction sites, translation or transcription start signals, protein binding sites, and other known functionalities of nucleic acid base sequences. Genetic selection schemes for particular functional attributes in the recombination sites can be used according to known method steps. For example, the modification of sites to provide (from a pair of sites that do not interact) partners that do interact could be achieved by requiring deletion, via recombination between the sites, of a DNA sequence encoding a toxic substance. Similarly, selection for sites that remove translation stop sequences, the presence or absence of protein binding sites, etc., can be easily devised by those skilled in the art.

The nucleic acid molecule can have at least one mutation that confers at least one enhancement of said recombination, said enhancement selected from the group consisting of substantially (i) favoring integration; (ii) favoring recombination; (ii) relieving the requirement for host factors; (iii) increasing the efficiency of said Cointegrate DNA or Product DNA formation; and (iv) increasing the specificity of said Cointegrate DNA or Product DNA formation.

In suitable embodiments of the present invention, the core region of the recombination site comprises a DNA sequence selected from the group consisting of:

| | |
|---|---|
| (a) RKYCWGCTTTYKTRTACNAASTSGB | (SEQ ID NO:1) |
| (m-att); | |
| (b) AGCCWGCTTTYKTRTACNAACTSGB | (SEQ ID NO:2) |
| (m-attB); | |
| (c) GTTCAGCTTTCKTRTACNAACTSGB | (SEQ ID NO:3) |
| (m-attR); | |
| (d) AGCCWGCTTTCKTRTACNAAGTSGB | (SEQ ID NO:4) |
| (m-attL); | |
| (e) GTTCAGCTTTYKTRTACNAAGTSGB | (SEQ ID NO:5) |
| (m-attP1); | |
| (f) RBYCW GCTTTYTTRTACWAA STKGD | (SEQ ID NO:6) |
| (n-att); | |
| (g) ASCCW GCTTTYTTRTACWAA STKGW | (SEQ ID NO:7) |
| (n-attB); | |
| (h) ASCCW GCTTTYTTRTACWAA GTTGG | (SEQ ID NO:8) |
| (n-attL); | |
| (i) GTTCA GCTTTYTTRTACWAA STKGW | (SEQ ID NO:9) |
| (n-attR); | |
| (j) GTTCA GCTTTYTTRTACWAA GTTGG | (SEQ ID NO:10) |
| (n-attP); | |

or a corresponding or complementary DNA or RNA sequence, wherein R=A or G; K=G or T/U; Y=C or T/U; W=A or T/U; N=A or C or G or T/U; S=C or G; and B=C or G or T/U, as presented in 37 C.F.R. §1.822, which is entirely incorporated herein by reference, wherein the core region does not contain a stop codon in one or more reading frames.

The core region also suitably comprises a DNA sequence selected from the group consisting of:

| | |
|---|---|
| (a) AGCCTGCTTTTTTGTACAAACTTGT | (SEQ ID NO:11) |
| (attB1); | |
| (b) AGCCTGCTTTCTTGTACAAACTTGT | (SEQ ID NO:12) |
| (attB2); | |
| (c) ACCCAGCTTTCTTGTACAAAGTGGT | (SEQ ID NO:13) |
| (attB3); | |
| (d) GTTCAGCTTTTTTGTACAAACTTGT | (SEQ ID NO:14) |
| (attR1); | |
| (e) GTTCAGCTTTCTTGTACAAACTTGT | (SEQ ID NO:15) |
| (attR2); | |
| (f) GTTCAGCTTTCTTGTACAAAGTGGT | (SEQ ID NO:16) |
| (attR3); | |
| (g) AGCCTGCTTTTTTGTACAAAGTTGG | (SEQ ID NO:17) |
| (attL1); | |
| (h) AGCCTGCTTTCTTGTACAAAGTTGG | (SEQ ID NO:18) |
| (attL2); | |
| (i) ACCCAGCTTTCTTGTACAAAGTTGG | (SEQ ID NO:19) |
| (attL3); | |
| (j) GTTCAGCTTTTTTGTACAAAGTTGG | (SEQ ID NO:20) |
| (attP1); | |
| (k) GTTCAGCTTTCTTGTACAAAGTTGG | (SEQ ID NO:21) |
| (attP2,P3); | |

a corresponding or complementary DNA or RNA sequence.

The present invention thus also provides a methods of generating and cloning a nucleic acid molecule having at least one engineered recombination site comprising at least one DNA sequence having at least 80-99% homology (or any range or value therein) to at least one of the above sequences, or any suitable recombination site, or which hybridizes under stringent conditions thereto, as known in the art.

Clearly, there are various types and permutations of such well-known in vitro and in vivo selection methods, each of which are not described herein for the sake of brevity. However, such variations and permutations are contemplated and considered to be the different embodiments of the present invention.

It is important to note that as a result of the preferred embodiment being in vitro recombination reactions, non-biological molecules such as PCR products can be manipulated via the present recombinational cloning method.

### Vectors

In accordance with the invention, any vector may be used to construct the vectors of the invention. In particular, vectors known in the art and those commercially available (and variants or derivatives thereof) may in accordance with the invention be engineered to include one or more recombination sites for use in the methods of the invention. Such vectors may be obtained from, for example, Vector Laboratories Inc., Invitrogen, Promega, Novagen, NEB, Clontech, Boehringer Mannheim, Pharmacia, EpiCenter, OriGenes Technologies Inc., Stratagene, Perkin Elmer, Pharmingen, Life Technologies, Inc., and Research Genetics. Such vectors may then for example be used for cloning or subcloning nucleic acid molecules of interest. General classes of vectors of particular interest include prokaryotic and/or eukaryotic cloning vectors, expression vectors, fusion vectors, two-hybrid or reverse two-hybrid vectors, shuttle vectors for use in different hosts, mutagenesis vectors, transcription vectors, vectors for receiving large inserts and the like.

Other vectors of interest include viral origin vectors (M13 vectors, bacterial phage λ vectors, adenovirus vectors, and retrovirus vectors), high, low and adjustable copy number vectors, vectors which have compatible replicons for use in combination in a single host (pACYC184 and pBR322) and eukaryotic episomal replication vectors (pCDM8).

Particular vectors of interest include prokaryotic expression vectors such as pcDNA II, pSL301, pSE280, pSE380, pSE420, pTrcHisA, B, and C, pRSET A, B, and C (Invitrogen Corporation), pGEMEX-1, and pGEMEX-2 (Promega, Inc.), the pET vectors (Novagen, Inc.), pTrc99A, pKK223-3, the pGEX vectors, pEZZ18, pRIT2T, and pMC1871 (Pharmacia, Inc.), pKK233-2 and pKK388-1 (Clontech, Inc.), and pProEx-HT (Invitrogen Corporation) and variants and derivatives thereof. Vector donors can also be made from eukaryotic expression vectors such as pFastBac, pFastBac HT, pFastBac DUAL, pSFV, and pTet-Splice (Invitrogen Corporation), pEUK-C1, pPUR, pMAM, pMAMneo, pBI101, pBI121, pDR2, pCMVEBNA, and pYACneo (Clontech), pSVK3, pSVL, pMSG, pCH110, and pKK232-8 (Pharmacia, Inc.), p3′SS, pXT1, pSG5, pPbac, pMbac, pMC1neo, and pOG44 (Stratagene, Inc.), and pYES2, pAC360, pBlueBacHis A, B, and C, pVL1392, pBlueBacIII, pCDM8, pcDNA1, pZeoSV, pcDNA3 pREP4, pCEP4, and pEBVHis (Invitrogen Corporation) and variants or derivatives thereof.

Other vectors of particular interest include pUC18, pUC19, pBlueScript, pSPORT, cosmids, phagemids, YAC's (yeast artificial chromosomes), BAC's (bacterial artificial chromosomes), P1 (E. coli phage), pQE70, pQE60, pQE9 (quagan), pBS vectors, PhageScript vectors, BlueScript vectors, pNH8A, pNH16A, pNH18A, pNH46A (Stratagene), pcDNA3 (Invitrogen Corporation), pGEX, pTrsfus, pTrc99A, pET-5, pET-9, pKK223-3, pKK233-3, pDR540, pRIT5 (Pharmacia), pSPORT1, pSPORT2, pCMVSPORT2.0 and pSV-SPORT1 (Invitrogen Corporation) and variants or derivatives thereof.

Additional vectors of interest include pTrxFus, pThioHis, pLEX, pTrcHis, pTrcHis2, pRSET, pBlueBacHis2, pcDNA3.1/His, pcDNA3.1(−)/Myc-His, pSecTag, pEBVHis, pPIC9K, pPIC3.5K, pAO815, pPICZ, pPICZα, pGAPZ, pGAPZα, pBlueBac4.5, pBlueBacHis2, pMelBac, pSinRep5, pSinHis, pIND, pIND(SP1), pVgRXR, pcDNA2.1. pYES2, pZErO1.1, pZErO-2.1, pCR-Blunt, pSE280, pSE380, pSE420, pVL1392, pVL1393, pCDM8, pcDNA1.1, pcDNA1.1/Amp, pcDNA3.1, pcDNA3.1/Zeo, pSe, SV2, pRc/CMV2, pRc/RSV, pREP4, pREP7, pREP8, pREP9, pREP10, pCEP4, pEBVHis, pCR3.1, pCR2.1, pCR3.1-Uni, and pCRBac from Invitrogen; λExCell, λ gt11, pTrc99A, pKK223-3, pGEX-1λT, pGEX-2T, pGEX-2TK, pGEX-4T-1, pGEX-4T-2, pGEX-4T-3, pGEX-3X, pGEX-5X-1, pGEX-5X-2, pGEX-5X-3, pEZZ18, pRIT2T, pMC1871, pSVK3, pSVL, pMSG, pCH110, pKK232-8, pSL1180, pNEO, and pUC4K from Pharmacia; pSCREEN-1b(+), pT7Blue(R), pT7Blue-2, pCITE-4abc(+), pOCUS-2, pTAg, pET-32 LIC, pET-30 LIC, pBAC-2 cp LIC, pBACgus-2 cp LIC, pT7Blue-2 LIC, pT7Blue-2, λSCREEN-1, λBlueSTAR, pET-3abcd, pET-7abc, pET9abcd, pET11abcd, pET12abc, pET-14b, pET-15b, pET-16b, pET-17b-pET-17xb, pET-19b, pET-20b(+), pET-21abcd(+), pET-22b(+), pET-23abcd(+), pET-24abcd(+), pET-25b(+), pET-26b(+), pET-27b(+), pET-28abc(+), pET-29abc(+), pET-30abc(+), pET-31b(+), pET-32abc(+), pET-33b(+), pBAC-1, pBACgus-1, pBAC4x-1, pBACgus4x-1, pBAC-3 cp, pBACgus-2 cp, pBACsurf-1, plg, Signal plg, pYX, Selecta Vecta-Neo, Selecta Vecta-Hyg, and Selecta Vecta-Gpt from Novagen; pLexA, pB42AD, pGBT9, pAS2-1, pGAD424, pACT2, pGAD GL, pGAD GH, pGAD10, pGilda, pEZM3, pEGFP, pEGFP-1, pEGFP-N, pEGFP-C, pEBFP, pGFPuv, pGFP, p6xHis-GFP, pSEAP2-Basic, pSEAP2-Contral, pSEAP2-Promoter, pSEAP2-Enhancer, pβgal-Basic, pβgal-Control, pβgal-Promoter, pβgal-Enhancer, pCMVβ, pTet-Off, pTet-On, pTK-Hyg, pRetro-Off, pRetro-On, pIRES1neo, pIRES1hyg, pLXSN, pLNCX, pLAPSN, pMAMneo, pMAMneo-CAT, pMAMneo-LUC, pPUR, pSV2neo, pYEX 4T-1/2/3, pYEX-S1, pBacPAK-His, pBacPAK8/9, pAcUW31, BacPAK6, pTriplEx, λgt10, λgt11, pWE15, and λTriplEx from Clontech; Lambda ZAP II, pBK-CMV, pBK-RSV, pBluescript II KS +/−, pBluescript II SK +/−, pAD-GAL4, pBD-GAL4 Cam, pSurfscript, Lambda FIX II, Lambda DASH, Lambda EMBL3, Lambda EMBL4, SuperCos, pCR-Scrigt Amp, pCR-Script Cam, pCR-Script Direct, pBS +/−, pBC KS +/−, pBC SK +/−, Phagescript, pCAL-n-EK, pCAL-n, pCAL-c, pCAL-kc, pET-3abcd, pET-11abcd, pSPUTK, pESP-1, pCMVLacI, pOPRSVI/MCS, pOPI3 CAT, pXT1, pSG5, pPbac, pMbac, pMC1neo, pMC1neo Poly A, pOG44, pOG45, pFRTβGAL, pNEOβGAL, pRS403, pRS404, pRS405, pRS406, pRS413, pRS414, pRS415, and pRS416 from Stratagene.

Two-hybrid and reverse two-hybrid vectors of particular interest include pPC86, pDBLeu, pDBTrp, pPC97, p2.5, pGAD1-3, pGAD10, pACt, pACT2, pGADGL, pGADGH, pAS2-1, pGAD424, pGBT8, pGBT9, pGAD-GAL4, pLexA, pBD-GAL4, pHISi, pHISi-1, placZi, pB42AD, pDG202, pJK202, pJG4-5, pNLexA, pYESTrp and variants or derivatives thereof.

### Generation of Allele Libraries

In one embodiment, the present invention provides methods for generating a library of full-length target sequences, including: (a) providing a first vector comprising a first recombination site, a second recombination site, and a selectable marker gene; (b) mixing at least one nucleic acid molecule comprising a third recombination site, a target sequence, and a fourth recombination site with the first vector to generate a mixture; (c) incubating the mixture in the presence of at least one recombination protein under conditions sufficient to cause recombination between the first and third recombination sites and the second and fourth recombination sites, thereby generating a target sequence selection construct comprising a fifth recombination site, a target sequence, a sixth recombination site, and a selectable marker; (d) introducing the target sequence selection construct into a host cell; (e) incubating the host cell under conditions sufficient to express the selectable marker gene; and (f) selecting for host cells expressing the selectable marker to obtain a library of full-length target sequences comprising nucleic acid molecules encoding, in order, the fifth recombination site, a full length target gene, the sixth recombination site, and the selectable marker.

The first vector is designed for screening of full-length target sequences. As used herein, target sequences are any sequences of interest that include an open reading frame. The open reading frame may be the entire open reading frame of a known protein, or can be one or more identified domains of a protein, or can even be a designed protein not known to be naturally occurring. As used herein “full length” means that the reading frame of the sequence of interest has not been truncated, and extends from the first open reading frame codon (at the 5′ end or within the sequence of interest) to the end of the sequence of interest without an intervening stop codon. Where the target sequences used in the methods of the present invention are known, or are based on known sequences, the target sequences are preferably generated such that they will allow for an open reading frame extending from the target sequence open reading frame, through the sixth recombination site of a generated target sequence selection construct, into and through the selectable marker gene open reading frame. This allows a target protein-selectable marker fusion protein can be expressed from the target sequence selection construct.

In some preferred embodiments, the target sequence encodes a protein of interest or at least a portion of a protein of interest, and allele libraries of the target sequence are generated by mutagenesis. Mutagenesis of a sequence can be performed by any mutagenesis methods known in the art or later developed. For example, PCR conditions can be manipulated to generate mutant target sequences, and in particular allele libraries of mutant target sequences. The methods of the present invention provide means for avoiding selection of truncated lack-of-function alleles and favor selection of full-length alleles that have altered amino acid sequences by providing an efficient selection scheme for alleles that “read through” and read into a selectable marker gene.

The present invention therefore includes methods of generating a full length allele library, where the method includes generating alleles of one or more target sequences by mutagenesis, and producing full-length allele libraries of one or more target sequences by recombinational cloning of the target sequence alleles in an expression vector that includes a selectable marker, in which cloning of an full-length allele into the vector provides an in-frame fusion with the selectable marker. In these embodiments, the method includes: providing a first vector comprising a first recombination site, a second recombination site, and a selectable marker gene; providing a population of target sequence alleles flanked by a third recombination site on one end and a fourth recombination site on the other end, in which the population of target sequence alleles has been generated by mutagenesis of at least one target nucleic acid molecule; mixing the population of target sequence alleles with the first vector to generate a mixture; and incubating the mixture in the presence of at least one recombination protein under conditions sufficient to cause recombination between the first and third recombination sites and the second and fourth recombination sites, thereby generating a population of target sequence allele selection constructs comprising a fifth recombination site, a target sequence allele, a sixth recombination site, and the selectable marker gene. To select for full length alleles, the population of selection constructs is introduced into a host cell; the host cell is incubated under conditions sufficient for the host cell to express the selectable marker gene; and host cells expressing the selectable marker are selected to obtain a library of full-length target alleles comprising nucleic acid molecules encoding, in order, the fifth recombination site, a full length target alleles, the sixth recombination site, and the selectable marker.

In suitable embodiments of the present invention, the mixing and incubating for recombinational cloning are performed in vitro. The full length target alleles of the library are fused in frame with the selectable marker via an open reading frame that extends through the sixth recombination site of the selection construct and the target selection construct includes a promoter that promotes expression of target sequences in the host cells.

Vectors suitable for use in the practice of the present invention can comprise any recombination site (or combinations thereof) including those described throughout, including, but not limited to, att sites, lox sites, frt sites, psi sites, dif sites and cer sites. In suitable embodiments, the first and second recombination sites on the first vector described above do not recombine with each other, though in other embodiments they can. In preferred embodiments, the first and second recombination sites on the first vector are att sites. In certain embodiments the first and second recombination sites are attP sites. Preferably the second recombination site of the vector does not include a stop codon in frame with the selectable marker gene. This prevents the generated sixth recombination site of the selection constructs from having a stop codon that can abort readthrough from the target sequence to the selectable marker.

In some preferred embodiments of vectors used in the present invention, any stop codons of a recombination site that will occurs between a target sequence and a selectable marker sequence of a target sequence selection construct are removed. The selectable marker utilized in the first vector described above invention can be any selectable marker, such as any positive selectable marker or any negative selectable marker known in the art, including those described throughout. In suitable embodiments, the selectable marker will be an antibiotic resistance gene, and can be for example, an ampicillin resistance gene, a tetracycline resistance gene, a spectinomycin resistance gene, a kanamycin resistance gene, or a chloramphenicol resistance gene.

Vectors useful in the practice of the present invention can also further comprise additional nucleic acid segments, including, but not limited to, promoters, operators, origins of replication restriction sites, additional recombination sites, repressor genes, and additional selectable markers, as discussed throughout. In certain embodiments, the vectors of the present invention will comprise a promoter under the control of an operator. The first vector is designed for expression of the target sequence linked in frame to a selectable marker gene. The first vector therefore preferably has a promoter situated upstream from the first recombination site for expression of the target sequence-selectable marker fusion protein. The promoter is preferably inducible. Inducible promoters are known in the art and also exemplified herein.

In one embodiment, the first vector used in the methods of the invention can include a selectable marker, which more preferably can be a counter-selectable marker, between the first and second recombination sites. The marker can be used to select for constructs in which a target sequence has replaced the counter-selectable marker during a recombinational cloning step.

The first vector can be designed for replication and expression in any cell type, but most conveniently for replication and expression of sequences in bacteria, such as E. coli, which have a high transformation efficiency and simple selection schemes.

In one embodiment, the present invention provides for a vector as shown in FIG. 1, depicting a vector map of the pDONR-Express vector. This vector can be used in the methods of the present invention to generate allele libraries for use in identification of interaction domains in yeast-hybrid systems as described throughout. Vector pDONR-Express is a modified pDONR vector (Invitrogen Corporation, Carlsbad, Calif.) that allows for the isolation of full length open reading frames (ORFs) (i.e., full length target sequences) via site-specific recombination reaction and positive selection of transformed E. coli on media containing kanamycin.

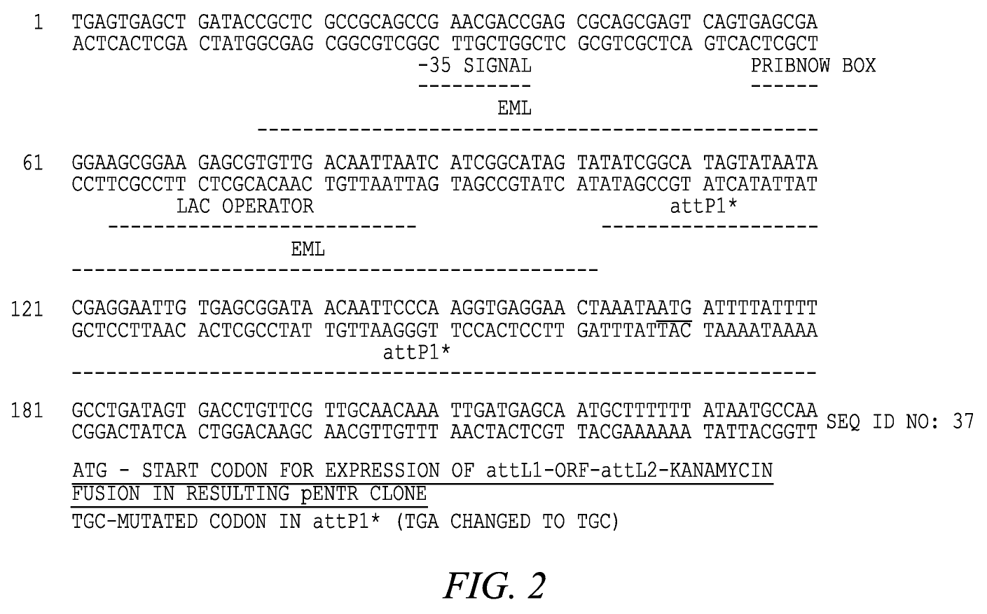

The pDONR-Express vector differs from traditional pDONR vectors in the following ways: 1) An EML promoter upstream of the recombinational cloning site—this is a novel IPTG-inducible promoter constructed by integrating the lac operator into the EM-7 promoter, 2) attP1*—this a mutated attP1 site containing a A→C mutation at position 20 (this mutation converts a TGA codon to TGC), 3) a Kanamycin resistance gene located downstream and in-frame with attP2, and 4) lacIQ—which allows constitutive expression of the lacI gene, which binds to the lac operator in the EML promoter and suppresses gene expression in the absence of IPTG. Therefore, under the control of the lac operator, in the absence of IPTG, the pDONR-Express vector does not express any target sequence that has been cloned into it. An inducible promoter integrated into pDONR-Express is used to check the gene of interest for cryptic promoter activity, which will produce false positives by expressing partial open reading frames (ORFs) fused to attL2-Kan^{R}. The vector can be used to select for ORFs coding for full-length proteins by simply inducing expression with IPTG after E. coli transformation and plating on media containing kanamycin. The resulting fusion consists of attL1-ORF-attL2-Kan^{R}. FIG. 2 depicts the sequence of the EML promoter and the start (ATG) and mutated codon (TGC) in attP1*.

By mixing an isolated nucleic acid molecule comprising a third recombination site, a full length target sequence, and a fourth recombination site, with the first vector to generate a mixture, and incubating the mixture in the presence of at least one recombination protein under conditions sufficient to cause recombination between the first and third recombination sites and the second and fourth recombination sites, a target sequence selection construct is generated which comprises a fifth recombination site and a sixth recombination site. Methods for adding recombination sites to target sequences are well known in the art and include PCR amplification using primers as described throughout and the use of adapter molecules to add recombination sites.

The recombination sites utilized in all aspects of the present invention can be any recombination sites known in the art, including those discussed throughout, for example, att sites, lox sites, frt sites, psi sites, dif sites or cer sites. In suitable embodiments though, they will be att sites. In one embodiment, when attP recombination sites are utilized in the first vector as described above, the third and fourth recombination sites flanking a full length target sequence will be attB sites. In such an embodiment, upon incubation with the appropriate recombination proteins (i.e., Int and IHF) and under appropriate conditions, a site-specific recombination reaction will take place between the attB sites flanking the full length target sequence and the attP sites on the first vector thereby generating a second vector comprising a fifth and sixth recombination site (in this case attL sites). As noted throughout, other recombination sites and recombination schemes can be used in the practice of the present invention.

While the mixing and recombination reactions discussed throughout can take place in vivo or in vitro, suitably the mixing, incubation and recombination reaction utilized in the methods of the present invention will take place in vitro as described in U.S. Pat. Nos. 5,888,732 and 6,277,608, which are incorporated by reference herein in their entireties. The benefits of such an in vitro reaction are discussed throughout the present application, and will be familiar to those of ordinary skill in the art.

After the second vector is generated (now comprising a fifth and sixth recombination site and the full length target sequence), this second vector is suitably introduced into a host cell. Methods for introducing vectors into host cells are well known in the art and include transduction, electroporation, transfection (e.g., liposome-based transfection), and transformation.

Host cells that may be used in any aspect of the present invention include, but are not limited to, bacterial cells, yeast cells, plant cells and animal cells. Preferred bacterial host cells include Escherichia spp. cells (including E. coli cells and E. coli strains DH10B, Stb12, DH5, DB3 (deposit No. NRRL B-30098), DB3.1 (including E. coli LIBRARY EFFICIENCY7 DB3.1J Competent Cells; Invitrogen Corporation, Carlsbad, Calif.), DB4 and DB5 (deposit Nos. NRRL B-30106 and NNRL B-30107 respectively, see U.S. Published Patent Application No. 2004/0053412, the disclosure of which is incorporated by reference herein in its entirety), JDP682 and ccdA-over (See U.S. Published Application No 20040053412A1, filed Mar. 26, 2003, the disclosure of which is incorporated by reference herein in its entirety), Bacillus spp. cells (particularly B. subtilis and B. megaterium cells), Streptomyces spp. cells, Erwinia spp. cells, Klebsiella spp. cells, Serratia spp. cells (particularly S. marcessans cells), Pseudomonas spp. cells (particularly P. aeruginosa cells), and Salmonella spp. cells (particularly S. typhimurium and S. typhi cells). Preferred animal host cells include insect cells (most particularly Drosophila melanogaster cells, Spodoptera frugiperda Sf9 and Sf21 cells and Trichoplusa High Five cells), nematode cells (particularly C. elegans cells), avian cells, amphibian cells (particularly Xenopus laevis cells), reptilian cells, and mammalian cells (most particularly NIH3T3, CHO, COS, VERO, BHK and human cells). Preferred yeast host cells include Saccharomyces cerevisiae cells and Pichia pastoris cells. These and other suitable host cells are available commercially, for example from Invitrogen Corporation (Carlsbad, Calif.), American Type Culture Collection (Manassas, Va.), and Agricultural Research Culture Collection (NRRL; Peoria, Ill.).

Additional host cells that are useful in the present invention include mutant host cells and host cell strains, as well as mutants and/or derivatives thereof, that are resistant to the effects of the expression of one or more toxic genes. Host cells of this type may, for example, comprise one or more mutations in one or more genes within their genomes or on extrachromosomal or extragenomic DNA molecules (such as plasmids, phagemids, cosmids, etc.), including mutations in, for example, recA, endA, mcrA, mcrB, mcrC, hsd, deoR, tonA, and the like, in particular in recA or endA or in both recA and endA. The mutations to these host cells may render the host cells and host cell strains resistant to toxic genes including, but not limited to, ccdB, kicB, sacB, DpnI, an apoptosis-related gene, a retroviral gene, a defensin, a bacteriophage lytic gene, an antibiotic sensitivity gene, an antimicrobial sensitivity gene, a plasmid killer gene, and a eukaryotic transcriptional vector gene that produces a gene product toxic to bacteria, and most particularly ccdB. Production and use of these type of mutant host cell strains are described in commonly owned U.S. Published Patent Application No. 2004/0053412 the disclosure of which is incorporated herein by reference in its entirety.

The host cells are then incubated under sufficient conditions to allow for generation of an allele library, which comprises nucleic acid molecules that encode, in order, the fifth recombination site, the full length target gene, the sixth recombination site and the selectable marker from the first vector. Host cells comprising the selectable marker are then selected. In the case of the pDONR-Express vector, the resulting “pENTR” construct clones are expressed as attL1-ORF-attL2-Kanamycin resistant fusions, where the open reading frame (ORF) represents the full length target sequence. Only host cells that contain nucleic acid molecules encoding the full length target sequence will have Kanamycin resistance, and therefore only these cells will be selected and contain the allele libraries. The present invention allows for the production of allele libraries which contain various mutations throughout the full length target sequence, and therefore allow for identification of interaction domains of various proteins as described throughout. In other embodiments, the methods of the present invention can be used to generate full-length allele libraries of either partial, or complete, ORFs and to generate in-frame ORF fragment cDNA libraries.

In another embodiment, the present invention also provides an isolated nucleic acid molecule comprising, in order: (a) a first recombination site; (b) a full length target sequence; (c) a second recombination site; and (d) a selectable marker. The first and second recombination sites can be any recombination site as discussed throughout, but are suitably att sites, for example attL sites as results when using the pDONR-Express vector to generate the allele libraries of the present invention.

The isolated nucleic acid molecules of the present invention will suitably comprise a selectable marker selected from the group consisting of an antibiotic resistance gene, a toxic gene and a reporter gene, and suitably the selectable marker will be an antibiotic resistance gene that confers resistance to ampicillin, tetracycline, spectinomycin, kanamycin or chloramphenicol. The present invention also provides for host cells, suitably bacterial host cells such as E. coli, comprising such isolated nucleic acid molecules.

In another embodiment, the present invention provides methods for identifying a host cell comprising at least one interaction-defective allele in an allele library. The method includes producing at least one nucleic acid molecule of the present invention that includes, in the following order: a first recombination site, a target sequence full-length allele, a second recombination site, and a selectable marker gene. (Here, the recombination sites flanking the full-length allele of the target sequence selection construct are referred to as the first and second recombination sites for convenience.) The one or more nucleic acid molecules are produced using the methods provided previously herein. The one or more nucleic acid molecules are preferably from a full-length allele library. In performing the methods, isolated nucleic acid molecules are mixed with a vector comprising a third recombination site and a fourth recombination site to form a mixture and the mixture is incubated in the presence of at least one recombination protein under conditions sufficient to cause recombination between the first and third recombination sites and the second and fourth recombination sites, to generate expression constructs comprising full length alleles. The expression constructs are introduced into host cells and an additional plasmid comprising an interacting domain sequence is also introduced into host cells, in which the host cells contain a nucleic acid molecule comprising a second selectable marker that is capable of counter-selection. The host cells are incubated under conditions sufficient to allow interaction between the translated full-length alleles and the interacting domain (i.e., under conditions that allow the second selectable marker to be transcribed); and host cells are selected for in which the second selectable marker is not transcribed, in which the selected host cells include one or more interaction-defective alleles.

In certain such embodiments of the present invention, the first and second recombination sites will be attL sites and the third and fourth recombination sites will be attR sites. Incubating the mixture of the first vector and the isolated nucleic acid molecule, suitably in vitro, under appropriate conditions will generate a recombination reaction between the attL sites on the nucleic acid molecule and the attR sites on the first vector, thereby producing an expression construct comprising the full length target sequence but lacking the first selectable marker (e.g., the antibiotic resistance gene) from the isolated nucleic acid molecule. In addition, the expression construct now also comprises attB sites flanking the full length target sequence. In suitable embodiments, the nucleic acid molecule comprising the second selectable marker capable of counter-selection can be integrated into the host cell (e.g., yeast) genome, or can exist in a plasmid or other suitable nucleic acid construct (e.g., vector).

In one embodiment, the present invention provides methods and nucleic acid constructs useful in yeast two-hybrid systems, as well as other cell systems, including mammalian and bacterial cell systems. In these systems, the vectors used in the methods of the invention are yeast vectors. Suitably these methods and nucleic acid constructs utilize site-specific recombinational cloning, and site-specific recombination sites discussed throughout, in order to manipulate nucleic acid molecules.

A yeast two-hybrid system is generated by introducing the second vector (discussed above) along with a plasmid comprising an interacting domain into a host cell which contains a nucleic acid molecule comprising a second selectable marker that is capable of counter-selection. An interaction between two proteins will facilitate expression of the second selectable marker. In suitable embodiments this second selectable marker will induce toxicity to 5-FOA when expressed and will suitably be a URA3 gene, though any selectable marker/compound combination as described herein can be used. For example, additional combined selectable marker/compound systems include, but are not limited to, the CYH2 gene with the drug Cycloheximide (see, The Reverse Two-hybrid System: A Genetic Scheme for Selection Against Specific Protein/Protein Interactions, Nucleic Acids Res. 124:3341-7 (1996)), LYS2 gene with the compound α-aminoadipate (see, Selection of lys2 Mutants of the Yeast Saccharomyces Cerevisiae by the Utilization of α-Aminoadipate, Genetics 93:51-65 (1979)), GAP1 gene with the amino acid D-histidine (see, GAP1, a novel selection and counter-selection marker for multiple gene disruptions in Saccharomyces cerevisiae, Yeast 16:1111-9 (2000)), GIN1 gene with Galactose (see, A positive selection for plasmid loss in Saccharomyces cerevisiae using galactose-inducible growth inhibitory sequences, Yeast 15:1-10 (1999)), GAL1 gene with Galactose (see, Quenching accumulation of toxic galactose-1-phosphate as a system to select disruption of protein-protein interactions in vivo, Biotechniques 37:844-52 (2004)) and any other selectable marker where expression causes cell death and/or inhibits cell growth under general or specific conditions (e.g., exposure to a drug or compound). Yeast two-hybrid systems can also use other selectable markers which produce a detectable phenotype.

The host cell is then incubated under conditions sufficient to allow interaction between the full length target sequence on the first yeast vector and the interacting domain on the second vector. Interaction between the full length target sequence and the interacting domain will allow expression of the URA3 gene, thereby initiating conversion of 5-FOA to fluoruracil and causing toxicity to the yeast cells. By selecting for host cells in which the second selectable marker is not transcribed, cells will be identified that comprise one or more interaction-defective alleles, i.e. alleles that do not interact with the interacting domain on the plasmid (e.g., mutated full length target sequences.)

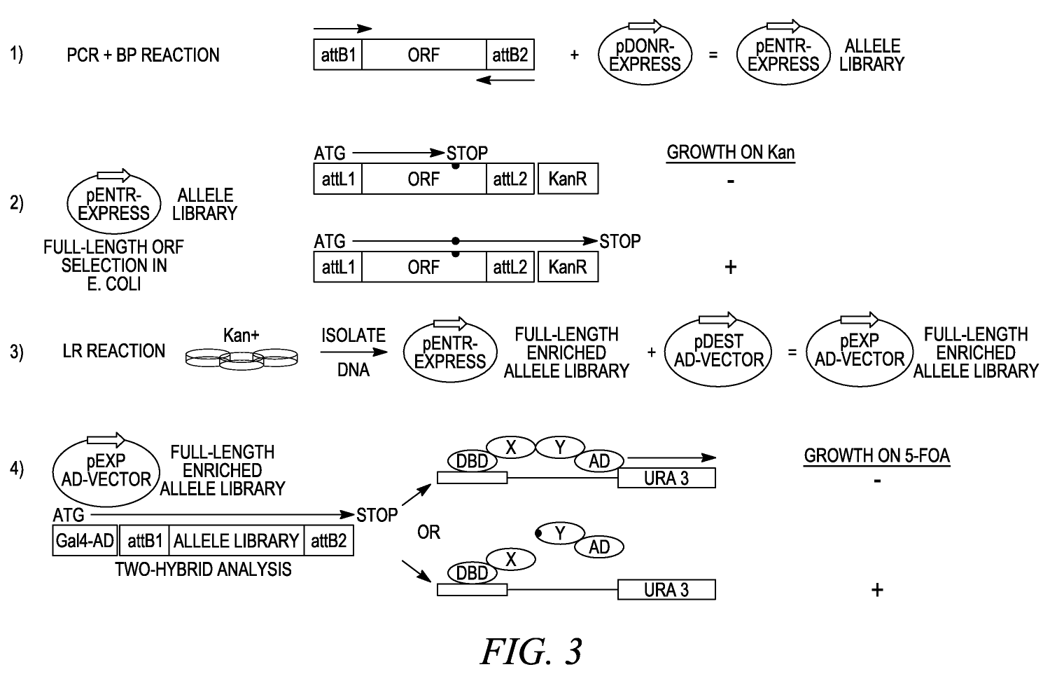

A schematic of this embodiment of the present invention is provided in FIG. 3 which shows 1) Allele libraries are generated via PCR and BP crossed into pDONR-Express (Invitrogen, Carlsbad, Calif.; Invitrogen.com) to generate pENTR allele constructs. 2) the reaction that has produced selection constructs is transformed into E. coli and plated on kanamycin media. Only ORFs coding for full-length proteins survive the kanamycin selection. 3) The pENTR full-length enriched allele library is isolated and transferred via LR reaction to a yeast two-hybrid vector that includes sequences encoding either an Activation Domain (AD) or DNA Binding Domain (DBD), thus losing the C-terminal fusion used for full-length selection. 4) The allele library is co-transformed into yeast with the bait plasmid (that includes a sequence including a binding partner protein for the sequence of interest fused to either a DBD or AD (whichever is not in the allele construct) and interaction-defective alleles will confer 5-FOA resistance. For example, the allele library can be recombinationally cloned into pDEST 22 (Invitrogen, Carlsbad, Calif.; Invitrogen.com) to generate pEXP 22 constructs that include the alleles fused in frame to the GAL4 DBD. These clones can be co-transformed with a pEXP 32 (Invitrogen, Carlsbad, Calif.; Invitrogen.com) construct that includes a sequence encoding a binding partner for a target sequence fused in frame to the GAL4 AD.

The present invention includes methods of identifying a host cell comprising at least one interaction-defective allele in an allele library using yeast two hybrid systems in which the expression constructs for expressing the alleles for functional assays in yeast are made through recombinational cloning that generates fusions of the full-length alleles with a DNA-Binding Domain or a Transcriptional Activation domain sequence.

The present invention also encompasses the use of additional two-hybrid systems including mammalian reverse two-hybrid systems using suicide genes for counter-selection, such as, but not limited to, Thymidine kinase expression in the presence of the drug Ganciclovir (see, Prodrug-activating systems in suicide gene therapy, J. Clin Invest. 105:1161-7 (2000)) and any other counterselectable marker where expression causes cell death and/or inhibits cell growth under general or specific conditions (e.g., exposure to a drug or compound). Other mammalian two-hybrid systems using reporter systems other than suicide genes, such as beta-lactamase, which produce a detectable phenotype (e.g. fluorescence) can also be used. The present invention also encompasses the use of bacterial reverse two-hybrid systems which utilize counter-selection, such as systems utilizing selectable markers including, but not limited to, CcdB (see, Bacterial death by DNA gyrase poisoning, Trends Microbiol. 6:269-75 (1998)), the SacB gene with Sucrose (see, Conditional suicide system of Escherichia coli released into soil that uses the Bacillus subtilis sacB gene, Appl Environ Microbiol. 59:1361-6 (1993)), the Tus gene with Ter DNA binding sites (see, Mutations in the Escherichia coli Tus protein define a domain positioned close to the DNA in the Tus-Ter complex, J. Biol. Chem. 270:30941-8 (1995)) and any other counterselectable marker where expression causes cell death and/or inhibits cell growth under general or specific conditions (e.g., exposure to a drug or compound). Or bacterial two-hybrid systems using other reporter systems, which produce a detectable phenotype.

In another embodiment, the present invention provides methods of identifying, and selecting for, enhanced interactions between an allele library (e.g., a full length target sequence) and an interaction domain on a second (or third, etc.) plasmid. In certain such embodiments, the interaction between the full length target sequence and the interaction domain will turn on expression of a selectable marker on a third vector or plasmid, or a selectable marker that is integrated into the host cell genome, e.g., a yeast cell. Examples of selectable markers such as antibiotic resistance genes, fluorescent proteins, toxic genes, or other such markers as described throughout, can be utilized. In such embodiments, the interaction allows for positive selection (in contrast to counter-selection), where the cells that are ultimately selected are those that comprise an interaction between the target sequence and the interaction domain (suitably an enhanced interaction), and thus express the selectable marker.

Certain such embodiments of the present invention can be used to select for enhanced interactions, i.e., screening an allele library for alleles which elicit the strongest interaction with an interaction domain. The stronger the interaction between the allele and the interaction domain, the greater the amount of selectable marker that is produced, and hence, the greater the amount of selectable marker that is monitored or detected. For example, the His3 reporter gene can be utilized in such embodiments of the present invention. Yeast cells comprising the His3 reporter gene can be plated on selection plates comprising various concentrations of 3-aminotriazole (3-AT), an inhibitor of the His3 protein (His3p). Cells which comprise a weak interaction between an allele sequence and an interaction domain will produce low levels of His3p, and thus will survive (if at all) at only very low levels of 3-AT. In contrast, cells comprising enhanced interactions and thus expressing high levels of His3p, will grow in greater number, and at higher concentrations of 3-AT. Thus, in one embodiment, the methods of the present invention provide for selection of cells comprising enhanced interactions, allowing for domain mapping of target sequences and selection of alleles that demonstrate enhanced interaction with the interaction domain. Other selectable systems, such as those described throughout and known in the art, can be used in a similar manner to select for enhanced interactions. For example, the positive selection systems of the present invention can be practiced in the various mammalian and bacterial systems discussed throughout.

In addition to analyzing protein-protein interaction, the methods of the present invention can also be used to analyze protein-DNA, protein-RNA and protein-small molecule interactions in two-hybrid systems, including, but not limited to those systems described throughout.

The present invention also provides methods for isolating and sequencing the non-interactive alleles (e.g., mutant alleles) to determine the nucleic acid sequence of the full length target sequence. Methods for isolation of such alleles are well known in the art and described in Maniatis id. and similar texts. Following isolation of the non-interactive alleles, the nucleic acid sequence of the full length target sequence can be readily determined using well known methods to sequence and amplify the target sequence as needed. The present invention therefore provides methods of determining the sequence of a non-interactive allele identified using the methods and nucleic acid constructs described throughout.

The methods of the present invention expedite and simplify the process of conducing a reverse two-hybrid screen. Since full-length selection occurs in E. coli, yeast are co-transformed with the bait plasmid and intact library plasmids that are enriched for full-length ORFs, which is a significant advantage over existing techniques because (i) the need to generate a competent bait strain is negated, (ii) higher transformation efficiencies are achieved in yeast and (iii) yeast are plated directly onto media containing 5-FOA, which eliminates the need to replicate plate thousands of colonies from media used for plasmid selection to media containing 5-FOA. Thus, pDONR-Express facilitates the high-throughput analysis of protein-protein interactions and the isolation of interaction-defective alleles, which may be used to dissect biological processes in vivo. In addition, pDONR-Express may be used to generate allele libraries for the analysis of protein-DNA and protein-RNA interactions, or in any system where a mutant library of a gene is desired.

The present invention also provides methods for identifying a protein interaction domain of a target protein that includes generating an allele library encoding variants of the target protein using the methods provided herein, in which the allele library is generated using recombinational cloning, the alleles of the allele library are translated in frame with a selectable marker, and full-length clones are isolated by isolating clones of the allele library that express the selectable marker. The methods include transfecting yeast cells with the full length clones, in which the yeast cells are used in a reverse 2-hybrid screen to identify alleles of the allele library that are defective in the protein interaction domain; and identifying the defective protein interaction domain of the identified alleles. Suitably the recombinational cloning is site-specific recombinational cloning, for example att site recombinational cloning, though other recombination sites, as discussed throughout, can be used.

In another embodiment, the present invention provides methods for generating an allele library in yeast cells, in which the method includes: generating an allele library encoding variants of the target protein, wherein the allele library is generated using recombinational cloning and in which alleles of the allele library are translated in frame with a selectable marker; isolating clones of the allele library that express the selectable marker, thereby isolating full length clones; and transfecting yeast cells with the full length clones, in which the yeast cells comprise a selectable marker that confers toxicity to a compound. Suitably, the recombinational cloning is site-specific recombinational cloning, for example att site recombinational cloning.

The present invention also includes alleles of target sequences isolated using the methods of the present invention. For example, the present invention includes Fos allele proteins that comprise the sequences of SEQ ID NO:38; SEQ ID NO:39; SEQ ID NO:40; SEQ ID NO:41; SEQ ID NO:42; SEQ ID NO:43; SEQ ID NO:44; SEQ ID NO:45; SEQ ID NO:46; SEQ ID NO:47; SEQ ID NO:48; SEQ ID NO:49; SEQ ID NO:50; SEQ ID NO:51; SEQ ID NO:52; SEQ ID NO:53; SEQ ID NO:54; SEQ ID NO:55; SEQ ID NO:56; SEQ ID NO:57; SEQ ID NO:58; SEQ ID NO:59; SEQ ID NO:60; SEQ ID NO:61; SEQ ID NO:62; SEQ ID NO:63; SEQ ID NO:64; SEQ ID NO:65; SEQ ID NO:66; SEQ ID NO:67; SEQ ID NO:68; SEQ ID NO:69; SEQ ID NO:70; SEQ ID NO:71; SEQ ID NO:72; SEQ ID NO:73; SEQ ID NO:74; SEQ ID NO:75; SEQ ID NO:76; SEQ ID NO:77; SEQ ID NO:78; SEQ ID NO:79; SEQ ID NO:80; SEQ ID NO:81; SEQ ID NO:82; SEQ ID NO:83; SEQ ID NO:84; SEQ ID NO:85; SEQ ID NO:86; SEQ ID NO:87; SEQ ID NO:88; SEQ ID NO:89; SEQ ID NO:90; SEQ ID NO:91; SEQ ID NO:92; SEQ ID NO:93; SEQ ID NO:94; SEQ ID NO:95; SEQ ID NO:96; SEQ ID NO:97; and SEQ ID NO:98.

The present invention also includes nucleic acid molecules that comprise sequences that can be translated to produce the sequences of SEQ ID NO:38; SEQ ID NO:39; SEQ ID NO:40; SEQ ID NO:41; SEQ ID NO:42; SEQ ID NO:43; SEQ ID NO:44; SEQ ID NO:45; SEQ ID NO:46; SEQ ID NO:47; SEQ ID NO:48; SEQ ID NO:49; SEQ ID NO:50; SEQ ID NO:51; SEQ ID NO:52; SEQ ID NO:53; SEQ ID NO:54; SEQ ID NO:55; SEQ ID NO:56; SEQ ID NO:57; SEQ ID NO:58; SEQ ID NO:59; SEQ ID NO:60; SEQ ID NO:61; SEQ ID NO:62; SEQ ID NO:63; SEQ ID NO:64; SEQ ID NO:65; SEQ ID NO:66; SEQ ID NO:67; SEQ ID NO:68; SEQ ID NO:69; SEQ ID NO:70; SEQ ID NO:71; SEQ ID NO:72; SEQ ID NO:73; SEQ ID NO:74; SEQ ID NO:75; SEQ ID NO:76; SEQ ID NO:77; SEQ ID NO:78; SEQ ID NO:79; SEQ ID NO:80; SEQ ID NO:81; SEQ ID NO:82; SEQ ID NO:83; SEQ ID NO:84; SEQ ID NO:85; SEQ ID NO:86; SEQ ID NO:87; SEQ ID NO:88; SEQ ID NO:89; SEQ ID NO:90; SEQ ID NO:91; SEQ ID NO:92; SEQ ID NO:93; SEQ ID NO:94; SEQ ID NO:95; SEQ ID NO:96; SEQ ID NO:97; SEQ ID NO:99; and SEQ ID NO:99.

The present invention also includes MyoD allele protein sequences that comprise the sequences of SEQ ID NO:100; SEQ ID NO:101; SEQ ID NO:102; SEQ ID NO:103; SEQ ID NO:104; SEQ ID NO:105; SEQ ID NO:106; SEQ ID NO:107; SEQ ID NO:108; SEQ ID NO:109; SEQ ID NO: 110; NO:111; NO:112; NO:113; NO:114; NO:115; and NO:116.

The present invention also includes nucleic acid molecules that comprise sequences that can be translated to produce the sequences of SEQ ID NO:100; SEQ ID NO:101; SEQ ID NO:102; SEQ ID NO:103; SEQ ID NO:104; SEQ ID NO:105; SEQ ID NO:106; SEQ ID NO:107; SEQ ID NO:108; SEQ ID NO:109; SEQ ID NO:110; NO:111; NO:112; NO:113; NO:114; NO:115; and NO:116.

The present invention also includes RalGDS allele protein sequences that comprise the sequences of SEQ ID NO:117; SEQ ID NO:118; SEQ ID NO:119; SEQ ID NO: 110; SEQ ID NO:111; SEQ ID NO:112; SEQ ID NO:113; SEQ ID NO:114; SEQ ID NO:115; SEQ ID NO:116; SEQ ID NO:117; NO:118; NO:119; NO:120; NO:121; NO:122; NO:123; SEQ ID NO:124; SEQ ID NO:125; SEQ ID NO:126; SEQ ID NO:127; NO:128; NO:129; NO:130; NO:131; NO:132; NO:133; NO:134; and NO:135.

The present invention also includes nucleic acid molecules that comprise sequences that can be translated to produce the sequences of SEQ ID NO:117; SEQ ID NO:118; SEQ ID NO:119; SEQ ID NO: 110; SEQ ID NO:111; SEQ ID NO:112; SEQ ID NO:113; SEQ ID NO:114; SEQ ID NO:115; SEQ ID NO:116; SEQ ID NO:117; NO:118; NO:119; NO:120; NO:121; NO:122; NO:123; SEQ ID NO:124; SEQ ID NO:125; SEQ ID NO:126; SEQ ID NO:127; NO:128; NO:129; NO:130; NO:131; NO:132; NO:133;NO:134; and NO:135.

In another embodiment, the present invention provides kits for generating an allele library that include one or more of the nucleic acid constructs of the invention, such as a vector that includes, in the following order, a first recombination site, a second recombination site, and a selectable marker, and preferably a promoter upstream of the first recombination site; and at least one other reagent or research product that can be used for generating an allele library. The vector is preferably designed such that insertion of a target sequence using the first and second recombination sites generates a construct having a third recombination site, a target sequence, a fourth recombination site, and a selectable marker, in which the target sequence can be fused in-frame to the selectable marker for expression of a target sequence-selectable marker fusion protein. An exemplary vector that can be provided in kits of the present invention is the pDONR-Express vector.

A reagent or research product for generation of an allele library that can be provided in a kit of the present invention can be, without limitation, an enzyme, such as but not limited to a polymerase or recombinase (including but not limited to excision enzymes or integrases), a nucleic acid primer, a nucleic acid adapter, a buffer, host cells (such as but not limited to bacterial strains or yeast strains), media for cell growth, an antibiotic, a compound for cell selection or counter-selection, a nucleic acid construct for titrating antibiotics for selection screens, a nucleic acid construct for expressing target sequence fusions with a DNA binding domain, a nucleic acid construct for expressing target sequence fusions with an Activation domain, or any other reagent or research product that can be used for the generation and selection of allele libraries as described herein. The components of the kit can be provided in one or more tubes, vials, packets, or other containers. Preferably at least two components of the kit (which can be in separate containers) are provided together in a common package, although this is not a requirement of the present invention. The kit can include instructions for use, or can provide instructions directing a user to manuals or instructions such as on a world wide web site.

For example, the kits of the invention can provide the vector pDONR-Express and one or more control constructs for titrating selectable marker resistance for allele library constructs. For example, a kit can include the pDONR-Express vector and a control vector. The kits can optionally further include one or more antibiotics and/or media for growth of host cells.

The present invention also provides kits for generating an allele library that include one or more of the vector constructs of the invention, such as vector pDONR-Express; one or more recombination proteins; and one or more buffers.

The kits of the present invention can further comprise one or more yeast two-hybrid vectors and one or more primer nucleic acid molecules comprising a recombination site sequence or a sequence complementary thereto.

Any recombination site discussed throughout the present specification can be used in the nucleic acid constructs, primers, or adapters provided in kits of the present invention. Suitably, the recombination sites will be att sites, for example attB sites, for addition to full length target sequences in order to practice the methods of the present invention. The kits of the present invention can also further comprise one or more host cells such as but not limited to one or more yeast cells as described throughout the present invention.

In another embodiment, the present invention provides host cells comprising the one or more genetic constructs of the invention, such as vector pDONR-Express. Suitably these host cells will be E. Coli host cell, though any host cell known to the skilled artisan and described throughout can be used. In other embodiments, the present invention provides yeast cells comprising the one or more genetic constructs of the invention. For example, the present invention provides yeast cells comprising an isolated nucleic acid molecule comprising, in order, (a) a first recombination site; (b) a full length target sequence; and (c) a second recombination site. The host cell can also contain a nucleic acid molecule comprising a second selectable marker capable of counter-selection. This nucleic acid molecule comprising the second selectable marker can be integrated into the host cell genome, or can exist in a plasmid or other nucleic acid construct. This second selectable marker is only transcribed in response to a protein-protein interaction between the DBD fusion protein and AD fusion protein. In suitable embodiments, the first and second recombination sites will be att sites, such as attB sites. The selectable marker is suitably a selectable marker that allows for counter-selection of mutant full length sequences, such selectable markers include URA3, CYH2, LYS2, GAP1, GIN1, GAL1 and any other selectable marker discussed throughout or known in the art.

It will be understood by one of ordinary skill in the relevant arts that other suitable modifications and adaptations to the methods and applications described herein are readily apparent and may be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLES

The following examples discuss the selection scheme for isolating full-length alleles and applies the technology through analysis of two protein-protein interactions. First, a full-length selection scheme is demonstrated by generating an allele library of the leucine zipper region of fos and segregated full-length from truncated alleles based on E. coli growth phenotypes and then confirmed by sequencing. Second, the pDONR-Express vector (FIG. 1) was used to generate a full-length enriched allele library of the basic helix-loop-helix (bHLH) transcription factor MyoD1 and its interaction with Id1 (Benezra, R., Davis, R. L., Lockshon, D., Turner, D. L. & Weintraub, H. Cell 61:49-59 (1990)) was analyzed. It was determined that most mutations that affect interaction with Id1 were located within the bHLH region of MyoD1. Furthermore, analysis of the crystal structure of the bHLH of a MyoD homodimer (Ma, P. C. M., Rould, M. A., Weintraub, H. & Pabo, C. O. Crystal. Cell 77:451-459 (1994)) reveals that, not only are these mutations within the bHLH region, but are localized to one side of either helix 1 or helix 2, at the interaction interface. Third, the pDONR-Express vector was used to generate a full-length enriched allele library of the ras association (RA) domain of Ra1GDS and its interaction with Krev1 (See Herrmann, C., Horn, G., Spaargaren, M. and Wittinghofer, A. J. Biol. Chem. 271:6794-6800 (1996) and Serebriiskii, I., Khazak, V. and Golemis, E. A. J. Biol. Chem. 274:17080-17087 (1999)) was analyzed. Several residues were identified within the RA domain, which appear to stabilize the domain and facilitate interaction.

### Example 1

### DNA Constructs

The pDONR-Express vector was constructed using pDONR223 (Invitrogen, Carlsbad, Calif.) as the backbone. In order to express ORFs as pENTR clones in the GATEWAY™ cloning system, a promoter was placed upstream of the attP1 site and a single base pair change was made to remove a stop codon located 20 bp downstream of the 5′ end of attP1. This was accomplished by using an overlapping PCR strategy and the restriction enzymes SapI and XmnI. Neomycin phosphotransferase from pLenti3N5 DEST (Invitrogen) was PCR amplified to include EcoRV and XbaI sites and cloned downstream and in-frame with attP2. Three promoter systems were evaluated (EM-7, pBAD and LacZ promoters), with EM-7 producing the desired results. However, an inducible promoter system was needed to check the gene of interest for cryptic promoter activity, which will produce false positives by expressing partial ORFs fused to attL2-Kan^{R}. Therefore, the lacO was inserted into the EM-7 promoter, producing the IPTG-inducible EML promoter. Finally, the lacIQ promoter and gene was removed from pET101-LacZ (Invitrogen, Carlsbad, Calif.) with AvaI and SphI, treated with T4 polymerase and Klenow, then cloned into the pDONR-Express backbone, which had been digested with MluI and XhoI, followed by treatment with T4 polymerase and Klenow.

A 1081bp fragment containing the mouse MyoD1 ORF (Accession: NM_{—}010866) was PCR amplified using standard PCR conditions with Platinum Supermix HiFi (Invitrogen, Carlsbad, Calif.) and primers (5′-GGG GAC AAG TTT GTA CAA AAA AGC AGG CTC TCC GGA GTG GCA GAA AGT TAA-3′) (SEQ ID NO: 22) and (5′-GGG GAC CAC TTT GTA CAA GAA AGC TGG GTT AAG CAC CTG ATA AAT CGC AT-3′) (SEQ ID NO: 23) using a fragment originally obtained from pACT-MyoD (Promega Corp., Madison, Wis.) as a template. The fragment was amplified to include attB1 and attB2 sites (underlined), in-frame with the complete ORF of MyoD1 (minus the stop codon), and a 22 amino acids leader sequence, which is part of the 5′UTR. A 454 bp fragment containing a partial mouse Id1 ORF (amino acids 29-148, Accession: NM_{—}010495) was PCR amplified using standard PCR conditions with Platinum Supermix HiFi (Invitrogen, Carlsbad, Calif.) and the primers (5′-GGG GAC AAG TTT GTA CAA AAA AGC AGG CTC TGA ATT CCC GGG GAT CCG TCG-3′) (SEQ ID NO: 24) and (5′-GGG GAC CAC TTT GTA CAA GAA AGC TGG GTT TCA GCG ACA CAA GAT GCG AT-3′) (SEQ ID NO: 25) using a fragment originally obtained from pBIND-Id (Promega Corp., Madison, Wis.) as a template. The fragment was amplified to include attB1 and attB2 sites (underlined), in-frame with the Id1 fragment and an 11 amino acid synthetic leader sequence (EFPGIRRHKFP) (SEQ ID NO: 26). PCR products were gel purified and included in BP reactions with pDONR-Express to generate the pENTR clones pENTR/Id1 and pENTR/MyoD1. Individual pENTR clones were sequenced and then LR crossed into the ProQuest Yeast Two-hybrid vectors pDEST32 and pDEST22 (Invitrogen, Carlsbad, Calif.), respectively, yielding pEXP32/Id1 and pEXP22/MyoD1. The MyoD1 clone used in the screen contains a C98R point mutation. However, this allele is still capable of interaction with Id1, as indicated by the activation of the URA3 and HIS3 reporters in MaV203.

A 552 bp fragment containing the full-length rat Krev1 (aka Rap1A, Accession: NM_{—}002884) ORF was PCR amplified using the oligos (5′-CAC CCG TGA GTA CAA GCT AGT GGT C-3′) (SEQ ID NO: 27) and (5′-TCT CTA GAG CAG CAG ACA TGA TTT-3′) (SEQ ID NO: 28) and the template pHybCI-HK-Krev (Invitrogen, Carlsbad, Calif.). A 296 bp fragment containing the ras association domain of Ra1GDS ((Accession: L07925)) was PCR amplified using the oligos (5′-CAC CTC CAG CTC CTC ACT GCC-3′) (SEQ ID NO: 29) and (5′-CCG CTT CTT TTA GGA TGA AGT CA-3′) (SEQ ID NO: 30) and the template pYesTrp2-RalGDS (Invitrogen, Carlsbad, Calif.). Both fragments were amplified with Platinum Taq HiFi (Invitrogen, Carlsbad, Calif.) and TOPO cloned into pENTR-D-TOPO (Invitrogen, Carlsbad, Calif.) to generate the pENTR clones pENTR/Krev1 and pENTR/RalGDS, which are in-frame with the attL sites. Individual pENTR clones were sequenced and then LR crossed into the ProQuest Yeast Two-hybrid vectors pDEST32 and pDEST22 (Invitrogen, Carlsbad, Calif.), respectively, yielding pEXP32/Krev1 and pEXP22/Ra1GDS.

Various Gateway clones were used as template DNA to produce attB-flanked PCR products to test expression of these ORFs in pDONR-Express. These ORFs include E2F1 (Accession: BC052160), LacZ (Accession: L36850) and the leucine zipper region of Fos (Accession: NM_{—}005252).

### Example 2

### Mutagenic PCR

The protocol was obtained from the Powers Lab webpage at UC Davis. PCR conditions set up to generate 1 mutation for every 60 bp using the primers attB1-5′ (100 ng), attB2-3′ (100 ng), 5 μl Taq Buffer w/o MgCl2, 15 μl MgCl2 (50 mM), 4 μl MnCl2 (5 mM), 11 each of 100 mM dGTP, dCTP and dTTP and 1 μl of 10 mM dATP, 1 μl Platinum rTaq and dH₂O to 50 μl. Thirty cycles of PCR were performed at a Tm of 55° C.

### Example 3

### Allele Library Generation

The MyoD1 allele library was generated via PCR using 100 ng each of the oligos (5′-ACA AGT TTG TAC AAA AAA GCA G-3′) (SEQ ID NO: 31) and (5′-ACC ACT TTG TAC AAG AAA GCT-3′) (SEQ ID NO: 32) and pEXP22/MyoD1 (10 ng) as the template combined with 45 μl Plantinum PCR Supermix HiFi (Invitrogen, Carlsbad, Calif.) with a TM of 55° C. using standard PCR conditions. The RalGDS RA allele library was generated via PCR using 100 ng each of the oligos (5′-ACA AGT TTG TAC AAA AAA GCA G-3′) (SEQ ID NO: 31) and (5′-ACC ACT TTG TAC AAG AAA GCT-3′) (SEQ ID NO: 32) and pEXP22/Ra1GDS (10 ng) as the template combined with 45 μl Plantinum PCR Supermix (Invitrogen, Carlsbad, Calif.) with a TM of 55° C. using standard PCR conditions. PCR products were gel purified using S.N.A.P. (Invitrogen, Carlsbad, Calif.) and quantified by measuring the OD₂₆₀ value on a spectrophotometer.

### Example 4

### Library Transfer BP Reaction

The BP library transfer protocol was set up for a 1 Kb ORF. The amount of PCR product may be scaled down for smaller ORFs. Standard reactions used 450 ng of pDONR-Express, 200 ng gel purified PCR product (flanked by attB sites), 3 μl BP Buffer, 8 μl BP Clonase and TE to 20 μl. Incubation was at room temperature (25° C.) for 20 hrs. The reaction was stopped by adding 2 μl Proteinase K and incubating at 37° C. for 10 min.

### Example 5

### Kanamycin Titration

A threshold concentration of kanamycin exists for all ORFs evaluated, where Kan⁺ colonies appeared independent of IPTG induction when a kanamycin concentration below their respective threshold was used. The background growth is most likely due to cryptic promoter activity and internal RBS, which will produce a Kan⁺ phenotype in the absence of a complete attL1-ORF-attL2-Kan^{R} fusion. To minimize this background, it is necessary to determine a kanamycin concentration, which allows for a maximum number of colonies in the presence of IPTG, while suppressing growth on kanamycin in the absence of IPTG.

To determine the optimal kanamycin concentration for a particular ORF in the pDONR-Express system, set up two transformations for the BP reaction (A and B). For reactions A and B, transform 1 μl of the BP reaction into 80 μl TOP10 Electro-comp cells (electroporation settings: 1700V, 200Ω, 25 μF). Recover reaction A for 1 hr in 1 ml SOB+1 mM IPTG at 37° C./250 rpm. Recover reaction B for 1 hr in 1 ml SOB at 37° C./250 rpm. Serial dilute both reactions to 10⁻⁴ and plate 100 μl of dilutions 10⁻², 10⁻³ and 10⁻⁴. Plate serial dilutions of transformation A on LB/Spec (100 μg/ml) (test BP efficiency) and LB/Kan at concentrations of 20, 30, 40 and 50 μg/ml +1 mM IPTG. Plate serial dilutions of transformation B on LB/Spec and LB/Kan (20, 30, 40 and 50 μg/ml). Incubate plates at 30° C. for 24-36 hrs and count colonies. An optimal [Kan] will give a maximum number of colonies under IPTG induction and a minimum number (or zero) without induction.

### Example 6

### Library Representation

The generation of an allele library requires a minimum number of clones to be isolated for good library representation. This target number of clones/colonies will depend on the size of the ORF under study, with larger ORFs requiring a higher target number. Errors generated by Taq polymerase are reported to occur in a biased manner (i.e. not all types of nucleotide changes occur at equal frequencies). As a result, the number of mutations per DNA sequence generated during PCR are not expected to follow the Poisson distribution (See, Fromant, M., Blanquet, S., & Plateau, P. Anal. Biochem. 224:347-353 (1995) and Matsumura, I. & Ellington, A. D. Methods Mol. Biol. 182:259-267 (2002)). In an effort to create guidelines, it was reasoned that for a 1 kb ORF, which possesses ˜333 codons, approximately 1,000−2,000×333, (or 333,000 to 666,000) clones would be sufficient to generate good library representation.

### Example 7

### pENTR-Express Allele Library Isolation

Once the kanamycin concentration and target number of colonies has been determined, the pENTR-Express library (the pENTR-Express library is the library resulting from cloning target sequences into pDONR-Express) may be transformed and plated to generate the desired number of clones for DNA isolation. Transform 1 μl of BP reaction into 80 μl TOP10 Electro-comp cells (electroporation settings: 1700V, 200Ω, 25 μF). Recover for 1 hr in 1 ml SOB+1 mM IPTG at 37° C./250 rpm. Perform serial dilutions and plate to titer the number of Kan⁺ colonies*. Incubate plates at 30° C. for 24-36 hrs. Store the remainder of the transformation as a glycerol stock. After titer is determined, thaw glycerol stock and plate out for 20K-30K colonies/plate on X number of LB/Kan (X μg/ml)+1 mM IPTG plates to produce the overall target number of Kan⁺ colonies. In addition, serial dilute and plate some of the glycerol stock to check if there was loss in cell viability**. Incubate plates at 30° C. for 24-36 hrs, scrape colonies and midiprep DNA.

*Note: The transformation results obtained from the kanamycin titration step will give you an idea of CFUs/μl BP reaction. This number can be used to estimate how much of the transformation should be plated on LB/Kan+1 mM IPTG plates to get 20K-30K colonies/plate. As a result, the titering step above may be skipped.

**Note: If there is a loss in cell viability, plate at a higher density if the target number of colonies is not obtained.

### Example 8

### Library Transfer LR Reaction

Plasmid DNA recovered from the library transfer BP reaction yields allele libraries of the respective ORF as pENTR clones. Combine 1 μg of pDEST22 (an expression vector having recombination sites for cloning sequences as fusions to a GAL4 Activation Domain; Invitrogen.com), 500 ng pENTR-Express allele library, 3.5 μl LR Buffer, 6 μl LR Clonase and TE to 20 μl. Incubate reaction at room temperature (25° C.) for 20 hrs. Stop reaction by adding 2 μl Proteinase K and incubating at 37° C. for 10 min.

### Example 9

### pEXP22 Allele Library Isolation

The target number of clones from the LR reaction is the same number determined for the BP reaction. Transform 1 μl of the LR reaction into 80 μl TOP10 Electro-comp cells. Recover for 1 hr in 1 ml SOC at 37° C./250 rpm. Perform serial dilutions, plate to titer and make a glycerol stock. After titer is determined, thaw glycerol stock and plate out for 20-30K colonies/plate on X number of LB/Amp (100 μg/ml) plates to produce the overall target number of Amp+colonies. Incubate at 37° C. for 20-24 hrs, scrape colonies and midi- or maxi-prep DNA.

### Example 10

### Yeast Strains and Media

The reverse two-hybrid screen was conducted in the ProQuest yeast two-hybrid system (Invitrogen), which includes the Saccharomyces cerevisiae strain MaV203 (MATα, leu2-3,112, trp1-901, his3Δ200, ade2-101, gal4Δ, gal80Δ, SPAL10:: URA3, GAL1:: lacZ, HIS3_{UAS GAL1}::HIS3@ LYS2, can1^{R}, cyh2^{R}). CSM yeast media (BIO 101) was used for all experiments. CSM media containing 5-FOA was prepared as follows: 2×CSM-LW was prepared according to manufacturers instructions, 5-FOA was added at either 0.05%, 0.1% or 0.2% and the pH was adjusted to 4.5, then filter sterilized and combined with 2× agar cooled to ˜65° C. CSM-LWH+3-AT was prepared by first preparing CSM-LWH according to manufacturers instructions and then autoclaving. Media was cooled to ˜65° C. and 3-AT was added as powder to a final concentration of either 10, 25, 50 or 100 mM, stirred until dissolved and plates were poured.

### Example 11

### Protocol for conducting screen

Yeast transformations were performed according to MaV203 competent yeast cell protocol (Invitrogen, Carlsbad, Calif.) using Gateway destination vectors pDEST32 and pDEST 22 (Invitrogen.com). Briefly, 25 μl cells are mixed with 1 μg bait construct (pEXP32-Bait ORF) and 1 μg prey allele library (pEXP22-Prey allele library). pEXP32 is an expression construct in which a partner sequence (“bait”) is fused to the GAL4 DBD. pEXP22 is an expression construct in which a target sequence (“prey”) is fused to the GAL4 AD. Next, 180 μl LiAc/PEG solution is added and tube is inverted several times to mix. Incubate at 30° C. for 30 min, add 10 μl DMSO and heat shock at 42° C. for 10 min. Spin down cells at 1800 rpm, resuspend in 1 ml dH₂O, serial dilute to 10⁻². Plate 1001 of dilutions 10⁻¹ and 10⁻² on CSM-LW, and 100 μl undiluted and dilution 10⁻¹ on CSM-LW+5-FOA. Incubate plates at 30° C. for 3-5 five days. Patch colonies from CSM-LW+5-FOA onto CSM-LW (along with positive and negative control patches) and incubate at 30° C. for 2 days. Replica plate onto CSM-LW and CSM-LWH+3-AT (10 mM, 25 mM, 50 mM and 100 mM). Replica clean until patches are barely visible on the plate when held up to the light (typically after cleaning once or twice). Incubate at 30° C. for 24 hours, replica clean again and incubate at 30° C. until positive control patch is clearly visible.

### Example 12

### Plasmid Isolation from Yeast Using PureLink™

Patch yeast containing prey alleles onto a fresh CSM-LW plate, incubate at 30° C. for 1-2 days. Inoculate 4 ml of CSM-W with a match-head size amount of cells from individual patches. Incubate at 30° C., 250 rpm overnight, or until cultures are turbid (16 to 24 hrs). Collect yeast from a liquid culture (4 ml, OD₆₆₀=1.0-2.3) by centrifugation in a tabletop centrifuge at 1,500×g for 15 minutes. Resuspend the cell pellet in 1 ml 1×TE and re-pellet the cells. Resuspend the cell pellet in 240 μl Resuspension buffer containing RNase A. Add 10 μl Zymolyase (1.5 U/μl, Genotech # 786-036) and 5 μl β-mercaptoethanol. Incubate at 37° C. for 30 minutes. Add 240 μl Lysis Buffer and mix gently by inverting the tube 4-8 times. Incubate for 3-5 minutes at room temperature (It is recommended to not exceed 5 minutes). Add 340 μl of Neutralization/Binding Buffer, and immediately mix gently by inverting the tube 4-8 times. Centrifuge for 10 minutes at maximum speed in a tabletop centrifuge to clarify the cell lysate. Place a PureLink™ spin column inside a 2-ml collection tube. Pipette or decant the supernatant into the spin column. Centrifuge the column at room temperature at 10,000-14,000×g for 30-60 sec. Discard the flow through, and add 650 μl of Wash Buffer, prepared with ethanol to the column. Centrifuge the column at room temperature at 10,000-14,000×g for 30-60 sec. Discard the flow through from the collection tube, and place repeat the Wash step. Centrifuge the column at maximum speed for 2.5 minutes to remove the residual wash buffer. Place the spin column in a clean 1.7-ml elution tube. Add 70 μl of Elution Buffer or water to the center of the column. Incubate the column at room temperature for 1 min, then centrifuge at maximum speed for 2 min. Transform E. coli with 5-10 μl of the purified DNA and plate out on media containing ampicillin at 100 g/ml. Grow overnight cultures and isolate plasmid DNA from E. coli transformants using the PureLink™ HQ Kit plasmid DNA. Analyze plasmids with the restriction enzyme BsrGI.

### Example 13

### Sequence Analysis of the MyoD1 and Ra1GDS Alleles

Sequencing reactions were performed using the oligos (5′-TAT ACC GCG TTT GGA ATC ACT-3′) (SEQ ID NO: 33), and (5′-AGC CGA CAA CCT TGA TTG GAG AC-3′) (SEQ ID NO: 34), which are specific to the pDEST22 vector, and an internal primer for MyoD1 (5′-GAG CAT GTG CGC GCG CCC AG-3′) (SEQ ID NO: 35). Sequences were analyzed using Sequencher. Translation of alleles and multiple sequence alignments were performed using Vector NTI.

### Example 14

### Phenotype Confirmation

Phenotypes must be confirmed to verify initial mutant phenotypes were due to the isolated allele opposed to a background mutation in the yeast. Following the transformation protocol outlined above, alleles were retransformed into yeast along with the bait plasmid. Transformations were plated onto −LW plates, incubated for 3 days at 30° C. A master plate was created by combining two to three individual colonies from each transformation and patching onto one −LW plate with positive and negative control patches. The master plate was incubated overnight at 30° C. and then replica plated onto −LWU and −LWH+3-AT at concentrations of 10, 25, 50 and 100 mM, to test for activation of the URA3 and HIS3 reporters, respectively. Plates were replica cleaned until patches are barely visible on the plate when held up to the light (typically after cleaning once or twice). Incubate at 30° C. for 24 hours, replica clean again and incubate at 30° C. until positive control patch is clearly visible.

### Example 15

### Analysis of pDONR-Express

pDONR-Express is a modified Gateway™ donor vector that was designed to express open reading frames (ORFs) as a fusion to neomycin phosphotransferase. The key features that distinguish pDONR-Express from traditional donor vectors include (i) the EML promoter, a novel IPTG inducible promoter, (ii) attP1*, a modified attP1 site, which contains an ATG and codes for an ORF which can be fused to a gene of interest, (iii) neomycin phosphotransferase (Kan^{R}), which is located downstream and in-frame with attP2 and (iv) lacIQ, which facilitates regulation of the EML promoter. An inducible promoter was integrated into pDONR-Express to check the gene of interest for cryptic promoter activity, which will produce false positives by expressing partial ORFs fused to attL2-Kan^{R}. The vector may be used to select for ORFs coding for full-length proteins by simply inducing expression with IPTG after E. coli transformation and plating on media containing kanamycin. The resulting fusion consists of attL1-ORF-attL2-Kan^{R}. A vector map of pDONR-Express is shown in FIG. 1 and the nucleic acid sequence is shown in Table 1a.

TABLE 1a
Nucleic Acid Sequence for pDONR-Express

(SEQ ID NO. 36)

tgagtgagctgataccgctcgccgcagccgaacgaccgagcgcagcgagt
cagtgagcgaggaagcggaagagcgtgttgacaattaatcatcggcatag
tatatcggcatagtataatacgaggaattgtgagcggataacaattccca
aggtgaggaactaaataatgattttattttgcctgatagtgacctgttcg
ttgcaacaaattgatgagcaatgcttttttataatgccaactttgtacaa
aaaagctgaacgagaaacgtaaaatgatataaatatcaatatattaaatt
agattttgcataaaaaacagactacataatactgtaaaacacaacatatc
cagtcactatgaatcaactacttagatggtattagtgacctgtagtcgac
cgacagccttccaaatgttcttcgggtgatgctgccaacttagtcgaccg
acagccttccaaatgttcttctcaaacggaatcgtcgtatccagcctact
cgctattgtcctcaatgccgtattaaatcataaaaagaaataagaaaaag
aggtgcgagcctcttttttgtgtgacaaaataaaaacatctacctattca
tatacgctagtgtcatagtcctgaaaatcatctgcatcaagaacaatttc
acaactcttatacttttctcttacaagtcgttcggcttcatctggatttt
cagcctctatacttactaaacgtgataaagtttctgtaatttctactgta
tcgacctgcagactggctgtgtataagggagcctgacatttatattcccc
agaacatcaggttaatggcgtttttgatgtcattttcgcggtggctgaga
tcagccacttcttccccgataacggagaccggcacactggccatatcggt
ggtcatcatgcgccagctttcatccccgatatgcaccaccgggtaaagtt
cacgggagactttatctgacagcagacgtgcactggccagggggatcacc
atccgtcgcccgggcgtgtcaataatatcactctgtacatccacaaacag
acgataacggctctctcttttataggtgtaaaccttaaactgcatttcac
cagcccctgttctcgtcagcaaaagagccgttcatttcaataaaccgggc
gacctcagccatcccttcctgattttccgctttccagcgttcggcacgca
gacgacgggcttcattctgcatggttgtgcttaccagaccggagatattg
acatcatatatgccttgagcaactgatagctgtcgctgtcaactgtcact
gtaatacgctgcttcatagcatacctctttttgacatacttcgggtatac
atatcagtatatattcttataccgcaaaaatcagcgcgcaaatacgcata
ctgttatctggcttttagtaagccggatccacgcggcgtttacgcccccc
ctgccactcatcgcagtactgttgtaattcattaagcattctgccgacat
ggaagccatcacaaacggcatgatgaacctgaatcgccagcggcatcagc
accttgtcgccttgcgtataatatttgcccatggtgaaaacgggggcgaa
gaagttgtccatattggccacgtttaaatcaaaactggtgaaactcaccc
agggattggctgagacgaaaaacatattctcaataaaccctttagggaaa
taggccaggttttcaccgtaacacgccacatcttgcgaatatatgtgtag
aaactgccggaaatcgtcgtggtattcactccagagcgatgaaaacgttt
cagtttgctcatggaaaacggtgtaacaagggtgaacactatcccatatc
accagctcaccgtctttcattgccatacggaattccggatgagcattcat
caggcgggcaagaatgtgaataaaggccggataaaacttgtgcttatttt
tctttacggtctttaaaaaggccgtaatatccagctgaacggtctggtta
taggtacattgagcaactgactgaaatgcctcaaaatgttctttacgatg
ccattgggatatatcaacggtggtatatccagtgatttttttctccattt
tagcttccttagctcctgaaaatctcgataactcaaaaaatacgcccggt
agtgatcttatttcattatggtgaaagttggaacctcttacgtgccgatc
aacgtctcattttcgccaaagttggcccagggcttcccggtatcaacagg
gacaccaggatttatttattctgcgaagtgatcttccgtcacaggtattt
attcggcgcaaagtgcgtcgggtgatgctgccaacttagtcgactacagg
tcactaataccatctaagtagttgattcatagtgactggatatgttgtgt
tttacagtattatgtagtctgttttttatgcaaaatctaatttaatatat
tgatatttatatcattttacgtttctcgttcagctttcttgtacaaagtt
ggcattataagaaagcattgcttatcaatttgttgcaacgaacaggtcac
tatcagtcaaaataaaatcattatttgccatccagctgatatcgcctcaa
ttgaacaagatggattgcacgcaggttctccggccgcttgggtggagagg
ctattcggctatgactgggcacaacagacaatcggctgctctgatgccgc
cgtgttccggctgtcagcgcaggggcgcccggttctttttgtcaagaccg
acctgtccggtgccctgaatgaactgcaggacgaggcagcgcggctatcg
tggctggccacgacgggcgttccttgcgcagctgtgctcgacgttgtcac
tgaagcgggaagggactggctgctattgggtgaagtgccggggcaggatc
tcctgtcatctcaccttgctcctgccgagaaagtatccatcatggctgat
gcaatgcggcggctgcatacgcttgatccggctacctgcccattcgacca
ccaagcgaaacatcgcatcgagcgagcacgtactcggatggaagccggtc
ttgtcgatcaggatgatctggacgaagagcatcaggggctcgcgccagcc
gaactgttcgccaggctcaaggcgcgcatgcccgacggcgaggatctcgt
cgtgacccatggcgatgcctgcttgccgaatatcatggtggaaaatggcc
gcttttctggattcatcgactgtggccggctgggtgtggcggaccgctat
caggacatagcgttggctacccgtgatattgctgaagagcttggcggcga
atgggctgaccgcttcctcgtgctttacggtatcgccgctcccgattcgc
agcgcatcgccttctatcgccttcttgacgagttcttctgagctctagac
cagccaggacagaaatgcctcgacttcgctgctacccaaggttgccgggt
gacgcacaccgtggaaacggatgaaggcacgaacccagtggacataagcc
tgttcggttcgtaagctgtaatgcaagtagcgtatgcgctcacgcaactg
gtccagaaccttgaccgaacgcagcggtggtaacggcgcagtggcggttt
tcatggcttgttatgactgtttttttggggtacagtctatgcctcgggca
tccaagcagcaagcgcgttacgccgtgggtcgatgtttgatgttatggag
cagcaacgatgttacgcagcagggcagtcgccctaaaacaaagttaaaca
ttatgagggaagcggtgatcgccgaagtatcgactcaactatcagaggta
gttggcgtcatcgagcgccatctcgaaccgacgttgctggccgtacattt
gtacggctccgcagtggatggcggcctgaagccacacagtgatattgatt
tgctggttacggtgaccgtaaggcttgatgaaacaacgcggcgagctttg
atcaacgaccttttggaaacttcggcttcccctggagagagcgagattct
ccgcgctgtagaagtcaccattgttgtgcacgacgacatcattccgtggc
gttatccagctaagcgcgaactgcaatttggagaatggcagcgcaatgac
attcttgcaggtatcttcgagccagccacgatcgacattgatctggctat
cttgctgacaaaagcaagagaacatagcgttgccttggtaggtccagcgg
cggaggaactctttgatccggttcctgaacaggatctatttgaggcgcta
aatgaaaccttaacgctatggaactcgccgcccgactgggctggcgatga
gcgaaatgtagtgcttacgttgtcccgcatttggtacagcgcagtaaccg
gcaaaatcgcgccgaaggatgtcgctgccgactgggcaatggagcgcctg
ccggcccagtatcagcccgtcatacttgaagctagacaggcttatcttgg
acaagaagaagatcgcttggcctcgcgcgcagatcagttggaagaatttg
tccactacgtgaaaggcgagatcaccaaggtagtcggcaaataaccctcg
accgagatgcgccgcgtgcggctgctggagatggcggacgcgatggatat
gttctgccaagggttggtttgcgcattcacagttctccgcaagaattgat
tggctccaattcttggagtggtgaatccgttagcgaggtgccgccggctt
ccattcaggtcgaggtggcccggctccatgcaccgcgacgcaacgcgggg
aggcagacaaggtatagggcggcgcctacaatccatgccaacccgttcca
tgtgctcgccgaggcggcataaatcgccgtgacgatcagcggtccaatga
tcgaagttaggctggtaagagccgcgagcgatccttgaagctgtccctga
tggtcgtcatctacctgcctggacagcatggcctgcaacgcgggcatccc
gatgccgccggaagcgagaagaatcataatggggaaggccatccagcctc
gcgtcgcgaacgccagcaagacgtagcccagcgcgtcggccgccatgccg
gcgataatggcctgcttctcgccgaaacgtttggtggcgggaccagtgac
gaaggcttgagcgagggcgtgcaagattccgaataccgcaagcgacaggc
cgatcatcgtcgcgctccagcgaaagcggtcctcgccgaaaatgacccag
agcgctgccggcacctgtcctacgagttgcatgataaagaagacagtcat
aagtgcggcgacgatagtcatgccccgcgcccaccggaaggagctgactg
ggttgaaggctctcaagggcatcggtcgagatcccggtgcctaatgagtg
agctaacttacattaattgcgttgcgctcactgcccgctttccagtcggg
aaacctgtcgtgccagctgcattaatgaatcggccaacgcgcggggagag
gcggtttgcgtattgggcgccagggtggtttttcttttcaccagtgagac
gggcaacagctgattgcccttcaccgcctggccctgagagagttgcagca
agcggtccacgctggtttgccccagcaggcgaaaatcctgtttgatggtg
gttaacggcgggatataacatgagctgtcttcggtatcgtcgtatcccac
taccgagatatccgcaccaacgcgcagcccggactcggtaatggcgcgca
ttgcgcccagcgccatctgatcgttggcaaccagcatcgcagtgggaacg
atgccctcattcagcatttgcatggtttgttgaaaaccggacatggcact
ccagtcgccttcccgttccgctatcggctgaatttgattgcgagtgagat
atttatgccagccagccagacgcagacgcgccgagacagaacttaatggg
cccgctaacagcgcgatttgctggtgacccaatgcgaccagatgctccac
gcccagtcgcgtaccgtcttcatgggagaaaataatactgttgatgggtg
tctggtcagagacatcaagaaataacgccggaacattagtgcaggcagct
tccacagcaatggcatcctggtcatccagcggatagttaatgatcagccc
actgacgcgttgcgcgagaagattgtgcaccgccgctttacaggcttcga
cgccgcttcgttctaccatcgacaccaccacgctggcacccagttgatcg
gcgcgagatttaatcgccgcgacaatttgcgacggcgcgtgcagggccag
actggaggtggcaacgccaatcagcaacgactgtttgcccgccagttgtt
gtgccacgcggttgggaatgtaattcagctccgccatcgccgcttccact
ttttcccgcgttttcgcagaaacgtggctggcctggttcaccacgcggga
aacggtctgataagagacaccggcatactctgcgacatcgtataacgtta
ctggtttcacattcaccaccctgaattgactctcttccgggcgctatcat
gccataccgcgaaaggttttgcgccattcgatggtgtccgggatctcgac
gctctcccttatgcgactcctgcattaggaagcagcccagtagtaggttg
aggccgttgagcaccgccgccgcaaggaatggtgcgcgtcgttccactga
gcgtcagaccccgtagaaaagatcaaaggatcttcttgagatcctttttt
tctgcgcgtaatctgctgcttgcaaacaaaaaaaccaccgctaccagcgg
tggtttgtttgccggatcaagagctaccaactctttttccgaaggtaact
ggcttcagcagagcgcagataccaaatactgttcttctagtgtagccgta
gttaggccaccacttcaagaactctgtagcaccgcctacatacctcgctc
tgctaatcctgttaccagtggctgctgccagtggcgataagtcgtgtctt
accgggttggactcaagacgatagttaccggataaggcgcagcggtcggg
ctgaacggggggttcgtgcacacagcccagcttggagcgaacgacctaca
ccgaactgagatacctacagcgtgagctatgagaaagcgccacgcttccc
gaagggagaaaggcggacaggtatccggtaagcggcagggtcggaacagg
agagcgcacgagggagcttccagggggaaacgcctggtatctttatagtc
ctgtcgggtttcgccacctctgacttgagcgtcgatttttgtgatgctcg
tcaggggggcggagcctatggaaaaacgccagcaacgcggcctttttacg
gttcctggccttttgctggccgctcacatgttctttcctgcgttatcccc
tgattctgtggataaccgtattaccgcctt

To test pDONR-Express for kanamycin selection and EML promoter induction, pDONR-Express was BP crossed with five ORFs ranging in size from 300 bp to 3 kb and transformed int o E. coli by electroporation. The resulting entry clones were tested for their ability to confer kanamycin resistance in the presence and absence of 1 mM IPTG. Table 1b shows high numbers of kanamycin resistant colonies in the presence of 1 mM IPTG for all ORFs tested, which suggests the attL1-ORF-attL2-Kan^{R} fusion is being expressed. The absence of kanamycin resistant colonies when IPTG is excluded suggests expression of the fusion proteins are under the control of a functional lacIQ gene product and lac operator within the EML promoter. The high number of colonies on LB/Spec plates verifies that all BP reactions were successful, as non-reacted pDONR-Express contains the ccdB gene, which is toxic to TOP10 E. coli (See Bernard, P. & Couturier, M. J. Mol. Biol. 226:735-745 (1992)).

TABLE 1b
Test pDONR-Express for kanamycin selection and EML promoter function.

| | | | | | | # of |
|---|---|---|---|---|---|---|
| | | Recovery | | # of | # of colonies | colonies on |
| ORF | | in 1 mM | Dilution | colonies on | on LB/Kan + | LB/Kan |
| (size) | [Kanamycin] | IPTG | factor | LB/Spec | 1 mM IPTG | (no IPTG) |
| MyoD | 20 μg/ml | + | 10⁻³ | 820 | 30 | N/A |
| (1 kb) | | + | 10⁻⁴ | 91 | 4 | N/A |
| | | + | 10⁻⁵ | 10 | 1 | N/A |
| | | − | 10⁻³ | 800 | N/A | 0 |
| | | − | 10⁻⁴ | 78 | N/A | 0 |
| | | − | 10⁻⁵ | 10 | N/A | 0 |
| E2F1 | 30 μg/ml | + | 10⁻² | 2180 | 433 | N/A |
| (1.3 kb) | | + | 10⁻³ | 592 | 57 | N/A |
| | | + | 10⁻⁴ | 25 | 3 | N/A |
| | | − | 10⁻² | 2400 | N/A | 8 |
| | | − | 10⁻³ | 201 | N/A | 2 |
| | | − | 10⁻⁴ | 34 | N/A | 0 |
| RalGDS | 20 μg/ml | + | 10⁻³ | 2036 | 50 | N/A |
| (300 bp) | | + | 10⁻⁴ | 196 | 4 | N/A |
| | | + | 10⁻⁵ | 23 | 1 | N/A |
| | | − | 10⁻³ | 1800 | N/A | 0 |
| | | − | 10⁻⁴ | 202 | N/A | 0 |
| | | − | 10⁻⁵ | 21 | N/A | 0 |
| Fos | 50 μg/ml | + | 10⁻³ | 1199 | 124 | N/A |
| (300 bp) | | + | 10⁻⁴ | 148 | 15 | N/A |
| | | + | 10⁻⁵ | 14 | 1 | N/A |
| | | − | 10⁻³ | 1234 | N/A | 0 |
| | | − | 10⁻⁴ | 163 | N/A | 0 |
| | | − | 10⁻⁵ | 18 | N/A | 0 |
| LacZ | 50 μg/ml | + | 10⁻² | 3436 | 2000 | N/A |
| (3 Kb) | | + | 10⁻³ | 762 | 291 | N/A |
| | | + | 10⁻⁴ | 81 | 15 | N/A |
| | | − | 10⁻² | 3628 | N/A | 28 |
| | | − | 10⁻³ | 813 | N/A | 4 |
| | | − | 10⁻⁴ | 103 | N/A | 1 |

Table 1b. Test pDONR-Express for kanamycin selection and EML promoter function. ORFs ranging in size from 300 bp to 3 Kb were BP crossed into pDONR-Express. Two transformations (A and B) were set up for each ORF. Following electroporation, transformants were recovered at 37° C./250 rpm in either SOB+1 mM IPTG (A) or SOB only (B). Transformation A was serial diluted and plated on LB/Spec (100 μg/ml) and LB/Kan (20-50 μg/ml)+1 mM IPTG. Transformation B was serial diluted and plated on LB/Spec (100 μg/ml) and LB/Kan (20-50 μg/ml). All plates were incubated at 30° C. for 24-36 hrs and colonies counted.

It was necessary to titrate the amount of kanamycin used in the selection process for individual ORFs. A threshold concentration of kanamycin was found to exist for all ORFs evaluated where Kan⁺ colonies appeared independent of IPTG induction when a kanamycin concentration below their respective threshold was used. The background growth is most likely due to cryptic promoter activity and internal ribosome binding sites, which will produce a Kan⁺ phenotype in the absence of a complete attL1-ORF-attL2-Kan^{R} fusion protein. To minimize this background, it was necessary to determine a kanamycin concentration that allows for a maximum number of colonies in the presence of IPTG, while suppressing growth on kanamycin in the absence of IPTG. Of the ORFs tested, two (E2F1 and LacZ) produced colonies in the absence of 1 mM IPTG. However, the number of colonies on kanamycin media lacking IPTG is minimal compared to the number on media containing IPTG. For both of these ORFs, an average of 3.1%-3.5% background was detected.

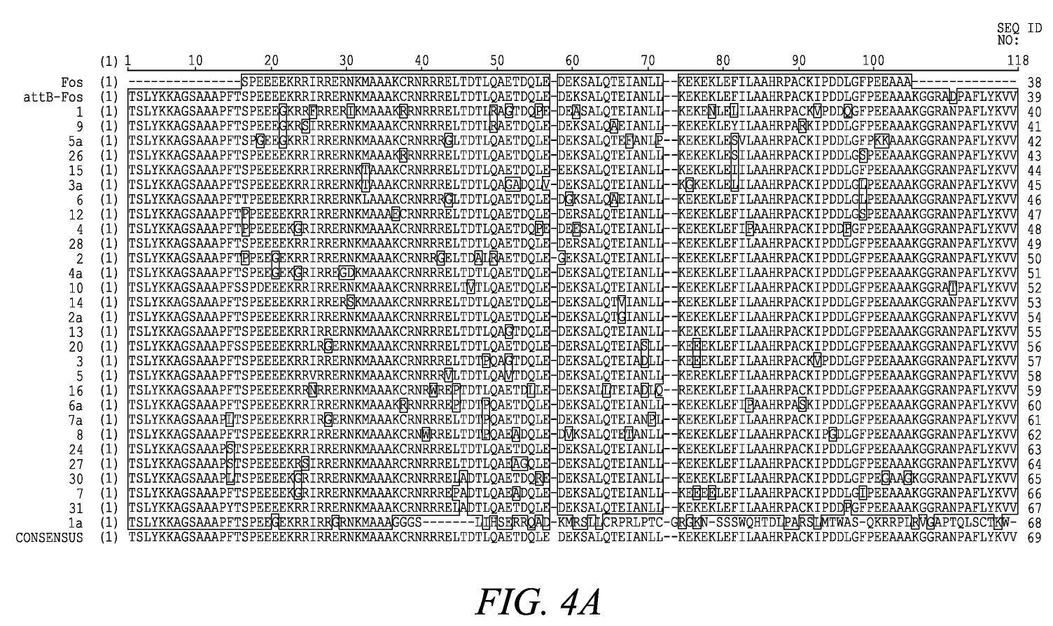

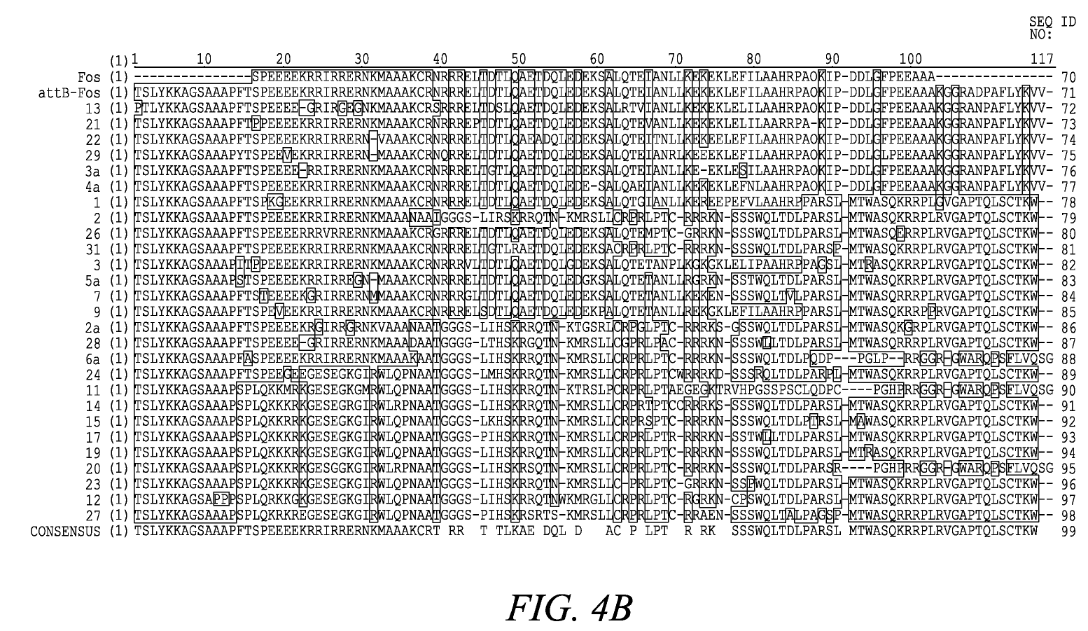

Initial studies using ORFs with and without stop codons in the pDONR-Express system suggested the presence of a stop codon would inhibit growth on media containing kanamycin. To verify the pDONR-Express system could discriminate between alleles containing stop codons and frameshift mutations from those with missense mutations, an allele library of the leucine zipper region of Fos was generated by mutagenic PCR, under conditions that generated one mutation per sixty base pairs. PCR products were BP crossed into pDONR-Express, transformed into E. coli and plated on LB/Spectinomycin media containing 1 mM IPTG. Several hundred colonies were patched onto LB/Kan+1 mM IPTG and plasmid DNA was isolated from clones displaying both Kan⁻ and Kan⁺ phenotypes. Phenotypes were confirmed by re-transforming the entry clones back into E. coli, followed by induced expression and kanamycin selection. Confirmed ORFs were LR crossed into pDEST22 for sequence analysis. Sequences were obtained for 27 clones displaying a Kan⁻ phenotype and 29 clones displaying a Kan⁺ phenotype. A multiple sequence alignment was generated with translated Fos alleles from Kan⁺ (FIG. 4A) and Kan⁻ clones (FIG. 4B). All Kan⁻ clones contain either a nonsense mutation, frameshift mutation or both. As a result, the attL2-neomycin phosphotransferase fusion would either not be expressed, or be out of frame.

By contrast, with the exception of one clone (clone 1a), sequence analysis of Fos alleles exhibiting Kan⁺ phenotypes show attb1-Fos-attB2 are in-frame, containing only missense mutations. The reading frame is maintained between Gateway™ reactions, so attL1, Fos and attL2-Kan^{R} are expected to be in-frame in pENTR-Express.

The exception, clone 1a, contains a thirteen base pair deletion localized near the 5′ end of the ORF. Sequence analysis of clones exhibiting Kan⁻ phenotypes show the Fos alleles containing either one or two deletions, nonsense mutations, or both, which would result in entry clones expressing either partial fusions or out-of-frame proteins that would not contain neomycin phosphotransferase. These results suggest pDONR-Express is capable of discrimination against truncated ORFs in the majority of cases. The 13 base pair deletion in clone 1a results in a frameshift mutation that generates two tandem GGA codons, followed by a GGG, AGC and TGA. GGA codons have been reported to be associated with non-programmed −1 frameshifting (for review see, Farabaugh, P. J. and Bjork, G. R. EMBO 18:1427-1434 (1999)). Thus, we believe the kanamycin resistant phenotype displayed by this clone is the result of a −1 frameshift, which restores the appropriate reading frame for neomycin phosphotransferase expression.

### Example 16

### Allele Library Generation and Reverse Two-hybrid Screen of the Id1-MyoD1 Interaction

MyoD1 belongs to the basic helix-loop-helix (bHLH) family of transcription factors and plays a role in muscle cell development (see, Davis, R. L., Weintraub, H. & Lasser, A. B. Cell 51:987-1000 (1987) and Weintraub, H. et al. Science 251:761-766 (1991)). MyoD1 activity is inhibited through interaction with the HLH protein Id1. This interaction is mediated by the HLH regions of both proteins (see, Benezra, R., Davis, R. L., Lockshon, D., Turner, D. L. & Weintraub, H. Cell 61:49-59 (1990) and Finkel, T., Duc, J., Fearon, E. R., Dang, C. V. & Tomaselli, G. F. J. Biol. Chem. 268:5-8 (1993)). An allele library of MyoD1 was generated with pDONR-Express. Based on the guidelines outlined in material and methods, we decided a minimum of 500,000 individual Kan⁺ clones was sufficient to provide good library representation for the 1081 bp ORF. This target number of colonies was exceeded with approximately 700,000 Kan⁺ colonies produced. The resulting pENTR library was isolated and LR crossed into pDEST22. The target number of colonies (Amp⁺) from the LR reaction was 500,000. Approximately 2,600,000 Amp+were produced and the resulting pEXP22-MyoD1 allele library was isolated.

The ProQuest™ (Invitrogen) yeast two hybrid system was used to analyze the Id1-MyoD1 interaction. The pEXP22-MyoD1 allele library was co-transformed with pEXP32-Id1 into MaV203, which contains the SPALIO::URA3 reporter gene. Activation of this reporter by a protein-protein interaction converts 5-FOA into the toxic product 5-fluorouracil, which inhibits yeast growth. Thus, interaction defective alleles may be selected out of libraries consisting largely of wild type alleles (see, Vidal, M., Brachmann, R. K., Fattaey, A., Harlow, E. & Boeke, J. D. Proc. Natl. Acad. Sci. 93, 10315-10320 (1996) and Vidal, M., Braun, P., Chen, E., A., Boeke, J. D. & Harlow, E. Proc. Natl. Acad. Sci. 93, 10321-10326 (1996)). Interaction defective alleles of MyoD1 were selected for on media containing 5-FOA at concentrations of 0.05%, 0.1% and 0.2%. Approximately 1% of 10,000 transformants displayed strong 5-FOA^{R} phenotypes, most of which were observed on media containing 0.1% and 0.2% 5-FOA. Eighty-seven 5-FOA^{R} clones, plus positive (Id1-MyoD1) and negative (Id1-Ra1GDS) controls, were tested for their ability to activate the HIS3 reporter in the presence of 3-aminotriazole (3-AT), an inhibitor of the His3p, at concentrations of 10mM, 25 mM, 50 mM and 100 mM. 5-FOA^{R} clones that behave identical to wild type under histidine/3-AT selection may contain a mutation in the URA3 reporter gene opposed to a mutant MyoD1 allele. Thus, this second step positive selection may serve to separate 5-FOA^{R} strains containing true mutants versus those harboring wild type.

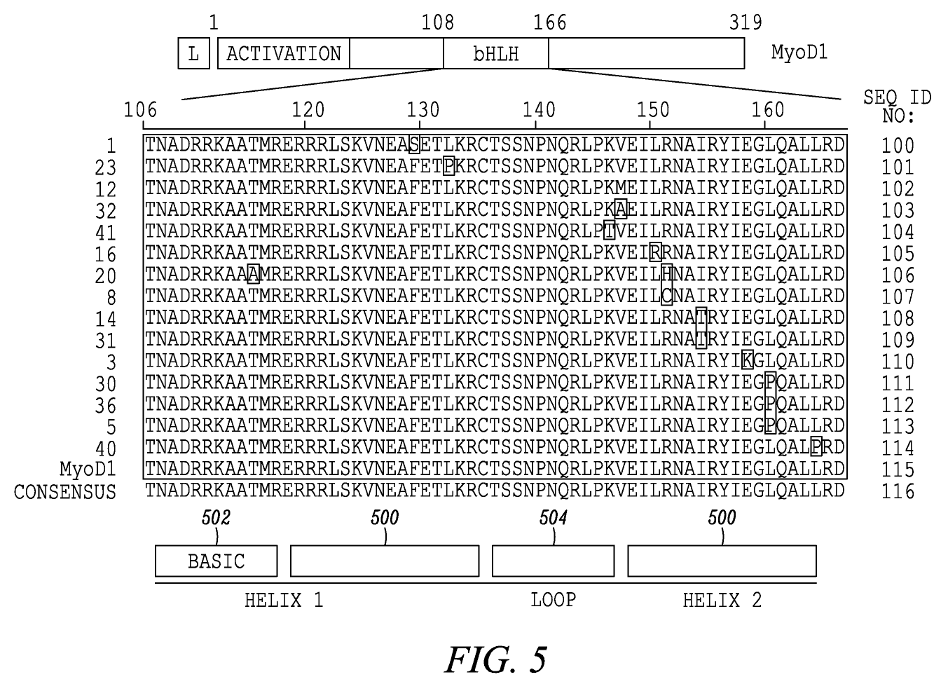

Sequence data was obtained from thirty-two MyoD1 alleles displaying the 5-FOA^{R} phenotype and suppressed growth on histidine deficient media supplemented with 3-AT. Of the 32 clones, 15 were wild type, 14 contained a single missense mutation, 1 contained three missense mutations, 1 contained a point mutation in the leader sequence and 1 contained a truncated ORF. Sequences of the 15 alleles containing missense mutations within the MyoD1 ORF were translated and aligned with a MyoD1 template sequence using ClustalW. FIG. 5 shows the bHLH region of the alignment. Sequences were analyzed with the Vector NTI 9.0 program, translated, and aligned with the MyoD1 reference sequence with ClustalW. Secondary structure elements are shown below the sequences (α-helix=400, basic region of helix1=402 and loop region=404) Note: Not shown are allele 6, A16V and allele 20, N226D. With the exception of clone 20, all alleles possess a single point mutation in either helix 1 or helix 2 within the bHLH domain (2/15 contain a single point mutation in helix 1 and 12/15 contain a single point mutation in helix 2). Clone 20 contains two point mutations within the bHLH region and a third outside the region (N204D).

To confirm the initial mutant phenotypes, plasmid DNA from 16 mutant alleles (the truncated mutant was not included) and 10 wild type clones was co-transformed into MaV203 with pEXP32-Id1. Transformants were tested for their ability to activate the URA3 reporter, as well as the HIS3 reporter in the presence of 10 mM, 25 mM, 50 mM or 100 mM 3-AT. The 3-AT titration provides information on a how a particular mutation effects the interaction. Mutations that completely disrupt the interaction are unable to grow in the presence of low concentrations of 3-AT (10 mM), whereas mutations that weaken the interaction can survive on higher levels (25-100 mM). Of the ten wild type clones, eight (4, 18, 24, 26, 33, 35, 44 and 48) produced strong URA⁺ and HIS3/100 mM 3-AT⁺ phenotypes, while two (19 and 22) displayed minimal growth under these conditions. The reason for this observation is unclear. These clones may contain mutations in their promoters, decreasing the expression of wild type MyoD1. All mutant alleles (1, 3, 5, 6, 8, 12, 14, 16, 20, 23, 30, 31, 32, 36, 40 and 41) were unable to activate the URA3 reporter, as indicated by the absence of growth on −LWU plates and displayed varying sensitivities to 3-AT. Table 2 lists a summary of the MyoD1 alleles and the maximum [3-AT] required to suppress growth. Clone 40 (L164P) was the only allele containing a mutation in the MyoD1 ORF displaying a strong growth phenotype in the presence of 100 mM 3-AT.

TABLE 2
Summary of MyoD1 Alleles Containing Point Mutations

| Mutation | Clone/Allele | 3-AT Phenotype | |
|---|---|---|---|
| A(L16)V | 6 | >100 | mM |
| T115A | 20 | 100 | mM |
| F129S | 1 | 10 | nM |
| L132P | 23 | 10 | nM |
| K146T | 41 | 25 | nM |
| V147M | 12 | 50 | nM |
| V147A | 32 | 50 | nM |
| L150R | 16 | 10 | nM |
| R151H | 20 | 100 | mM |
| R151C | 8 | 100 | mM |
| I154T | 14, 31 | 10 | nM |
| E158K | 3 | 10 | nM |
| L160P | 5, 30, 36 | 10 | nM |
| L164P | 40 | >100 | mM |

Table 2. Summary of MyoD1 mutant alleles containing point mutations and their phenotypes under histidine/3-AT selection. The table lists all amino acid changes from alleles containing point mutations. The [3-AT] listed is the concentration required to inhibit growth under histidine selection. For clone 6, L16 refers to position 16 of the 22 amino acid leader sequence.

To validate our results, we used the crystal structure of MyoD bHLH-DNA complex (1MYD) as a model (see, Ma, P. C. M., Rould, M. A., Weintraub, H. & Pabo, C. O. Cell 77.451-459 (1994)). In this structure, the bHLH domain of MyoD (containing a C135S mutation in the loop) is complexed with a synthetic strand of DNA as a homodimer. Most of the residues mutated in interaction defective alleles containing a single codon change are located at the interaction interface and code for either aliphatic or aromatic amino acids, which have been reported to be common at binding surfaces (See, Lo Conte, L., Chothia, C. & Janin, J. J. Mol. Biol. 285:2177-2198 (1999)) Moreover, these mutations are located outside the DNA binding domain of the bHLH.

Table 3 lists a summary of residues that appear to facilitate interaction between the two molecules based on analysis of the crystal structure. The molecules interact in such a way that residues in helix 1 of strand S (600) interact with residues in helix 2 of strand L (602). This is the case with all residues except L160, where both L160 residues are located in helix 2. Moreover, 4 out of 6 interactions can be found in both orientations. For example F129 of helix 1/stand A interacts with L150 of helix 2/strand B and vice versa (i.e. L150 of helix 2/strand A interacts with F129 of helix 1/strand B). This is the case for the F129-L150 and L132-1154 interactions (four total). The other interaction is V147-V125, where V147 of helix 2/strand A interacts with V125 of helix 1/strand B. We isolated alleles containing mutations in all seven of these positions (V125, F129, L132, V147, L150, I154 and L160) in the bHLH region except V125.

Table 3 also lists the corresponding residues found in Id1 for both strands A and B. All residues are identical between Id1 and MyoD1 except at positions 125 and 129. However, the class of amino acid at these positions is conserved. MyoD1 contains a phenylalanine at position 129, Id1, a tyrosine; both are aromatic. MyoD1 contains a valine at position 125, Id1, a methionine; both are aliphatic. The level of conservation at these residues suggests the Id1-MyoD1 complex should form a similar structure to the MyoD homodimer, so it is reasonable to model the interactions of the Id1-MyoD1 complex based on the 1MYO crystal structure.

TABLE 3
Summary of the putative hydrophobic interactions between residues
on MyoD1-S and MyoD1-L and corresponding residues on Id1.

| | | | |
|---|---|---|---|
| MyoD1 S | Id1 | MyoD1 L | Id1 |

| | | | | | |
|---|---|---|---|---|---|
| Helix 1 | F129 | F129 | Helix 2 | L150 | L150 |
| | L132 | L132 | | I154 | I154 |
| Helix 2 | V147 | V147 | Helix 1 | V125 | M125* |
| | L150 | L150 | | F129 | Y129* |
| | I154 | I154 | | L132 | L132 |
| Helix 2 | L160 | L160 | Helix 2 | L160 | L160 |

Table 3. Summary of the putative interactions between residues on each bHLH molecule (S and L) of MyoD and corresponding residues on Id1.

We compared the phenotypes observed under histidine/3-AT selection to the location of the point mutation in the crystal structure of each allele and found a good correlation for alleles containing mutations at the interaction interface. Five of the seven alleles that contain mutations at the interaction interface (i.e. F129S, L132P, L150R, I154T and L160P) failed to grow under histidine selection in the presence of 10 mM 3-AT (Table 2). These results suggest the interaction between Id1 and these alleles is severely, or completely, disabled. The F129s and 1154T mutations transition from aromatic and aliphatic to nucleophilic amino acids, which are not expected to interact with leucine. Likewise, the L150R mutation transitions from a aliphatic to a basic residue and is not expected to interact with tyrosine (see Table 3). The L132P mutation most likely disrupts helix 1 and the L160P mutation disrupts helix 2. In contrast, alleles containing the V147M or V147A mutations required 50 mM 3-AT to suppress growth, suggesting these alleles still interact with Id1, but with reduce affinity. This is not surprising since the class of amino acid is conserved in the V147M mutation, both are aliphatic, and a transition from valine to alanine in the V147A mutation substitutes aliphatic for small.

Alleles containing mutations outside the interaction interface include K146T, R151c, E158K and L164P. Ma et al. report a hydrogen bond between N126 of helix 1 and K146 of helix 2, which is thought to stabilize the molecule (Ma, P. C. M., Rould, M. A., Weintraub, H. & Pabo, C. O. Crystal. Cell 77:451-459 (1994)). The K146T mutation changes the residue from basic to nucleophilic, which would destroy the hydrogen bond with N126 and destabilize the molecule. The allele containing this mutation required 25 mM 3-AT to suppress growth, suggesting a weakened interaction with Id1. The R151 and E158 residues are located in the bHLH region one position away from the interaction interface. The allele containing the R151C mutation required 50 mM 3-AT to suppress growth, suggesting this allele still interacts with Id1, but with reduce affinity. The allele containing the E158K mutation failed to grow under histidine selection in the presence of 10mM 3-AT, suggesting a disrupted interaction with Id1. These two residues are not conserved between Id1 and MyoD1, therefore the 1MYO crystal structure cannot be used as a model to determine the role these residues play in the interaction with Id1. These residues could stabilize the bHLH through intramolecular interactions with regions not included in the crystal structure. Allele 20 contains three point mutations (T115A, R151H and N204D), with one located within helix 2 of the bHLH region (R151H) and displays a similar phenotype to allele 8, which contains a similar mutation (R151C). The L164 residue is within helix 2, facing away from the interaction interface and alleles containing L164P behave similar to wild type under histidine/3-AT selection. However, this mutation probably distorts helix 2, weakening interaction with Id1 because this allele is unable to activate the URA3 reporter. Clone 6 was the only allele isolated with a mutation outside the MyoD1 ORF. This allele is unable to activate the URA3 reporter and failed to grow under histidine selection in the presence of 100 mM 3-AT.

### Example 17

### Allele Library Generation and Reverse Two-hybrid Screen of the Krev1-Ra1GDS Interaction

Krev1 (a.k.a. Rap1A) is a member of the Ras family of GTP binding proteins and has been shown to interact with the RA domain of the Ral guanine nucleotide dissociator stimulator protein Ra1GDS (See Herrmann, C., Horn, G., Spaargaren, M. and Wittinghofer, A. J. Biol. Chem. 271:6794-6800 (1996) and Serebriiskii, I., Khazak, V. and Golemis, E. A. J. Biol. Chem. 274:17080-17087 (1999). The full-length Krev1 ORF (fused to cI DNA binding protein) and the RA domain of Ra1GDS (fused to B42 activator domain) serve as controls in the Dual Bait Hybrid Hunter Yeast Two-Hybrid System. When analyzed in the ProQuest Yeast Two-Hybrid system, the Krev1-Ra1GDS interacting pair is capable of activating all reporter genes (HIS3, URA3 and LacZ), producing strong phenotypes. Thus, the Krev1/Ra1GDS interaction was selected for analysis in the reverse two-hybrid system.

In creating the allele library for Ra1GDS, it was calculated using the guidelines in Materials and Methods that 200,000 individual Kan⁺ clones was sufficient to provide good library representation for the 296 bp ORF. This target number of colonies was exceeded with approximately 1,200,000 Kan⁺ colonies produced. The resulting pENTR library was isolated and LR crossed into pDEST22. The target number of colonies (Amp⁺) from the LR reaction was 200,000. Approximately 700,000 Amp+were produced and the resulting pEXP22-Ra1GDS allele library was isolated and co-transformed with pEXP32-Krev1 into MaV203. Non-interacting alleles of Ra1GDS were selected for on media containing 5-FOA (0.05% and 0.1%). Approximately 1% of 10,000 transformants grew on 5-FOA. Sixty-two clones displaying a 5-FOA^{R} phenotype plus positive (Krev1-Ra1GDS positive interaction) and negative (Krev1-Fos negative interaction) controls were tested for their ability to activate the HIS3 reporter in the presence of 3-AT (10 mM, 25 mM, 50mM and 100 mM).

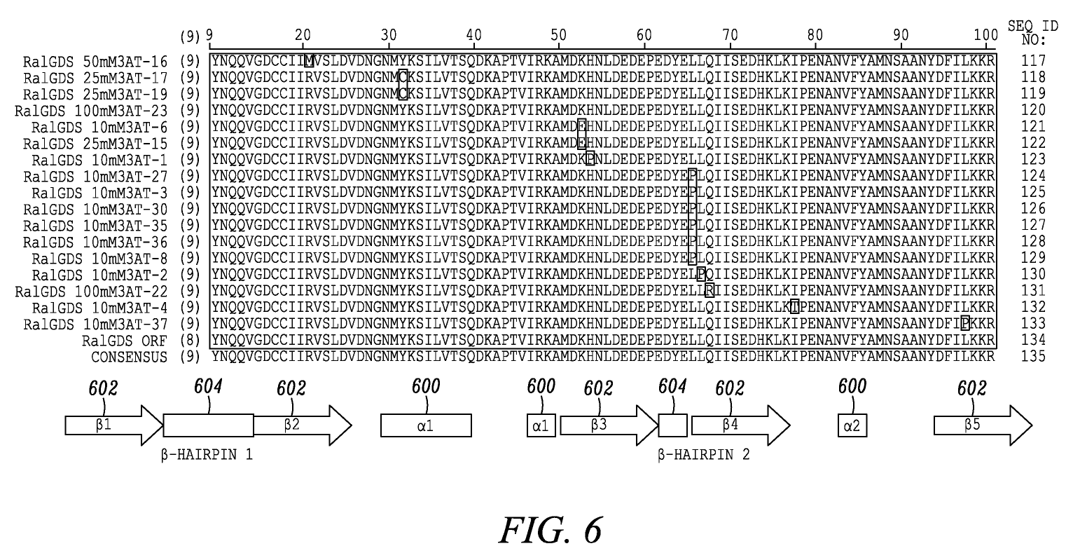

Sequence data was obtained from twenty-eight RalGDS alleles displaying the 5-FOA^{R} phenotype and suppressed growth on histidine deficient media supplemented with 3-AT. Of the 28 clones, 8 were wild type, 17 contained a single missense mutation and 3 possess frameshift mutations in the attb1 site. Sequences of the 17 alleles containing a single missense mutations were translated and aligned with the Ra1GDS template sequence using ClustalW (FIG. 6). Sequences were analyzed with the Vector NTI 9.0 program, and translated and aligned with the Ra1GDS RA reference sequence with ClustalW. Secondary structure elements are shown below the sequences (α-helix=600, β-sheet=602 and β-hairpin=604). Plasmid DNA from the 17 mutant alleles and 6 wild type clones was transformed into MaV203 with pEXP32/Krev1.

This alignment reveals that all interaction defective alleles contain point mutations in secondary structure elements. To confirm the initial mutant phenotypes, plasmid DNA from the 17 mutant alleles and 6 wild type clones was co-transformed into MaV203 with pEXP32-Krev1. Transformants were tested for their ability to activate the URA3 reporter, as well as the HIS3 reporter in the presence of 10 mM, 25 mM, 50 mM or 100 mM 3-AT. All six wild type clones (7, 9, 11, 12, 20 and 21) produced strong URA⁺ and HIS3/100 mM 3-AT⁺ phenotypes, except clone 20. All mutant alleles (1, 2, 3, 4, 6, 8, 14, 15, 16, 17, 19, 22, 23, 27, 28, 29, 30, 35, 36 and 37) except clone 23 were unable to activate the URA3 reporter, as indicated by the absence of growth on −LWU plates and displayed varying sensitivities to 3-AT. Table 3a lists a summary of the Ra1GDS alleles and the maximum [3-AT] required to suppress growth. Clone 4 (177T) and 23 (M50V) were the only mutants displaying a strong growth phenotype in the presence of 100 mM 3-AT.

TABLE 3a
Summary of RalGDS Alleles Containing Point Mutations

| Mutation | Clone/Allele | 3-AT Phenotype | |
|---|---|---|---|
| R20M | 16 | 50 | mM |
| Y31C | 17, 19 | 10 | mM |
| M50V | 23 | >100 | mM |
| K52E | 6, 15 | 10 | mM |
| H53P | 1 | 10 | mM |
| L65P | 3, 8, 27, 30, 35, 36 | 10 | mM |
| L66P | 2 | 10 | mM |
| Q67R | 22 | 100 | mM |
| I77T | 4 | >100 | mM |
| L97P | 37 | 10 | mM |

Table 3a. Summary of Ra1GDS mutant alleles containing point mutations and their phenotypes under histidine/3-AT selection. The table lists all amino acid changes from alleles containing point mutations. The 3-AT phenotype is the concentration of 3-AT required to inhibit growth under histidine selection.

Krev is a homologue of Ras; both proteins belong to the Ras family of GTP binding proteins and possess similar structures (Huang, L., Hofer, F., Martin, G. S, and Kim, S. H. Nat. Struct. Biol. 5:422-426). To gain some insight into how the mutations in the RA domain of Ra1GDS recovered from the screen effect its ability to interact with Krev1, we used the crystal structure of the active Ras protein complexed with the RA domain of Ra1GDS (1LFD) as a model (Huang, L., Hofer, F., Martin, G. S, and Kim, S. H. Nat. Struct. Biol. 5:422-426). In this structure, two molecules of a mutant form of the human Ras (E31K) are complexed to two molecules of rat Ra1GDS-RA, forming a heterotetramer. It is unclear whether this structure represents the complex in vivo, therefore only one Ra1GDS RA molecule was analyzed. Huang et al. describe residues that mediate the protein-protein interaction between Ras and the Ra1GDS RA domain. All of these residues are located within either β-sheet or α-helical structures. We only recovered three alleles containing mutations at the reported contact points with Ras (R20M, Y31C and K52E). However, these represent approximately one-third of all alleles isolated (5/17).

Further analysis of the crystal structure reveals some residues identified as mutants in interaction defective alleles may be involved in intramolecular interactions, which may be important for the overall structure of the protein. The protein consists of a hydrophobic core, with interactions between α-helix 1 and β-sheet 3 (L65-146), α-helix 1 and β-sheet 5 (M50-L97), and β-sheet 4 and α-helix 2 (177-V83). In addition, an ionic interaction appears to occur between the carbonyl group of Q67 in β-sheet 3 and amide group (H⁺) of N88 (located in a γ-turn between α-helix 2 and β-sheet 5). Also, it appears R20 and Y31, while contacting Ras, may also undergo base stacking. Of these 10 residues (5 putative interacting pairs), all were recovered as mutants except 146, V83 and N88.

We compared the phenotypes observed under histidine/3-AT selection to the location of the point mutation in the crystal structure of each allele. Two out of three alleles that contained mutations at residues reported to contact Ras (R20, Y31 and K52) failed to grow under histidine selection in the presence of 10 mM 3-AT. These results suggest the Y31C and K52E mutations severely, or completely, disable interaction with Krev1. Likewise, the allele containing the H53P mutation displays the same phenotype. While H53 was not reported to contact Ras, the H53P mutation would be expected to disrupt the local structure α-helix), which includes K52, and, as a result, disrupt interaction with Krev1. The allele containing the R20M mutation required 50 mM 3-AT to suppress growth. Thus, it appears this mutation only weakens the interaction with Krev1.

Alleles containing point mutations at residues involved in maintaining the hydrophobic core include M50V, L65P, L66P, Q67R, I77T and L97P. Alleles containing leucine to proline mutations failed to grow under histidine selection in the presence of 10 mM 3-AT, suggesting a disabled interaction with Krev1. Changing the residues L65, L66 and L97, which are located in β-sheets that make up the hydrophobic core of the protein, to prolines is likely to disrupt the β-sheet structure and modify the overall structure of the molecule, altering its affinity for Krev1. The Q67 codon is located in the same β-sheet as L65 and L66 and appears to stabilize the structure through an ionic interaction with N88. Alleles containing the Q67R mutation survive histidine selection in the presence of 100 mM 3-AT, suggesting this mutation only weakens the interaction. This mutation transitions a small amide group (Q) for a large basic group (R). It is possible that the charged hydrogens of arginine would still be capable of interacting with N88, but the increased size of the residue at this location may distort this interaction, slightly weakening the interaction. Alleles containing the M50V and 177T mutations survive histidine selection in the presence of 10mM 3-AT, suggesting these mutations only weaken the interaction. Moreover, the allele containing the M50V mutation is still capable of growth under uracil selection. This is not surprising since the M50V mutation retains a hydrophobic residue at position 50. However, activation of the URA3 reporter does appear to be weakened. The 177T mutation transitions from a hydrophobic to a nucleophilic residue, but threonine does have a methyl group available for interaction with V83.

### CONCLUSIONS

We have demonstrated the ability of our mutant allele cloning and isolation system using the pDONR-Express vector to select against truncated proteins from a library of Fos mutants generated through mutagenic PCR. Our results suggest that greater than 95% of alleles generated using this system should code for full-length (non-truncated) proteins. We used the pDONR-Express vector to generate a full-length enriched MyoD1 allele library and selected for interaction defective alleles. Fifteen out of eighteen interaction defective alleles contained a single point mutation in the known interaction domain. Thus, this system is capable of identifying interaction domains within an ORF, which is significant when no structure data is available. Because the three-dimensional structure of the bHLH of MyoD had been solved, we were able to visualize the positions of the point mutations from the interaction defective alleles. Of the ten point mutations within the bHLH region six were located at the interaction interface, at residues that appear to facilitate protein binding. In fact, a total of seven residues appear to mediate protein binding between the two molecules and we isolated interaction defective alleles containing mutations at six of these seven positions. Moreover, a second screen performed to investigate the interaction between Krev1 and the RA domain of Ra1GDS identified residues in RalGDS that mediate both inter- and intra-molecular interactions.

The data obtained from the reverse two hybrid analysis of Id1-MyoD1 and Krev1-Ra1GDS demonstrates the potential of this strategy for generating allele libraries for reverse two hybrid analysis of protein interactions. This strategy has several advantages over existing methods. First, generating allele libraries in vitro with Gateway™ cloning technology is more efficient than gap repair, which may result in 9% of plasmids without insert (Endoh, H., Walhout, A. J. M. & Vidal, M. A. Methods Enzymol. 328:74-88 (2000)). pDONR-Express molecules that fail to recombine contain the ccdB gene, which is toxic to E. coli (Bernard, P. & Couturier, M. J. Mol. Biol. 226:735-745 (1992)), and thus will be eliminated from the library. Second, the high transformation efficiencies of E. coli allow for larger, more complex allele libraries to be generated. Third, selecting for full-length proteins in E. coli prior to yeast transformation removes a significant source of background. This is a key advantage of using pDONR-Express because the vast majority (>97%) of 5-FOA^{R} colonies either do not contain inserts or code for truncated proteins when using gap repair. By selecting for full-length proteins prior to yeast transformation, this background is virtually eliminated and a second step selection in yeast to identify full-length proteins is negated. Data from analyzing two separate protein-protein interactions, showed only 1% of transformants exhibited strong FOA^{R} phenotypes, opposed to an average of 32% when using gap repair, and we only isolated four truncated alleles from a total of 59 isolated. Moreover, the data from the mutant Fos library suggests >95% of clones exhibiting a Kan⁺ phenotype code for full-length ORFs. Finally, Gateway™ technology allows library transfer from the entry vector to the yeast two-hybrid expression vector. Thus, by separating full-length selection from reverse two-hybrid analysis, protein-protein interactions may be studied in the original two-hybrid context.

This new method also expedites and simplifies the process of conducing a reverse two-hybrid screen. Since full-length selection occurs in E. coli, yeast are co-transformed with the bait plasmid and intact library plasmids that are enriched for full-length ORFs, which is a significant advantage over existing techniques because (i) the need to generate a competent bait strain is negated, (ii) higher transformation efficiencies are achieved in yeast and (iii) yeast are plated directly onto media containing 5-FOA, which eliminates the need to replicate plate thousands of colonies from media used for plasmid selection to media containing 5-FOA. Thus, pDONR-Express should facilitate the high-throughput analysis of protein-protein interactions and the isolation of interaction defective alleles, which may be used to dissect biological processes in vivo. In addition, pDONR-Express may be used to generate allele libraries for the analysis of protein-DNA and protein-RNA interactions, or in any system where a mutant library of a gene is desired.

In summary, a new method for allele library generation for reverse two-hybrid analysis of protein interactions has been developed. This method significantly reduces background and expedites the isolation of interaction defective alleles, which allow the identification of single residues and regions of a protein that mediate protein interactions.

Having now fully described the present invention in some detail by way of illustration and example for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

1. A method for generating an allele library, comprising:
(a) providing a first vector comprising a first recombination site, a second recombination site and a selectable marker gene;
(b) mixing at least one isolated nucleic acid molecule comprising a third recombination site, a target sequence, and a fourth recombination site with the first vector to generate a mixture;
(c) incubating the mixture in the presence of at least one recombination protein under conditions sufficient to cause recombination between the first and third recombination sites and the second and fourth recombination sites, thereby generating target sequence selection construct comprising a fifth recombination site, a target sequence, a sixth recombination site, and a selectable marker gene;
(d) introducing the second vector into a host cell;
(e) incubating the host cell under conditions sufficient to express the selectable marker; and
(f) selecting for host cells comprising the selectable marker to obtain a library of full-length target sequences.

2. The method of claim 1, wherein said mixing in (b) and said incubating in (c) are performed in vitro.

3. The method of claim 1, wherein the first, second, third, fourth, fifth and sixth recombination sites are selected from the group consisting of: att sites, lox sites, frt sites, psi sites, dif sites and cer sites.

4. The method of claim 3, wherein the first, second, third, fourth, fifth and sixth recombination sites are att sites.

5. The method of claim 4, wherein the att sites are mutated att sites.

6. The method of claim 4, wherein the att sites are selected from the group consisting of attB, attP, attL and attR sites.

7. The method of claim 1, wherein the first and second recombination sites are attP sites.

8. The method of claim 1, wherein the third and fourth recombination sites are attB sites.

9. The method of claim 1, wherein the fifth or sixth recombination sites are attL sites.

10. The method of claim 1, wherein the third and fourth recombination sites flank the full length target sequence.

11. The method of claim 1, wherein the selectable marker is selected from the group consisting of an antibiotic resistance gene, a toxic gene and a reporter gene.

12. The method of claim 11, wherein the selectable marker is an antibiotic resistance gene.

13. The method of claim 12, wherein the antibiotic resistance gene confers resistance to ampicillin, tetracycline, spectinomycin, kanamycin or chloramphenicol.

14. The method of claim 1, wherein the first vector further comprises at least one promoter.

15. The method of claim 14, wherein the promoter further comprises an operator.

16. The method of claim 15, wherein the operator is a lac operator.

17. The method of claim 14, wherein the promoter is an EML promoter.

18. The method of claim 16 or claim 17, wherein the first vector further comprises a lad gene.

19. The method of claim 1, wherein the full length target sequence comprises one or more mutations relative to the wild type of the full length target sequence.

20-55. (canceled)


SEQUENCE LISTING (135 sequences)

SEQ ID NO: 1 - DNA, 25 bp, Artificial Sequence
  Chemically synthesized - Possible recombination site, m-att
rkycwgctttyktrtacnaastsgb

SEQ ID NO: 2 - DNA, 25 bp, Artificial Sequence
  Chemically synthesized - Possible recombination site, m-attB
agccwgctttyktrtacnaactsgb

SEQ ID NO: 3 - DNA, 25 bp, Artificial Sequence
  Chemically synthesized - Possible recombination site, m-attR
gttcagctttcktrtacnaactsgb

SEQ ID NO: 4 - DNA, 25 bp, Artificial Sequence
  Chemically synthesized - Possible recombination site, m-attL
agccwgctttcktrtacnaagtsgb

SEQ ID NO: 5 - DNA, 25 bp, Artificial Sequence
  Chemically synthesized - Possible recombination site, m-attP1
gttcagctttyktrtacnaagtsgb

SEQ ID NO: 6 - DNA, 25 bp, Artificial Sequence
  Chemically synthesized - Possible recombination site, n-att
rbycwgctttyttrtacwaastkgd

SEQ ID NO: 7 - DNA, 25 bp, Artificial Sequence
  Chemically synthesized - Possible recombination site, n-attB
asccwgctttyttrtacwaastkgw

SEQ ID NO: 8 - DNA, 25 bp, Artificial Sequence
  Chemically synthesized - Possible recombination site, n-attL
asccwgctttyttrtacwaagttgg

SEQ ID NO: 9 - DNA, 25 bp, Artificial Sequence
  Chemically synthesized - Possible recombination site, n-attR
gttcagctttyttrtacwaastkgw

SEQ ID NO: 10 - DNA, 25 bp, Artificial Sequence
  Chemically synthesized - Possible recombination site, n-attP
gttcagctttyttrtacwaagttgg

SEQ ID NO: 11 - DNA, 25 bp, Artificial Sequence
  Chemically synthesized - Possible recombination site, attB1
agcctgcttttttgtacaaacttgt

SEQ ID NO: 12 - DNA, 25 bp, Artificial Sequence
  Chemically synthesized - Possible recombination site, attB2
agcctgctttcttgtacaaacttgt

SEQ ID NO: 13 - DNA, 25 bp, Artificial Sequence
  Chemically synthesized - Possible recombination site, attB3
acccagctttcttgtacaaagtggt

SEQ ID NO: 14 - DNA, 25 bp, Artificial Sequence
  Chemically synthesized - Possible recombination site, attR1
gttcagcttttttgtacaaacttgt

SEQ ID NO: 15 - DNA, 25 bp, Artificial Sequence
  Chemically synthesized - Possible recombination site, attR2
gttcagctttcttgtacaaacttgt

SEQ ID NO: 16 - DNA, 25 bp, Artificial Sequence
  Chemically synthesized - Possible recombination site, attR3
gttcagctttcttgtacaaagtggt

SEQ ID NO: 17 - DNA, 25 bp, Artificial Sequence
  Chemically synthesized - Possible recombination site, attL1
agcctgcttttttgtacaaagttgg

SEQ ID NO: 18 - DNA, 25 bp, Artificial Sequence
  Chemically synthesized - Possible recombination site, attL2
agcctgctttcttgtacaaagttgg

SEQ ID NO: 19 - DNA, 25 bp, Artificial Sequence
  Chemically synthesized - Possible recombination site, attL3
acccagctttcttgtacaaagttgg

SEQ ID NO: 20 - DNA, 25 bp, Artificial Sequence
  Chemically synthesized - Possible recombination site, attP1
gttcagcttttttgtacaaagttgg

SEQ ID NO: 21 - DNA, 25 bp, Artificial Sequence
  Chemically synthesized - Possible recombination site, attP2,P3
gttcagctttcttgtacaaagttgg

SEQ ID NO: 22 - DNA, 51 bp, Artificial Sequence
  Chemically synthesized - Primer used to amplify mouse MyoD1 ORF
ggggacaagtttgtacaaaaaagcaggctctccggagtggcagaaagttaa

SEQ ID NO: 23 - DNA, 50 bp, Artificial Sequence
  Chemically synthesized - Primer used to amplify mouse MyoD1 ORF
ggggaccactttgtacaagaaagctgggttaagcacctgataaatcgcat

SEQ ID NO: 24 - DNA, 51 bp, Artificial Sequence
  Chemically synthesized - Primer used to amplify mouse Id1 ORF
ggggacaagtttgtacaaaaaagcaggctctgaattcccggggatccgtcg

SEQ ID NO: 25 - DNA, 50 bp, Artificial Sequence
  Chemically synthesized - Primer used to amplify mouse Id1 ORF
ggggaccactttgtacaagaaagctgggtttcagcgacacaagatgcgat

SEQ ID NO: 26 - protein, 11 aa, Artificial Sequence
  Chemically synthesized - Synthetic leader sequence used to amplify attB1 and attB2 with mouse Id1
EFPGIRRHKFP

SEQ ID NO: 27 - DNA, 25 bp, Artificial Sequence
  Chemically synthesized - Primer used to amplify  rat Krev1
cacccgtgagtacaagctagtggtc

SEQ ID NO: 28 - DNA, 24 bp, Artificial Sequence
  Chemically synthesized - Primer used to amplify rat Krev1
tctctagagcagcagacatgattt

SEQ ID NO: 29 - DNA, 21 bp, Artificial Sequence
  Chemically synthesized - Primer used to amplify the ras association domain of RalGDS
cacctccagctcctcactgcc

SEQ ID NO: 30 - DNA, 23 bp, Artificial Sequence
  Chemically synthesized - Primer used to amplify the ras association domain of RalGDS
ccgcttcttttaggatgaagtca

SEQ ID NO: 31 - DNA, 22 bp, Artificial Sequence
  Chemically synthesized - Primer used to generate the MyoD1 allele library
acaagtttgtacaaaaaagcag

SEQ ID NO: 32 - DNA, 21 bp, Artificial Sequence
  Chemically synthesized - Primer used to generate the MyoD1 allele library
accactttgtacaagaaagct

SEQ ID NO: 33 - DNA, 21 bp, Artificial Sequence
  Chemically synthesized - Primer used in sequencing reactions with MyoD1 and RalGDS
tataccgcgtttggaatcact

SEQ ID NO: 34 - DNA, 23 bp, Artificial Sequence
  Chemically synthesized - Primer used in sequencing reactions with MyoD1 and RalGDS
agccgacaaccttgattggagac

SEQ ID NO: 35 - DNA, 20 bp, Artificial Sequence
  Chemically synthesized - Internal primer for MyoD1
gagcatgtgcgcgcgcccag

SEQ ID NO: 36 - DNA, 7385 bp, Artificial Sequence
  Chemically synthesized - pDONR-Express
tgagtgagctgataccgctcgccgcagccgaacgaccgagcgcagcgagtcagtgagcgaggaagcggaagagcgtgttgacaattaatcatcggcatagtatatcggcatagtataatacgaggaattgtgagcggataacaattcccaaggtgaggaactaaataatgattttattttgcctgatagtgacctgttcgttgcaacaaattgatgagcaatgcttttttataatgccaactttgtacaaaaaagctgaacgagaaacgtaaaatgatataaatatcaatatattaaattagattttgcataaaaaacagactacataatactgtaaaacacaacatatccagtcactatgaatcaactacttagatggtattagtgacctgtagtcgaccgacagccttccaaatgttcttcgggtgatgctgccaacttagtcgaccgacagccttccaaatgttcttctcaaacggaatcgtcgtatccagcctactcgctattgtcctcaatgccgtattaaatcataaaaagaaataagaaaaagaggtgcgagcctcttttttgtgtgacaaaataaaaacatctacctattcatatacgctagtgtcatagtcctgaaaatcatctgcatcaagaacaatttcacaactcttatacttttctcttacaagtcgttcggcttcatctggattttcagcctctatacttactaaacgtgataaagtttctgtaatttctactgtatcgacctgcagactggctgtgtataagggagcctgacatttatattccccagaacatcaggttaatggcgtttttgatgtcattttcgcggtggctgagatcagccacttcttccccgataacggagaccggcacactggccatatcggtggtcatcatgcgccagctttcatccccgatatgcaccaccgggtaaagttcacgggagactttatctgacagcagacgtgcactggccagggggatcaccatccgtcgcccgggcgtgtcaataatatcactctgtacatccacaaacagacgataacggctctctcttttataggtgtaaaccttaaactgcatttcaccagcccctgttctcgtcagcaaaagagccgttcatttcaataaaccgggcgacctcagccatcccttcctgattttccgctttccagcgttcggcacgcagacgacgggcttcattctgcatggttgtgcttaccagaccggagatattgacatcatatatgccttgagcaactgatagctgtcgctgtcaactgtcactgtaatacgctgcttcatagcatacctctttttgacatacttcgggtatacatatcagtatatattcttataccgcaaaaatcagcgcgcaaatacgcatactgttatctggcttttagtaagccggatccacgcggcgtttacgccccccctgccactcatcgcagtactgttgtaattcattaagcattctgccgacatggaagccatcacaaacggcatgatgaacctgaatcgccagcggcatcagcaccttgtcgccttgcgtataatatttgcccatggtgaaaacgggggcgaagaagttgtccatattggccacgtttaaatcaaaactggtgaaactcacccagggattggctgagacgaaaaacatattctcaataaaccctttagggaaataggccaggttttcaccgtaacacgccacatcttgcgaatatatgtgtagaaactgccggaaatcgtcgtggtattcactccagagcgatgaaaacgtttcagtttgctcatggaaaacggtgtaacaagggtgaacactatcccatatcaccagctcaccgtctttcattgccatacggaattccggatgagcattcatcaggcgggcaagaatgtgaataaaggccggataaaacttgtgcttatttttctttacggtctttaaaaaggccgtaatatccagctgaacggtctggttataggtacattgagcaactgactgaaatgcctcaaaatgttctttacgatgccattgggatatatcaacggtggtatatccagtgatttttttctccattttagcttccttagctcctgaaaatctcgataactcaaaaaatacgcccggtagtgatcttatttcattatggtgaaagttggaacctcttacgtgccgatcaacgtctcattttcgccaaaagttggcccagggcttcccggtatcaacagggacaccaggatttatttattctgcgaagtgatcttccgtcacaggtatttattcggcgcaaagtgcgtcgggtgatgctgccaacttagtcgactacaggtcactaataccatctaagtagttgattcatagtgactggatatgttgtgttttacagtattatgtagtctgttttttatgcaaaatctaatttaatatattgatatttatatcattttacgtttctcgttcagctttcttgtacaaagttggcattataagaaagcattgcttatcaatttgttgcaacgaacaggtcactatcagtcaaaataaaatcattatttgccatccagctgatatcgcctcaattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaggacgaggcagcgcggctatcgtggctggccacgacgggcgttccttgcgcagctgtgctcgacgttgtcactgaagcgggaagggactggctgctattgggtgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagagcatcaggggctcgcgccagccgaactgttcgccaggctcaaggcgcgcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagagcttggcggcgaatgggctgaccgcttcctcgtgctttacggtatcgccgctcccgattcgcagcgcatcgccttctatcgccttcttgacgagttcttctgagctctagaccagccaggacagaaatgcctcgacttcgctgctacccaaggttgccgggtgacgcacaccgtggaaacggatgaaggcacgaacccagtggacataagcctgttcggttcgtaagctgtaatgcaagtagcgtatgcgctcacgcaactggtccagaaccttgaccgaacgcagcggtggtaacggcgcagtggcggttttcatggcttgttatgactgtttttttggggtacagtctatgcctcgggcatccaagcagcaagcgcgttacgccgtgggtcgatgtttgatgttatggagcagcaacgatgttacgcagcagggcagtcgccctaaaacaaagttaaacattatgagggaagcggtgatcgccgaagtatcgactcaactatcagaggtagttggcgtcatcgagcgccatctcgaaccgacgttgctggccgtacatttgtacggctccgcagtggatggcggcctgaagccacacagtgatattgatttgctggttacggtgaccgtaaggcttgatgaaacaacgcggcgagctttgatcaacgaccttttggaaacttcggcttcccctggagagagcgagattctccgcgctgtagaagtcaccattgttgtgcacgacgacatcattccgtggcgttatccagctaagcgcgaactgcaatttggagaatggcagcgcaatgacattcttgcaggtatcttcgagccagccacgatcgacattgatctggctatcttgctgacaaaagcaagagaacatagcgttgccttggtaggtccagcggcggaggaactctttgatccggttcctgaacaggatctatttgaggcgctaaatgaaaccttaacgctatggaactcgccgcccgactgggctggcgatgagcgaaatgtagtgcttacgttgtcccgcatttggtacagcgcagtaaccggcaaaatcgcgccgaaggatgtcgctgccgactgggcaatggagcgcctgccggcccagtatcagcccgtcatacttgaagctagacaggcttatcttggacaagaagaagatcgcttggcctcgcgcgcagatcagttggaagaatttgtccactacgtgaaaggcgagatcaccaaggtagtcggcaaataaccctcgaccgagatgcgccgcgtgcggctgctggagatggcggacgcgatggatatgttctgccaagggttggtttgcgcattcacagttctccgcaagaattgattggctccaattcttggagtggtgaatccgttagcgaggtgccgccggcttccattcaggtcgaggtggcccggctccatgcaccgcgacgcaacgcggggaggcagacaaggtatagggcggcgcctacaatccatgccaacccgttccatgtgctcgccgaggcggcataaatcgccgtgacgatcagcggtccaatgatcgaagttaggctggtaagagccgcgagcgatccttgaagctgtccctgatggtcgtcatctacctgcctggacagcatggcctgcaacgcgggcatcccgatgccgccggaagcgagaagaatcataatggggaaggccatccagcctcgcgtcgcgaacgccagcaagacgtagcccagcgcgtcggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcgcgtcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctt

SEQ ID NO: 37 - DNA, 240 bp, Artificial Sequence
  Chemically Synthesized - Sequence of attL1-ORF-attL2-Kanamycin fusion in resulting pENTR clone
tgagtgagctgataccgctcgccgcagccgaacgaccgagcgcagcgagtcagtgagcgaggaagcggaagagcgtgttgacaattaatcatcggcatagtatatcggcatagtataatacgaggaattgtgagcggataacaattcccaaggtgaggaactaaataatgattttattttgcctgatagtgacctgttcgttgcaacaaattgatgagcaatgcttttttataatgccaa

SEQ ID NO: 38 - protein, 86 aa, Artificial Sequence
  Chemically synthesized - Fos Kan(+)
SPEEEEKRRIRRERNKMAAAKCRNRRRELTDTLQAETDQLEDEKSALQTEIANLLKEKEKLEFILAAHRPACKIPDDLGFPEEAAA

SEQ ID NO: 39 - protein, 115 aa, Artificial Sequence
  Chemically synthesized - attB-Fos Kan(+)
TSLYKKAGSAAAPFTSPEEEEKRRIRRERNKMAAAKCRNRRRELTDTLQAETDQLEDEKSALQTEIANLLKEKEKLEFILAAHRPACKIPDDLGFPEEAAAKGGRADPAFLYKVV

SEQ ID NO: 40 - protein, 115 aa, Artificial Sequence
  Chemically synthesized - Fos Kan(+)1
TSLYKKAGSAAAPFTSPEEEGKRRFRRERIKMAAAKRRNRRRELTDTLRAGTDQPEDEASALQTEIANLLKEKENLELILAAHRPACKVPDDQGFPEEAAAKGGRANPAFLYKVV

SEQ ID NO: 41 - protein, 115 aa, Artificial Sequence
  Chemically synthesized - Fos Kan(+)9
TSLYKKAGSAAAPFTSPEEEGKRSIRRERNKMAAAKCRNRRRELTDTLRAETDQLEDEKSALQAEIANLLKEKEKLEYILAAHRPARKIPDDLGFPEEAAAKGGRANPAFLYKVV

SEQ ID NO: 42 - protein, 115 aa, Artificial Sequence
  Chemically synthesized - Fos Kan(+)5a
TSLYKKAGSAAAPFTSPGEEGKRRIRRERNKMAAAKCRNRRRGLTDTLQAETDQLEDEKSALQTEFANLPKEKEKLESVLAAHRPACKIPDDLGFPKKAAAKGGRANPAFLYKVV

SEQ ID NO: 43 - protein, 115 aa, Artificial Sequence
  Chemically synthesized - Fos Kan(+)26
TSLYKKAGSAAAPFTSPEEEEKRRIRRERNKMAAAKRRNRRRELTDTLQAETDQLEDEKSALQTEIANLLKEKEKLESILAAHRPACKIPDDLGSPEEAAAKGGRANPAFLYKVV

SEQ ID NO: 44 - protein, 115 aa, Artificial Sequence
  Chemically synthesized - Fos Kan(+)15
TSLYKKAGSAAAPFTSPEEEEKRRIRRERNKTAAAKCRNRRRELTDTLQAETDQLEEEKSALQTEIANLLKEKEKLEIILAAHRPACKIPDDLGFPEEAAAKGGRANPAFLYKVV

SEQ ID NO: 45 - protein, 115 aa, Artificial Sequence
  Chemically synthesized - Fos Kan(+)3a
TSLYKKAGSAAAPFTSPEEEEKRRIRRERNKTAAAKCRNRRRELTDTLQAGADQLVDEKSALQTEIANLLKGKEKLELILAAHRPACKIPDDLGLPEEAAAKGGRANPAFLYKVV

SEQ ID NO: 46 - protein, 115 aa, Artificial Sequence
  Chemically synthesized - Fos Kan(+)6
TSLYKKAGSAAAPFTTPEEEEKRRIRRERNKLAAAKCRNRRRGLTDTLQAETDQLEDGKSALQAEIANLLKEKEKLEFILAAHRPACKIPDDLGLPEEAAAKGGRANPAFLYKVV

SEQ ID NO: 47 - protein, 115 aa, Artificial Sequence
  Chemically synthesized - Fos Kan(+)12
TSLYKKAGSAAAPFTPPEEEEKRRIRRERNKMAAAECRNRRRELTDTLQAETDQLEDERSALQTEIANLLKEKEKLEFILAAHRPACKIPDDLGSPEEAAAKGGRANPAFLYKVV

SEQ ID NO: 48 - protein, 115 aa, Artificial Sequence
  Chemically synthesized - Fos Kan(+)4
TSLYKKAGSAAAPFTPPEEEEKGRIRRERNKMAAAKCRNRRRELTDTLQAETDQPEDEESALQTEIANLLKEKEKLEFIPAAHRPACKIPDDPGFPEEAAAKGGRANPAFLYKVV

SEQ ID NO: 49 - protein, 115 aa, Artificial Sequence
  Chemically synthesized - Fos Kan(+)28
TSLYKKAGSAAAPFTSPEEEEKRRIRRERNKMAAAKCRNRRRELTDTLQAETDQLEDERSALQTEIANLLKEKEKLEFILAAHRPACKIPDDLGFPEEAAAKGGRANPAFLYKVV

SEQ ID NO: 50 - protein, 115 aa, Artificial Sequence
  Chemically synthesized - Fos Kan(+)2
TSLYKKAGSAAAPFTPPEEGEKRRIRRERNKMAAAKCRNRRGELTDALRAETDQLEGEKSALQTEIANLLKEKEKLEFILAAHRPACKIPDDLGFPEEAAAKGGRANPAFLYKVV

SEQ ID NO: 51 - protein, 115 aa, Artificial Sequence
  Chemically synthesized - Fos Kan(+)4a
TSLYKKAGSAAAPFTSPEEGEKGRIRREGDKMAAAKCRNRRRELTDTLQAETDQLEDEKSALQTEIANLLKEKEKLEFILAAHRPACKIPDDLGFPEEAAAKGGRANPAFLYKVV

SEQ ID NO: 52 - protein, 115 aa, Artificial Sequence
  Chemically synthesized - Fos Kan(+)10
TSLYKKAGSAAAPFSSPDEEEKRRIRRERNKMAAAKCRNRRRELTVTLQAETDQLEDEKSALQTEIANLLKEKEKLEFILAAHRPACKIPDDLGFPEEAAAKGGRATPAFLYKVV

SEQ ID NO: 53 - protein, 115 aa, Artificial Sequence
  Chemically synthesized - Fos Kan(+)14
TSLYKKAGSAAAPFTSPEEEEKRRIRRERSKMAAAKCRNRRRELTDTLQAETDQLEDEKSALQTVIANLLKEKEKLEFILAAHRPACKIPDDLGFPEEAAAKGGRANPAFLYKVV

SEQ ID NO: 54 - protein, 115 aa, Artificial Sequence
  Chemically synthesized - Fos Kan(+)2a
TSLYKKAGSAAAPFTSPEEEEKRRIRRERNKMAAAKCRNRRRELTDTLQAETDQLEDEKSALQTGIANLLKEKEKLEFILAAHRPACKIPDDLGFPEEAAAKGGRANPAFLYKVV

SEQ ID NO: 55 - protein, 115 aa, Artificial Sequence
  Chemically synthesized - Fos Kan(+)13
TSLYKKAGSAAAPFTSPEEEEKRRIRRERNKMAAAKCRNRRRELTDTLQAGTDQLEDEKSALQTEIANLLKEKEKLEFILAAHRPACKIPDDLGFPEEAAAKGGRANPAFLYKVV

SEQ ID NO: 56 - protein, 115 aa, Artificial Sequence
  Chemically synthesized - Fos Kan(+)20
TSLYKKAGSAAAPFSSPEEEEKRRLRGERNKMAAAKCRNRRRELTDTLQAETDQLEDERSALQTEIASLLKEEEKLEFILAAHRPACKIPDDLGFPEEAAAKGGRANPAFLYKVV

SEQ ID NO: 57 - protein, 115 aa, Artificial Sequence
  Chemically synthesized - Fos Kan(+)3
TSLYKKAGSAAAPFTSPEEEEKRRIRRERNKMAAAKCRNRRRELTDTPQAGTDQLEDEKSALQTEIADLLKEEEKLEFILAAHRPACKVPDDLGFPEEAAAKGGRANPAFLYKVV

SEQ ID NO: 58 - protein, 115 aa, Artificial Sequence
  Chemically synthesized - Fos Kan(+)5
TSLYKKAGSAAAPFTSPEEEEKRRVRRERNKMAAAKCRNRRRVLTDTLQAVTDQLEDEKSALQTEIANLLKEREKLEFILAAHRPACKIPDDLGFPEEAAAKGGRANPAFLYKVV

SEQ ID NO: 59 - protein, 115 aa, Artificial Sequence
  Chemically synthesized - Fos Kan(+)16
TSLYKKAGSAAAPFTSPEEEEKRRNRRERNKMAAAKCRNRWREPTDTLQAETDLLEDEKSALLTEIADLQREKEKLEFILAAHRPACKIPDDLGFPEEAAAKGGRANPAFLYKVV

SEQ ID NO: 60 - protein, 115 aa, Artificial Sequence
  Chemically synthesized - Fos Kan(+)6a
TSLYKKAGSAAAPFTSPEEEEKRRIRRERNKMAAAKRRNRRREPTDTPQAETDQLEDEKSALQTEIANLLKEKEKLEFIPAAHRPASKIPDDLGFPEEAAAKGGRANPAFLYKVV

SEQ ID NO: 61 - protein, 115 aa, Artificial Sequence
  Chemically synthesized - Fos Kan(+)7a
TSLYKKAGSAAAPLTSPEEEEKRRIRGERNKMAAAKCRNRRRELTDTPQAETDQLEDEKSALQTEIANPLKEKEKLEFILAAHRPACKIPDDLGFPEEAAAKGGRANPAFLYKVV

SEQ ID NO: 62 - protein, 115 aa, Artificial Sequence
  Chemically synthesized - Fos Kan(+)8
TSLYKKAGSAAAPFTSPEEEEKRRIRRERNKMAAAKCRNWRRELTDTPQAEADQLEDVKSALQTETANLLKEKEKLEFILAAHRPACKIPGDLGFPEEAAAKGGRANPAFLYKVV

SEQ ID NO: 63 - protein, 115 aa, Artificial Sequence
  Chemically synthesized - Fos Kan(+)24
TSLYKKAGSAAAPSTSPEEEEKRRIRRERNKMAAAKCRNRRRELTDTLQAETDQLEDEKSALQTEIANLLKEKEKLEFILAAHRPACKIPDDLGFPEEAAAKGGRANPAFLYKVV

SEQ ID NO: 64 - protein, 115 aa, Artificial Sequence
  Chemically synthesized - Fos Kan(+)27
TSLYKKAGSAAAPSTSPEEEEKRSIRRERNKMAAARCRNRRRELTDTLQAEAGQLEDEKSALQTEIANLLKEKEKLEFILAAHRPACKIPDDLGFPEEAAAKGGRANPAFLYKVV

SEQ ID NO: 65 - protein, 115 aa, Artificial Sequence
  Chemically synthesized - Fos Kan(+)30
TSLYKKAGSAAAPLTSPEEEEKGRIRRERNKMAAAKCRNRRRELADTLQAETDQREDEKSALQTEIANLLKEKEKLEFILAAHRPACKIPDDLGFPEGAAGKGGRANPAFLYKVV

SEQ ID NO: 66 - protein, 115 aa, Artificial Sequence
  Chemically synthesized - Fos Kan(+)7
TSLYKKAGSAAAPFTSPEEEEKGRIRRERNKMAAAKCRNRRREPADTLQAEADQLEDEKSALQTEIANLLKEEEELEFILAAHRPACKIPDDLGIPEEAAAKGGRANPAFLYKVV

SEQ ID NO: 67 - protein, 115 aa, Artificial Sequence
  Chemically synthesized - Fos Kan(+)31
TSLYKKAGSAAAPYTSPEEEEKRRIRRERNKMAAAKCRNRRRELADTLQAETDQLEDEKSALQTEIANLLKEKEKLEFILAAHRPACKIPDDPGFPEEAAAKGGRANPAFLYKVV

SEQ ID NO: 68 - protein, 106 aa, Artificial Sequence
  Chemically synthesized - Fos Kan(+)1a
TSLYKKAGSAAAPFTSPEEGEKRRIRRGRNKMAAAGGGSLIHSERRQADKMRSLLCRPRLPTCGRGKNSSSWQHTDLPARSLMTWASQKRRPLRVGAPTQLSCTKW

SEQ ID NO: 69 - protein, 115 aa, Artificial Sequence
  Chemically synthesized - Fos Kan(+) consensus
TSLYKKAGSAAAPFTSPEEEEKRRIRRERNKMAAAKCRNRRRELTDTLQAETDQLEDEKSALQTEIANLLKEKEKLEFILAAHRPACKIPDDLGFPEEAAAKGGRANPAFLYKVV

SEQ ID NO: 70 - protein, 86 aa, Artificial Sequence; identical to SEQ ID NO: 38
  Chemically synthesized - Fos Kan(-)

SEQ ID NO: 71 - protein, 115 aa, Artificial Sequence; identical to SEQ ID NO: 39
  Chemically synthesized - attB-Fos Kan(-)

SEQ ID NO: 72 - protein, 114 aa, Artificial Sequence
  Chemically synthesized - Fos Kan(-)13
PTLYKKAGSAAAPFTSPEEEEGRIRGEGNKMAAAKCRSRRRELTDSLQAETDQLEDEKSALRTVIANLLKEKEKLELILAAHRPACKIPDDLGFPEEAAAKGGRANPAFLYKVV

SEQ ID NO: 73 - protein, 114 aa, Artificial Sequence
  Chemically synthesized - Fos Kan(-)21
TSLYKKAGSAAAPFTPPEEEEKRRIRRERNKMAAAKCRNRRREPTDTLQAETDQLEDEKSALQTEVANLLKEKEKLELILAARRPAKIPDDLGFPEEAAAKGGRANPAFLYKVV

SEQ ID NO: 74 - protein, 114 aa, Artificial Sequence
  Chemically synthesized - Fos Kan(-)22
TSLYKKAGSAAAPFTSPEEEEKRRIRRERNVAAAKCRNRRRELTDTLQAEADQLEDEKSALQTEITNLLKEKEELEFILAAHRPACKIPDDLGFPEEAAAKGGRANPAFLYKVV

SEQ ID NO: 75 - protein, 114 aa, Artificial Sequence
  Chemically synthesized - Fos Kan(-)29
TSLYKKAGSAAAPYTSPEEVEKRRIRRERNMAAAKCRNQRRELTDTLQAETDQLEDEKSALQTEIANRLKEEEKLEFILAAHRPACKIPDDLGLPEEAAAKGGRANPAFLYKVV

SEQ ID NO: 76 - protein, 113 aa, Artificial Sequence
  Chemically synthesized - Fos Kan(-)3a
TSLYKKAGSAAAPFTSPEEEERRIRRERNKMAAAKCRNRRRELTGTLQAETDQLEDEKSALQTEIANLLKEEKLESILAAHRPACKIPDDLGFPEEAAAKGGRANPAFLYKVV

SEQ ID NO: 77 - protein, 114 aa, Artificial Sequence
  Chemically synthesized - Fos Kan(-)4a
TSLYKKAGSAAAPFTSPEEEEKRRIRRERNKMAAAKCRNRRRELTDTLQAETDQLEDESALQAEIANLLKEKEKLEFNLAAHRPACKIPDDLGFPEEAAAKGGRANPAFLYKVV

SEQ ID NO: 78 - protein, 114 aa, Artificial Sequence
  Chemically synthesized - Fos Kan(-)1
TSLYKKAGSAAAPFTSPKGEEKRRIRRERNKMAAAKCRNRRRELTDTLQAETDQLEDEKSALQTGIANLLKEREEPEFVLAAHRPPARSLMTWASQKRRPLGVGAPTQLSCTKW

SEQ ID NO: 79 - protein, 110 aa, Artificial Sequence
  Chemically synthesized - Fos Kan(-)2
TSLYKKAGSAAAPFTSPEEEEKRRIRRERNKMAAANAATGGGSLIRSKRRQTNKMRSLLCRPRLPTCRRRKNSSSWQLTDLPARSLMTWASQKRRPLRVGAPTQLSCTKW

SEQ ID NO: 80 - protein, 112 aa, Artificial Sequence
  Chemically synthesized - Fos Kan(-)26
TSLYKKAGSAAAPFTSPEEEERRRVRRERNKMAAAKCRGRRRELTDTLQAETDQLEDEKSALQTEMPTCGRRKNSSSWQLTDLPARSLMTWASQERRPLRVGAPTQLSCTKW

SEQ ID NO: 81 - protein, 112 aa, Artificial Sequence
  Chemically synthesized - Fos Kan(-)31
TSLYKKAGSAAAPFTSPEEEEKRRIRRERNKMAAAKCRNRRRELTGTLRAETDQLEDEKSACRPRLPTCRRRKNSSSWQLTDLPARSPMTWASQKRRPLRVGAPTQLSCTKW

SEQ ID NO: 82 - protein, 114 aa, Artificial Sequence
  Chemically synthesized - Fos Kan(-)3
TSLYKKAGSAAAPITPPEEEEKRRIRRERNKMAAAKCRNRRRVLTDTLQAETDQLGDEKSALQTETANPLKGKGKLELIPAAHRPPAGSLMTRASQKRRPLRVGAPTQLSCTKW

SEQ ID NO: 83 - protein, 112 aa, Artificial Sequence
  Chemically synthesized - Fos Kan(-)5a
TSLYKKAGSAAAPSTSPEEEEKRRIRREGNMAAAKCRNRRRELTDTLQAETDQLEDGKSALQTEIANLLRGRKNSSTWQLTDLPARSLMTWASQKRRPLRVGAPTQLSCTKW

SEQ ID NO: 84 - protein, 113 aa, Artificial Sequence
  Chemically synthesized - Fos Kan(-)7
TSLYKKAGSAAAPFTSTEEEEKGRIRRERNMMAAAKCRNRRRGLTDTLQAETDQLEDEKSALQTEIANLLKEKENSSSWQLTVLPARSLMTWASQRRRPLRVGAPTQLSCTKW

SEQ ID NO: 85 - protein, 114 aa, Artificial Sequence
  Chemically synthesized - Fos Kan(-)9
TSLYKKAGSAAAPFTSPEVEEKRRIRRERNKMAAAKCRNRRRELSDTLQAETDQLEDEKPALQTEIANLLREKGKLEFILAAHRPPARSLMTWASQKRRPPRVGAPTQLSCTKW

SEQ ID NO: 86 - protein, 110 aa, Artificial Sequence
  Chemically synthesized - Fos Kan(-)2a
TSLYKKAGSAAAPFTSPEEEEKRGIRRGRNKVAAANAATGGGSLIHSKRRQTNKTGSRLCRPGLPTCRRRKSGSSWQLTDLPARSLMTWASQKGRPLRVGAPTQLSCTKW

SEQ ID NO: 87 - protein, 109 aa, Artificial Sequence
  Chemically synthesized - Fos Kan(-)28
TSLYKKAGSAAAPFTSPEEEEGRIRRERNKMAAADAATGGGGLTHSKRGQTNKMRSLLCGPRLPACRRRKNSSSWLLTDLPARSLMTWASQRRRPLRVGAPTQLSCTKW

SEQ ID NO: 88 - protein, 107 aa, Artificial Sequence
  Chemically synthesized - Fos Kan(-)6a
TSLYKKAGSAAAPFASPEEEEKRRIRRERNKMAAAKAATGGGSLIHSKRRQTNKMRSLLCRPRLPTCRRRKNSSSWQLTDLPQDPPGLPRRGGRGWARQPSFLVQSG

SEQ ID NO: 89 - protein, 111 aa, Artificial Sequence
  Chemically synthesized - Fos Kan(-)24
TSLYKKAGSAAAPFTSPEEGEEGESEGKGIRWLQPNAATGGGSLMHSKRRQTNKMRSLLCRPRLPTCWRRRKDSSSRQLTDLPARPLMTWASQKRRPLRVGAPTQLSCTKW

SEQ ID NO: 90 - protein, 110 aa, Artificial Sequence
  Chemically synthesized - Fos Kan(-)11
TSLYKKAGSAAAPSPLQKKMRKGESEGKGMRWLQPNAATGGGSLIHSKRRQTNKTRSLPCRPRLPTAEGEGKTRVHPGSSPSCLQDPCPGHPRRGGRGWARQPSFLVQSG

SEQ ID NO: 91 - protein, 111 aa, Artificial Sequence
  Chemically synthesized - Fos Kan(-)14
TSLYKKAGSAAAPSPLQKKKRKGESEGRGIRWLRPNAATGGGSLIHSKRRQTNKMRSLLCRPRTPTCCRRRKSSSSWQLTDLPARSLMTWASQKRRPLRVGAPTQLSCTKW

SEQ ID NO: 92 - protein, 110 aa, Artificial Sequence
  Chemically synthesized - Fos Kan(-)15
TSLYKKAGSAAAPSPLQKKRRKGESEGKGIRWLQPNAATGGGSLKHSKRRQTNKMRSLLCRPRSPTCRRRKNSSSWQLTDLPTRSLMAWASQKRRPLRVGAPTQLSCTKW

SEQ ID NO: 93 - protein, 110 aa, Artificial Sequence
  Chemically synthesized - Fos Kan(-)17
TSLYKKAGSAAAPSPLQKKKRKGESEGKGIRWLQPNAATGGGSPIHSKRRQTNKMRSLLCRPRLPTRRRRKNSSTWLLTDLPARSLMTWASQKRRPLRVGAPTQLSCTKW

SEQ ID NO: 94 - protein, 110 aa, Artificial Sequence
  Chemically synthesized - Fos Kan(-)19
TSLYKKAGSAAAPSPLQKKKRKGESEGKGIRWLQPNAATGGGSLIHSKRRQTNKMRSLLCRPRLPTCRRRKNSSSWQLTDLPARSLMTRASQKRRPLRVGAPTQLSCTKW

SEQ ID NO: 95 - protein, 108 aa, Artificial Sequence
  Chemically synthesized - Fos Kan(-)20
TSLYKKAGSAAAPSPLQKKKRKGESGGKGIRWLRPNAATGGGSLIHSKRSQTNKMRSLLCRPRLPTCRRRKNSSSWQLTDLPARSRPGHPRRGGRGWARQPSFLVQSG

SEQ ID NO: 96 - protein, 109 aa, Artificial Sequence
  Chemically synthesized - Fos Kan(-)23
TSLYKKAGSAAAPSPLQKKKRKGESEGKGIRWLQPNAATGGGSLIHSKRRQTNKMRSLLCPRLPTCGRRKNSSPWQLTDLPARSLMTWASQKRRPLRVGAPTQLSCTKW

SEQ ID NO: 97 - protein, 111 aa, Artificial Sequence
  Chemically synthesized - Fos Kan(-)12
TSLYKKAGSAPPPSPLQRKKGKGESEGKGIRWLQPNAATGGGSLIHSKRRQTNWKMRGLLCRPRLPTCRGRKNCPSWQLTDLPARSLMTWASQKRRPLRVGAPTQLSCTKW

SEQ ID NO: 98 - protein, 110 aa, Artificial Sequence
  Chemically synthesized - Fos Kan(-)27
TSLYKKAGSAAAPSPLQKRKREGESEGKGIRWLQPNAATGGGSPIHSKRSRTSKMRSLLCRPRLPTCRRAENSSSWQLTALPAGSPMTWASQRRRPLRVGAPTQLSCTKW

SEQ ID NO: 99 - protein, 98 aa, Artificial Sequence
  Chemically synthesized - Fos Kan(-)consensus
TSLYKKAGSAAAPFTSPEEEEKRRIRRERNKMAAAKCRTRRTTLKAEDQLDACPLPTRRKSSSWQLTDLPARSLMTWASQKRRPLRVGAPTQLSCTKW

SEQ ID NO: 100 - protein, 61 aa, Artificial Sequence
  Chemically synthesized - MyoD1 - 1
TNADRRKAATMRERRRLSKVNEASETLKRCTSSNPNQRLPKVEILRNAIRYIEGLQALLRD

SEQ ID NO: 101 - protein, 61 aa, Artificial Sequence
  Chemically synthesized - MyoD1 - 23
TNADRRKAATMRERRRLSKVNEAFETPKRCTSSNPNQRLPKVEILRNAIRYIEGLQALLRD

SEQ ID NO: 102 - protein, 61 aa, Artificial Sequence
  Chemically synthesized - MyoD1 - 12
TNADRRKAATMRERRRLSKVNEAFETLKRCTSSNPNQRLPKMEILRNAIRYIEGLQALLRD

SEQ ID NO: 103 - protein, 61 aa, Artificial Sequence
  Chemically synthesized - MyoD1 - 32
TNADRRKAATMRERRRLSKVNEAFETLKRCTSSNPNQRLPKAEILRNAIRYIEGLQALLRD

SEQ ID NO: 104 - protein, 61 aa, Artificial Sequence
  Chemically synthesized - MyoD1 - 41
TNADRRKAATMRERRRLSKVNEAFETLKRCTSSNPNQRLPTVEILRNAIRYIEGLQALLRD

SEQ ID NO: 105 - protein, 61 aa, Artificial Sequence
  Chemically synthesized - MyoD1 - 16
TNADRRKAATMRERRRLSKVNEAFETLKRCTSSNPNQRLPKVEIRRNAIRYIEGLQALLRD

SEQ ID NO: 106 - protein, 61 aa, Artificial Sequence
  Chemically synthesized - MyoD1 - 20
TNADRRKAAAMRERRRLSKVNEAFETLKRCTSSNPNQRLPKVEILHNAIRYIEGLQALLRD

SEQ ID NO: 107 - protein, 61 aa, Artificial Sequence
  Chemically synthesized - MyoD1 - 8
TNADRRKAATMRERRRLSKVNEAFETLKRCTSSNPNQRLPKVEILCNAIRYIEGLQALLRD

SEQ ID NO: 108 - protein, 61 aa, Artificial Sequence
  Chemically synthesized - MyoD1 - 14
TNADRRKAATMRERRRLSKVNEAFETLKRCTSSNPNQRLPKVEILRNATRYIEGLQALLRD

SEQ ID NO: 109 - protein, 61 aa, Artificial Sequence; identical to SEQ ID NO: 108
  Chemically synthesized - MyoD1 - 31

SEQ ID NO: 110 - protein, 61 aa, Artificial Sequence
  Chemically synthesized - MyoD1 - 3
TNADRRKAATMRERRRLSKVNEAFETLKRCTSSNPNQRLPKVEILRNAIRYIKGLQALLRD

SEQ ID NO: 111 - protein, 61 aa, Artificial Sequence
  Chemically synthesized - MyoD1 - 30
TNADRRKAATMRERRRLSKVNEAFETLKRCTSSNPNQRLPKVEILRNAIRYIEGPQALLRD

SEQ ID NO: 112 - protein, 61 aa, Artificial Sequence; identical to SEQ ID NO: 111
  Chemically synthesized - MyoD1 - 36

SEQ ID NO: 113 - protein, 61 aa, Artificial Sequence; identical to SEQ ID NO: 111
  Chemically synthesized - MyoD1 - 5

SEQ ID NO: 114 - protein, 61 aa, Artificial Sequence
  Chemically synthesized - MyoD1 - 40
TNADRRKAATMRERRRLSKVNEAFETLKRCTSSNPNQRLPKVEILRNAIRYIEGLQALPRD

SEQ ID NO: 115 - protein, 61 aa, Artificial Sequence
  Chemically synthesized - MyoD1
TNADRRKAATMRERRRLSKVNEAFETLKRCTSSNPNQRLPKVEILRNAIRYIEGLQALLRD

SEQ ID NO: 116 - protein, 61 aa, Artificial Sequence; identical to SEQ ID NO: 115
  Chemically synthesized - MyoD1 - consensus

SEQ ID NO: 117 - protein, 92 aa, Artificial Sequence
  Chemically synthesized - RalGDS16
YNQQVGDCCIIMVSLDVDNGNMYKSILVTSQDKAPTVIRKAMDKHNLDEDEPEDYELLQIISEDHKLKIPENANVFYAMNSAANYDFILKKR

SEQ ID NO: 118 - protein, 92 aa, Artificial Sequence
  Chemically synthesized - RalGDS17
YNQQVGDCCIIRVSLDVDNGNMCKSILVTSQDKAPTVIRKAMDKHNLDEDEPEDYELLQIISEDHKLKIPENANVFYAMNSAANYDFILKKR

SEQ ID NO: 119 - protein, 92 aa, Artificial Sequence; identical to SEQ ID NO: 118
  Chemically synthesized - RalGDS19

SEQ ID NO: 120 - protein, 92 aa, Artificial Sequence
  Chemically synthesized - RalGDS23
YNQQVGDCCIIRVSLDVDNGNMYKSILVTSQDKAPTVIRKAVDKHNLDEDEPEDYELLQIISEDHKLKIPENANVFYAMNSAANYDFILKKR

SEQ ID NO: 121 - protein, 92 aa, Artificial Sequence
  Chemically synthesized - RalGDS6
YNQQVGDCCIIRVSLDVDNGNMYKSILVTSQDKAPTVIRKAMDEHNLDEDEPEDYELLQIISEDHKLKIPENANVFYAMNSAANYDFILKKR

SEQ ID NO: 122 - protein, 92 aa, Artificial Sequence; identical to SEQ ID NO: 121
  Chemically synthesized - RalGDS15

SEQ ID NO: 123 - protein, 92 aa, Artificial Sequence
  Chemically synthesized - RalGDS1
YNQQVGDCCIIRVSLDVDNGNMYKSILVTSQDKAPTVIRKAMDKPNLDEDEPEDYELLQIISEDHKLKIPENANVFYAMNSAANYDFILKKR

SEQ ID NO: 124 - protein, 92 aa, Artificial Sequence
  Chemically synthesized - RalGDS27
YNQQVGDCCIIRVSLDVDNGNMYKSILVTSQDKAPTVIRKAMDKHNLDEDEPEDYEPLQIISEDHKLKIPENANVFYAMNSAANYDFILKKR

SEQ ID NO: 125 - protein, 92 aa, Artificial Sequence; identical to SEQ ID NO: 124
  Chemically synthesized - RalGDS3

SEQ ID NO: 126 - protein, 92 aa, Artificial Sequence; identical to SEQ ID NO: 124
  Chemically synthesized - RalGDS30

SEQ ID NO: 127 - protein, 92 aa, Artificial Sequence; identical to SEQ ID NO: 124
  Chemically synthesized - RalGDS35

SEQ ID NO: 128 - protein, 92 aa, Artificial Sequence; identical to SEQ ID NO: 124
  Chemically synthesized - RalGDS36

SEQ ID NO: 129 - protein, 92 aa, Artificial Sequence; identical to SEQ ID NO: 124
  Chemically synthesized - RalGDS8

SEQ ID NO: 130 - protein, 92 aa, Artificial Sequence
  Chemically synthesized - RalGDS2
YNQQVGDCCIIRVSLDVDNGNMYKSILVTSQDKAPTVIRKAMDKHNLDEDEPEDYELPQIISEDHKLKIPENANVFYAMNSAANYDFILKKR

SEQ ID NO: 131 - protein, 92 aa, Artificial Sequence
  Chemically synthesized - RalGDS22
YNQQVGDCCIIRVSLDVDNGNMYKSILVTSQDKAPTVIRKAMDKHNLDEDEPEDYELLRIISEDHKLKIPENANVFYAMNSAANYDFILKKR

SEQ ID NO: 132 - protein, 92 aa, Artificial Sequence
  Chemically synthesized - RalGDS4
YNQQVGDCCIIRVSLDVDNGNMYKSILVTSQDKAPTVIRKAMDKHNLDEDEPEDYELLQIISEDHKLKTPENANVFYAMNSAANYDFILKKR

SEQ ID NO: 133 - protein, 92 aa, Artificial Sequence
  Chemically synthesized - RalGDS37
YNQQVGDCCIIRVSLDVDNGNMYKSILVTSQDKAPTVIRKAMDKHNLDEDEPEDYELLQIISEDHKLKIPENANVFYAMNSAANYDFIPKKR

SEQ ID NO: 134 - protein, 92 aa, Artificial Sequence
  Chemically synthesized - RalGDS ORF
YNQQVGDCCIIRVSLDVDNGNMYKSILVTSQDKAPTVIRKAMDKHNLDEDEPEDYELLQIISEDHKLKIPENANVFYAMNSAANYDFILKKR

SEQ ID NO: 135 - protein, 92 aa, Artificial Sequence; identical to SEQ ID NO: 134
  Chemically synthesized - RalGDS consensus